(19) United States
(12) Patent Application Publication
(10) Pub. No.: US 2026/0036837 A1
(43) Pub. Date: Feb. 5, 2026

(54) DIRECTIONAL DISPLAY APPARATUS

(71) Applicant: RealD Spark, LLC, Boulder, CO (US)

(72) Inventors: Graham J. Woodgate, Henley-on-Thames (GB); Michael G. Robinson, Boulder, CO (US)

(73) Assignee: RealD Spark, LLC, Boulder, CO (US)

(21) Appl. No.: 19/287,074

(22) Filed: Jul. 31, 2025

Related U.S. Application Data
(60) Provisional application No. 63/678,377, filed on Aug. 1, 2024.

(51) Int. Cl. G02F 1/13; G02F 1/1335; G02F 1/13363

(52) U.S. Cl. CPC G02F 1/1323; G02F 1/133514; G02F 1/133531; G02F 1/133634; G02F 1/133638; G02F 2413/12

(57) ABSTRACT

A switchable privacy display comprises at least one light source, a structured birefringent component, an out-of-plane polariser, a polarisation switch, and an in-plane polariser. The polarisation switch is arranged between the out-of-plane polariser and the in-plane polariser, and the polarisation switch is also arranged between the structured birefringent component and the in-plane polariser. The display device is arranged to output an image formed using light which has been output from the at least one light source and which has passed through the structured birefringent component, the out-of-plane polariser, the polarisation switch and the in-plane polariser. The display can operate in a privacy mode of operation that provides a high security factor in non-viewing directions and high image visibility in viewing directions, or in a wide-angle mode of operation that provides high image visibility for a relatively wider field of view.

### CROSS-REFERENCE TO RELATED APPLICATIONS

This application claims the benefit of and priority to U.S. Provisional Patent Application No. 63/678,377, filed Aug. 1, 2024, which is incorporated herein by reference in its entirety and for all purposes.

### TECHNICAL FIELD

This disclosure generally relates to illumination from light modulation devices, and more specifically relates to optical stacks for providing control of illumination for use in display including privacy display and night-time display.

### BACKGROUND

Privacy displays provide image visibility to a primary user that is typically in an on-axis position and reduced visibility of image content to a snooper, that is typically in an off-axis position. A privacy function may be provided by micro-louvre optical films that transmit some light from a display in an on-axis direction with low luminance in off-axis positions. However such films have high losses for head-on illumination and the micro-louvres may cause Moiré artefacts due to beating with the pixels of the spatial light modulator. The pitch of the micro-louvre may need selection for panel resolution, increasing inventory and cost.

Switchable privacy displays may be provided by control of the off-axis optical output.

Control may be provided by means of luminance reduction, for example by means of switchable backlights for a liquid crystal display (LCD) spatial light modulator. Display backlights in general employ waveguides and edge emitting sources. Certain imaging directional backlights have the additional capability of directing the illumination through a display panel into viewing windows. An imaging system may be formed between multiple sources and the respective window images. One example of an imaging directional backlight is an optical valve that may employ a folded optical system and hence may also be an example of a folded imaging directional backlight. Light may propagate substantially without loss in one direction through the optical valve while counter-propagating light may be extracted by reflection off tilted facets as described in U.S. Pat. No. 9,519,153, which is herein incorporated by reference in its entirety.

### SUMMARY

According to a first aspect of the present disclosure there is provided a display device comprising: at least one light source arranged to output light; a structured birefringent component; an out-of-plane polariser; and a polarisation switch arranged to switch the display device between a first mode of operation and a second mode of operation; and an in-plane polariser, wherein the polarisation switch is arranged between the out-of-plane polariser and the in-plane polariser, and the polarisation switch is also arranged between the structured birefringent component and the in-plane polariser, and wherein the display device is arranged to output an image formed using light which has been output from the at least one light source and which has passed through the structured birefringent component, the out-of-plane polariser, the polarisation switch and the in-plane polariser.

A switchable display device that is arranged to switch between a privacy or low stray light mode and a wide-angle mode may be provided. Security factor to off-axis snoopers in the privacy mode and the angular region over which desirable factor is achieved may be increased. A low thickness display device with low cost and complexity may be provided.

The at least one light source may be arranged to output light towards the structured birefringent component and out-of-plane polariser, the structured birefringent component and out-of-plane polariser may be arranged to receive the light output from the at least one light source and to output light towards the polarisation switch, the polarisation switch may be arranged to receive the light output from the structured birefringent component and out-of-plane polariser and to output light towards the in-plane polariser, and the in-plane polariser may be arranged to receive the light output from the polarisation switch and to output light for forming the image. The polarisation switch may provide switching of the optical transmission profile of both the structured birefringent component and the out-of-plane polariser.

The structured birefringent component may be arranged to output at least some light having a first polarisation state and at least some light having a different second polarisation state. The optical function of the structured birefringent component may conveniently be selected by the polarisation switch and in-plane polariser.

The out-of-plane polariser may be arranged to absorb a component of the light which it receives in a direction out of a plane defined by a pixel layer of the display device. The luminance in directions towards a snooper may be reduced and security factor increased.

The display device may further comprise a biaxial retarder arrangement arranged between the at least one light source and the in-plane polariser, wherein the light used to form the image output by the display device also passes through the biaxial retarder arrangement. The size of the angular region in privacy mode for which reduced transmission and increased security factor is achieved may be increased.

The biaxial retarder arrangement may comprise a B-plate. The B-plate may have principal components of refractive index nx, ny, nz and a thickness d, and wherein for light at a wavelength of 550 nm: the value of (nx−ny)d is in a range between −130 nm and −170 nm, the value of (nx−nz)d is in a range between +270 nm and +330 nm, and the value of a parameter Rth is in a range between +340 nm and +400 nm, wherein Rth=(nx+ny)/2−nz)d. A low thickness component may be provided that may be formed with low cost, for example by double stretching.

The biaxial retarder arrangement may comprise a C-plate arranged to receive the light output from an A-plate. For light at a wavelength of 550 nm the A-plate has a retardance in a range between +85 nm and +115 nm, and the C-plate may be a negative C-plate with a retardance in a range between −190 nm and −250 nm. The complexity of manufacture of the A-plate and negative C-plate retarders may be reduced, achieving reduced cost.

For light at a wavelength of 550 nm the A-plate has a retardance in a range between +85 nm and +115 nm, and the C-plate may be a positive C-plate with a retardance in a range between +220 nm and +280 nm. The thickness of the positive C-plate may be reduced.

Such ranges represent particularly beneficial or advantageous embodiments because the luminance in the viewing quadrants of the display device may be reduced in comparison to alternative combinations of values. In operation, the angular variation of output polarisation state of the out-of-plane polariser may be modified by the means of the biaxial retarder arrangement with said combination of values. The angular variation of output polarisation state of the biaxial retarder arrangement may achieve said reduction of luminance in viewing quadrants in narrow-angle or privacy mode. Image security factor in non-viewing directions may be increased.

The biaxial retarder arrangement may be arranged to receive light output from the out-of-plane polariser. The size of the region for which desirable transmission reduction and security factor is achieved in privacy mode may be increased.

The polarisation switch may be switchable between a first mode in which it is arranged to change the polarisation state of the light passing therethrough and a second mode in which it is arranged to affect the polarisation state of the light passing therethrough differently from the first mode. In the first mode, the polarisation switch may be arranged to change the polarisation state of the light passing therethrough from a first linear polarisation state to a second linear polarisation state that is orthogonal to the first linear polarisation state. The light output by the in-plane polariser in the first mode may have a different light output transmission profile to the light output by the in-plane polariser in the second mode.

The output of the display device may have an angular variation of luminance that is different between the first and second modes. The polarisation switch and in-plane polariser are capable of simultaneously selecting the light that is output from both the structured birefringent component and the out-of-plane polariser. The number of switches of the optical system is reduced and cost, thickness and complexity advantageously reduced.

In the second mode, the polarisation switch may be arranged not to change the polarisation state of the light passing therethrough. The in-plane polariser may be a linear polariser arranged to output light having a linear polarisation state. The out-of-plane polariser may be arranged between the structured birefringent component and the polarisation switch. The structured birefringent component may be arranged between the at least one light source and the out-of-plane polariser. The transmission of the display device in non-viewing directions may be minimised, advantageously achieving increased security factor.

The at least one light source may be a backlight. The display device may comprise a transmissive spatial light modulator. The number and precision of alignment steps during manufacture may be reduced. Cost and complexity of construction may be reduced.

The backlight may provide a luminance at polar angles to a normal direction to the display device greater than 45 degrees that is at most 33% of the luminance along the normal direction to the display device, preferably at most 20% of the luminance along the normal to the display device, and most preferably at most 10% of the luminance along the normal to the display device. The luminance of the display device in non-viewing directions may be reduced. Advantageously security factor may be increased in privacy mode of operation.

The at least one light source may be an emissive pixel layer. The thickness and weight of the display device may be reduced. Increased brightness and efficiency may be achieved. Image contrast may be increased.

The structured birefringent component may comprise a plurality of birefringent lenses. Imaging of the light sources may be provided to achieve reduced luminance and increased security factor in non-viewing directions.

The structured birefringent component may comprise one or more of: a refractive structure having optical power in only one dimension; a refractive structure having optical power in two dimensions; a diffractive structure having optical power in only one dimension; a diffractive structure having optical power in two dimensions. The profile of luminance in share mode may be modified to provide desirable image visibility in share mode of operation. Increased image visibility in one or two dimensions may be provided in share mode. Display peak luminance may be increased.

The polarisation switch layer may comprise a switchable layer of liquid crystal material. The polarisation switch may comprise two surface alignment layers disposed adjacent to the layer of liquid crystal material on opposite sides thereof and each arranged to provide alignment at the adjacent liquid crystal material. The polarisation switch layer may further comprise transmissive electrodes arranged to apply a voltage for controlling the switchable layer of liquid crystal material. The transmissive electrodes may be on opposite sides of the switchable layer of liquid crystal material. A low cost and thin polarisation switch may be provided.

The transmissive electrodes may be patterned to provide at least two pattern regions. Some regions of the display device may provide first mode of operation and other regions may provide second mode of operation. A switchable privacy display with regions of both privacy and share mode operation may be achieved. Visibility of gaps between share mode regions and privacy mode regions may be reduced.

The display device may further comprise a control system arranged to control the voltage applied across the transmissive electrodes of the polarisation switch layer. The display device may be controlled in a low cost and adjustable manner.

The emissive pixel layer may comprise a plurality of pixels arranged in a pixel array and the structured birefringent component may comprise a plurality of birefringent lenses, each pixel of the emissive pixel layer being aligned with a respective birefringent lens, wherein each of the plurality of birefringent lenses is arranged to reflect at least some of the light received from pixels which are not aligned with that birefringent lens. The display device may further comprise a parallax barrier layer comprising a plurality of apertures arranged in an aperture array, each aperture being aligned with a respective pixel of the emissive pixel layer, wherein the parallax barrier layer is arranged to prevent at least some of the light from each of the plurality of pixels from reaching birefringent lenses which are not aligned with that pixel. The luminance of the privacy mode of an emissive display in non-viewing directions may be reduced and security factor increased.

The emissive pixel layer may comprise a plurality of pixels arranged in a pixel array and the structured birefringent component may comprise a plurality of birefringent lenses, each pixel of the pixel layer being aligned with a respective birefringent lens, the display device further comprising a colour filter layer comprising a plurality of colour filters arranged in a colour filter array, wherein each of the plurality of pixels is aligned with a respective colour filter of the plurality of colour filters, wherein the colour filter layer is arranged between the structured birefringent component and the pixel layer. The colour filter layer may be arranged to prevent at least some of the light from each of the plurality of pixels from reaching birefringent lenses which are not aligned with that pixel. The luminance of the privacy mode of an emissive display in non-viewing directions may be reduced and security factor increased.

The display device may further comprise a half-wave retarder arranged between the at least one light source and the out-of-plane polariser. The structured birefringent component and out-of-plane polariser may be arranged to be simultaneously controlled for the first mode or the second mode by the polarisation switch to achieve desirable security factor or image visibility in non-viewing directions.

The display device may further comprise: a spatial light modulator; and at least one polar control retarder, wherein the in-plane polariser is an input polariser of the spatial light modulator, and wherein the spatial light modulator is arranged between the polarisation switch and the at least one polar control retarder, and wherein the display device comprises an additional polariser arranged on an output side of the polar control retarder. The size of the angular region for which desirable security factor is achieved in privacy mode may be increased. The size of the angular region for which desirable image visibility is achieved in share mode may advantageously be substantially unmodified. High efficiency may be achieved.

The at least one polar control retarder may comprise a switchable liquid crystal retarder comprising a layer of liquid crystal material, wherein the at least one polar control retarder may be arranged, in a switchable state of the switchable liquid crystal retarder, simultaneously to introduce no net relative phase shift to orthogonal polarisation components of light passed by the spatial light modulator along a first axis and to introduce a net relative phase shift to orthogonal polarisation components of light passed by the spatial light modulator along a second axis inclined to first axis. The at least one polar control retarder may further comprise at least one passive compensation retarder which may be arranged simultaneously to introduce no net relative phase shift to orthogonal polarisation components of light passed by the spatial light modulator along the first axis and to introduce a net relative phase shift to orthogonal polarisation components of light passed by the spatial light modulator along the second axis. A low cost, thickness and complexity of the optical stack of the polar control retarder may be achieved.

The display device may further comprise a reflective polariser arranged between the spatial light modulator and the at least one polar control retarder. The security factor of the display device in non-viewing directions in the privacy mode may be increased for illumination by ambient light. The reflectivity in the viewing direction for the primary user may be substantially the same for privacy and share modes of operation. In the share mode of operation low reflectivity may be provided and high image contrast visibility over a wide angular range.

The display device may further comprise: a spatial light modulator; and at least one polar control retarder, wherein the in-plane polariser may be arranged between the at least one polar control retarder and the polarisation switch, and wherein the at least one polar control retarder may be arranged between the in-plane polariser and the spatial light modulator, and wherein the spatial light modulator comprises an additional polariser as its input polariser. The at least one polar control retarder may comprise a switchable liquid crystal retarder comprising a layer of liquid crystal material, wherein the at least one polar control retarder may be arranged, in a switchable state of the switchable liquid crystal retarder, simultaneously to introduce no net relative phase shift to orthogonal polarisation components of light passed by the in-plane polariser along a first axis and to introduce a net relative phase shift to orthogonal polarisation components of light passed by the in-plane polariser along a second axis inclined to first axis. The at least one polar control retarder may further comprise at least one passive compensation retarder which may be arranged simultaneously to introduce no net relative phase shift to orthogonal polarisation components of light passed by the in-plane polariser along the first axis and to introduce a net relative phase shift to orthogonal polarisation components of light passed by the in-plane polariser along the second axis. Frontal reflections from the display device may be reduced and image contrast improved. Spatial light modulators comprising in-cell touch may be provided.

The switchable liquid crystal retarder may comprise two surface alignment layers disposed adjacent to the liquid crystal material on opposite sides thereof and each arranged to provide alignment at the adjacent liquid crystal material. The switchable liquid crystal retarder may further comprise transmissive electrodes arranged to apply a voltage for controlling the layer of liquid crystal material. The transmissive electrodes may be on opposite sides of the layer of liquid crystal material. A low cost and thin switchable liquid crystal retarder may be provided.

The control system may be further arranged to control the voltage applied across the transmissive electrodes of the switchable liquid crystal retarder. The polarisation switch and polar control retarder may be each arranged to provide luminance reduction or no luminance reduction in the same region of the display device. A display device with mixed regions of privacy and share mode may be provided.

According to a second aspect of the present disclosure there is provided a view angle control optical element for use with an in-plane polariser and at least one light source of a display device, the view angle control optical element comprising: a structured birefringent component; an out-of-plane polariser; and a polarisation switch for switching the display device between a first mode of operation and a second mode of operation, wherein: the out-of-plane polariser is arranged between the structured birefringent component and the polarisation switch; or the structured birefringent component is arranged between the out-of-plane polariser and the polarisation switch. A view angle control element may be provided for arrangement with a spatial light modulator comprising an in-plane polariser. The view angle control element may be provided during manufacture or may be fitted by a user.

Any of the aspects of the present disclosure may be applied in any combination.

Embodiments of the present disclosure may be used in a variety of optical systems. The embodiments may include or work with a variety of projectors, projection systems, optical components, displays, microdisplays, computer systems, processors, self-contained projector systems, visual and/or audio-visual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments.

Before proceeding to the disclosed embodiments in detail, it should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying FIGURES, in which like reference numbers indicate similar parts, and in which:

FIG. 1A is a schematic diagram illustrating in perspective side view a switchable privacy display device comprising a backlight, a switchable light dispersion and absorption arrangement comprising a structured birefringent component, an out-of-plane polariser, a polarisation switch and a transmissive spatial light modulator comprising a display polariser arranged on the input side of the spatial light modulator and a further display polariser arranged on the output side of the spatial light modulator;

FIG. 1B is a schematic diagram illustrating in perspective front view, alignment of optical layers in the optical stack of FIG. 1A;

FIG. 2A is a schematic diagram illustrating in perspective side view, operation of optical layers in the optical stack of FIG. 1A for orthogonal polarisation states wherein the polarisation switch is arranged to provide narrow-angle state of operation;

FIG. 2B is a schematic diagram illustrating in perspective side view, operation of optical layers in the optical stack of FIG. 1A for orthogonal polarisation states wherein the polarisation switch is arranged to provide wide-angle state of operation;

FIG. 2C is a schematic diagram illustrating in perspective side view, operation of optical layers in the optical stack of FIG. 1A for orthogonal polarisation states wherein the polarisation switch is arranged to provide narrow-angle state of operation and the biaxial retarder is omitted;

FIG. 2D is a schematic diagram illustrating in perspective side view, operation of optical layers in the optical stack of FIG. 1A for orthogonal polarisation states wherein the polarisation switch is arranged to provide wide-angle state of operation and the biaxial retarder is omitted;

FIG. 3A is a schematic diagram illustrating in top view, operation of optical layers in the optical stack of FIG. 1A wherein the polarisation switch is arranged to provide narrow-angle state of operation;

FIG. 3B is a schematic diagram illustrating in side view, operation of optical layers in the optical stack of FIG. 1A wherein the polarisation switch is arranged to provide narrow-angle state of operation;

FIG. 3C is a schematic diagram illustrating in top view, operation of optical layers in the optical stack of FIG. 1A wherein the polarisation switch is arranged to provide wide-angle state of operation;

FIG. 3D is a schematic diagram illustrating in side view, operation of optical layers in the optical stack of FIG. 1A wherein the polarisation switch is arranged to provide wide-angle state of operation;

FIG. 4A is a schematic diagram illustrating a perspective front view of a laptop computer illuminated by an ambient light source comprising a switchable privacy display device operating in privacy mode;

FIG. 4B is a schematic diagram illustrating a look-down off-axis perspective view of a laptop computer illuminated by an ambient light source comprising a switchable privacy display device operating in privacy mode.

FIG. 4C is a schematic diagram illustrating a perspective front view of a laptop computer illuminated by an ambient light source comprising a switchable privacy display device operating in share mode;

FIG. 4D is a schematic diagram illustrating a look-down off-axis perspective view of a laptop computer illuminated by an ambient light source comprising a switchable privacy display device operating in share mode;

FIG. 5A is a schematic diagram illustrating in perspective side view an in-plane polariser;

FIG. 5B is a schematic diagram illustrating in perspective side view an out-of-plane polariser comprising an absorption axis with no in-plane component;

FIG. 5C is a schematic diagram illustrating in perspective side view an out-of-plane polariser comprising an absorption axis with an in-plane component;

FIG. 6A is a schematic diagram illustrating in perspective side view operation of a birefringent lens array, out-of-plane polariser, switchable layer of liquid crystal material and an in-plane display polariser for light rays, inclined in lateral and elevation directions for the narrow-angle state of operation;

FIG. 6B is a schematic diagram illustrating in perspective side view operation of a birefringent lens array, out-of-plane polariser, switchable layer of liquid crystal material and an in-plane display polariser for light rays, inclined in lateral and elevation directions for the wide-angle state of operation;

FIG. 7A is a schematic diagram illustrating in perspective side view a polarisation switch arranged between an in-plane polariser and an out-of-plane polariser;

FIG. 7B is a schematic graph illustrating a polar variation of transmission for the arrangement of FIG. 7A for operation in the second mode;

FIG. 7C is a schematic graph illustrating a polar variation of transmission for the arrangement of FIG. 7A for operation in the first mode;

FIG. 8A is a schematic diagram illustrating in perspective side view a polarisation switch arranged between an in-plane polariser, a biaxial retarder and an out-of-plane polariser;

FIG. 8B is a schematic diagram illustrating in perspective front view, an alternative biaxial retarder arrangement comprising an A-plate and a negative C-plate;

FIG. 8C is a schematic diagram illustrating in perspective front view, an alternative biaxial retarder arrangement comprising an A-plate and a positive C-plate;

FIG. 8D is a schematic diagram illustrating in perspective top view an out-of-plane polariser;

FIG. 8E is a schematic diagram illustrating in perspective left side view an out-of-plane polariser;

FIG. 8F is a schematic diagram illustrating in perspective upper left quadrant view an out-of-plane polariser;

FIG. 8G is a schematic graph illustrating a polar variation of output polarisation state from an out-of-plane polariser without a biaxial retarder arrangement;

FIG. 8H is a schematic graph illustrating a polar variation of output polarisation state from an out-of-plane polariser arranged with a desirable biaxial retarder arrangement;

FIG. 8I is a schematic diagram illustrating in perspective top view propagation of a polarisation state through an out-of-plane polariser and a biaxial retarder arrangement;

FIG. 8J is a schematic diagram illustrating in perspective left side view propagation of a polarisation state through an out-of-plane polariser and a biaxial retarder arrangement;

FIG. 8K is a schematic diagram illustrating in perspective upper left quadrant view propagation of a polarisation state through an out-of-plane polariser and a biaxial retarder arrangement;

FIG. 8L is a schematic graph illustrating a polar variation of transmission for the arrangement of FIG. 8A;

FIG. 9A is a schematic diagram illustrating in top view a switchable light dispersion and absorption arrangement comprising a twisted nematic polarisation switch layer arranged in narrow-angle state;

FIG. 9B is a schematic diagram illustrating in top view a switchable light dispersion and absorption arrangement comprising a twisted nematic polarisation switch layer arranged in wide-angle state;

FIG. 9C is a schematic graph illustrating is a schematic graph illustrating a polar variation of transmission for the arrangement of FIG. 9B, the display device arrangement of TABLE 2, the biaxial retarder arrangement of TABLE 3A and the polarisation switch of TABLE 4;

FIG. 9D is a schematic diagram illustrating in perspective front view a polarisation switch comprising a vertically aligned polarisation switch layer with privacy and share mode regions;

FIG. 9E is a schematic graph illustrating a polar variation of transmission for the polarisation switch of FIG. 9D the display device arrangement of TABLE 2, the biaxial retarder arrangement 730 of TABLE 3A and the polarisation switch of TABLE 5;

FIG. 10A is a schematic diagram illustrating in top view a collimated backlight and output cone;

FIG. 10B is a schematic graph illustrating a polar variation of luminance for an illustrative embodiment of FIG. 10A wherein the backlight comprises the light source array, optical waveguide and light turning film of FIG. 1A;

FIG. 10C is a schematic diagram illustrating in top view the optical stack of a display device 100 not comprising a biaxial retarder and operating in privacy mode;

FIG. 10D is a schematic graph illustrating a polar variation of luminance for an illustrative embodiment of FIG. 10C comprising the backlight profile of FIG. 10B and the transmission profile of FIG. 7B;

FIG. 10E is a schematic graph illustrating a polar variation of security factor for 1 lux/nit illuminance to peak luminance ratio for an illustrative embodiment of FIGS. 10C-D and including front surface reflection from the display device;

FIG. 10F is a schematic diagram illustrating in top view the optical stack of a display device further comprising a biaxial retarder and operating in privacy mode;

FIG. 10G is a schematic graph illustrating a polar variation of luminance for an illustrative embodiment of FIG. 10F comprising the backlight profile of FIG. 10B and the transmission profile of FIG. 8L;

FIG. 10H is a schematic graph illustrating a polar variation of security factor for 1 lux/nit illuminance to peak luminance ratio for an illustrative embodiment of FIGS. 10F-G and including front surface reflection from the display device;

FIG. 11A is a schematic diagram illustrating in top view a collimated backlight, a structured birefringent component and output cone;

FIG. 11B is a schematic graph illustrating a polar variation of luminance for an illustrative embodiment of FIG. 11A wherein the backlight comprises the light source array, optical waveguide and light turning film of FIG. 1A and the structured birefringent component is arranged to disperse light in the lateral direction;

FIG. 11C is a schematic diagram illustrating in top view a collimated backlight, a structured birefringent component a twisted nematic liquid crystal polarisation switch and a display polariser;

FIG. 11D is a schematic graph illustrating a polar variation of luminance for an illustrative embodiment of FIG. 11C wherein the backlight comprises the light source array, optical waveguide and light turning film of FIG. 1A, the structured birefringent component is arranged to disperse light in the lateral direction, and the transmission profile of the twisted nematic liquid crystal polarisation switch is as illustrated in FIG. 9C;

FIG. 12A is a schematic diagram illustrating in perspective front view a birefringent component comprising a surface of birefringent layer comprising a one-dimensional random structure;

FIG. 12B is a schematic diagram illustrating in perspective front view a birefringent component comprising a surface of birefringent layer comprising a two-dimensional random structure;

FIG. 12C is a schematic diagram illustrating in top view a birefringent component comprising a surface of birefringent layer comprising a lens array structure;

FIG. 12D is a schematic diagram illustrating in top view a birefringent component comprising a surface of birefringent layer comprising a prismatic array structure;

FIG. 12E is a schematic diagram illustrating in top view a birefringent component comprising a first surface of birefringent layer comprising a lens array structure and a second surface relief birefringent layer comprising a prismatic structure;

FIG. 12F is a schematic diagram illustrating in perspective front view a diffractive structured birefringent component;

FIG. 12G is a schematic graph illustrating a profile of diffracted luminance into diffractive orders for the embodiment of FIG. 12F in wide-angle state;

FIG. 12H is a schematic diagram illustrating in top view a birefringent component comprising a surface of birefringent layer comprising a diffractive and refractive prismatic structure;

FIG. 13A is a schematic diagram illustrating in top view a birefringent component comprising an alternative alignment of birefringent material;

FIG. 13B is a schematic diagram illustrating in top view a birefringent component comprising an alternative material arrangement;

FIG. 13C is a schematic diagram illustrating in top view a step in the manufacture of a birefringent component comprising an arrangement of surface alignment layers;

FIG. 13D is a schematic diagram illustrating in top view a birefringent component comprising an alternative arrangement of surface alignment layers;

FIG. 13E is a schematic diagram illustrating in perspective side view a view angle control optical element comprising a structured birefringent component, a polarisation switch and a biaxial retarder;

FIG. 13F is a schematic diagram illustrating in perspective side view a view angle control optical element comprising a structured birefringent component, a polarisation switch and an in-plane polariser;

FIG. 14A, FIG. 14B, FIG. 14C, FIG. 14D, FIG. 14E, FIG. 14F, FIG. 14G, FIG. 14H and FIG. 14I are schematic diagrams illustrating in top view various alternative structures of display device optical stacks;

FIG. 15A is a schematic diagram illustrating in perspective side view an alternative switchable privacy display device comprising the arrangement of FIG. 1A and further comprising a reflective polariser, a switchable liquid crystal retarder and an additional polariser arranged to receive light from the further display polariser of the spatial light modulator;

FIG. 15B is a schematic diagram illustrating in perspective front view, alignment of optical layers in spatial light modulator and output layers of the optical stack of FIG. 15A;

FIG. 15C is a schematic diagram illustrating in top view, operation of optical layers in the optical stack of FIG. 15A wherein the polarisation switch and switchable liquid crystal retarder are arranged to provide narrow-angle state of operation;

FIG. 15D is a schematic graph illustrating a polar variation of transmission for the switchable liquid crystal retarder arrangement of FIG. 15A and TABLE 6-7 in narrow-angle state;

FIG. 15E is a schematic graph illustrating a polar variation of reflectivity for the switchable liquid crystal retarder arrangement of FIG. 15A and TABLE 6-7 in narrow-angle state;

FIG. 15F is a schematic graph illustrating a polar variation of transmission for the switchable liquid crystal retarder arrangement of FIG. 15A and TABLE 6-7 in wide-angle state;

FIG. 15G is a schematic graph illustrating a polar variation of reflectivity for the switchable liquid crystal retarder arrangement of FIG. 15A and TABLE 6-7 in wide-angle state;

FIG. 15H is a schematic graph illustrating a polar variation of security factor for 1 lux/nit illuminance to peak luminance ratio for an illustrative embodiment of FIGS. 10F-G and FIGS. 15C-D and including front surface reflection from the display device;

FIG. 15I is a schematic diagram illustrating in top view an automotive vehicle comprising the display device of the present disclosure;

FIG. 15J is a schematic diagram illustrating in perspective side view an alternative switchable privacy display device comprising the arrangement of FIG. 1A and further comprising an additional polariser that is the in-plane polariser, a passive compensation retarder, a switchable liquid crystal retarder and arranged on the input side of a transmissive spatial light modulator;

FIG. 16A is a schematic diagram illustrating in perspective side view a switchable privacy display device comprising an OLED emissive spatial light modulator; a parallax barrier, a birefringent lens array, out-of-plane polariser; polarisation switch, and display polariser arranged on the output side of the spatial light modulator;

FIG. 16B is a schematic diagram illustrating in perspective front view, alignment of optical layers in the optical stack of FIG. 16A;

FIG. 16C is a schematic diagram illustrating in top view the switchable privacy display device of FIG. 16A arranged in the privacy mode of operation;

FIG. 16D is a schematic diagram illustrating in top view the switchable privacy display device of FIG. 16A arranged in the privacy mode of operation;

FIG. 16E is a schematic diagram illustrating in top view reduction of stray light by reflection from birefringent lenses in privacy mode of operation;

FIG. 16F is a schematic graph illustrating the polar variation of luminance output for the embodiment of FIG. 16C in privacy mode of operation for the case of Lambertian emission of light from the pixels of the spatial light modulator omitting the out-of-plane polariser;

FIG. 16G is a schematic graph illustrating the polar variation of luminance output for the embodiment of FIG. 16C in privacy mode of operation for the case of Lambertian emission of light from the pixels of the spatial light modulator wherein the out-of-plane polariser is provided;

FIG. 16H is a schematic graph illustrating a polar variation of security factor for 1 lux/nit illuminance to peak luminance ratio for an illustrative embodiment of FIG. 16C wherein the out-of-plane polariser is provided and further comprising a polar control retarder and additional polariser of FIG. 15A and FIGS. 15D-E;

FIG. 16I is a schematic graph illustrating the polar variation of luminance output for the embodiment of FIG. 16D in share mode of operation for the case of Lambertian emission of light from the pixels of the spatial light modulator;

FIG. 16J is a schematic diagram illustrating in top view an alternative display device wherein the parallax barrier is provided by a first colour filter array and a second colour filter array is provided in a layer between the parallax barrier and the lens array;

FIG. 17A is a schematic diagram illustrating in perspective side view operation of a birefringent lens array, half wave retarder, out-of-plane polariser, switchable layer of liquid crystal material and an in-plane display polariser for light rays, inclined in lateral and elevation directions for the narrow-angle state of operation;

FIG. 17B is a schematic diagram illustrating in perspective side view operation of a birefringent lens array, half wave retarder, out-of-plane polariser, switchable layer of liquid crystal material and an in-plane display polariser for light rays, inclined in lateral and elevation directions for the wide-angle state of operation;

FIG. 18A is a schematic diagram illustrating in perspective side view a switchable privacy display device comprising an OLED emissive spatial light modulator; birefringent lens array, out-of-plane polariser; polarisation switch, and display polariser arranged on the output side of the spatial light modulator;

FIG. 18B is a schematic diagram illustrating in top view the switchable privacy display device of FIG. 18A arranged in the privacy mode of operation;

FIG. 18C is a schematic diagram illustrating in perspective front view, alignment of optical layers in the optical stack of FIG. 18A;

FIG. 19A, FIG. 19B, FIG. 19C, FIG. 19D, and FIG. 19E are schematic diagrams illustrating in top view various alternative structures of display device optical stacks;

FIG. 19F, FIG. 19G, FIG. 19H, FIG. 19I, FIG. 19J, FIG. 19K, FIG. 19L and FIG. 19M are schematic diagrams illustrating in top view various alternative structures of display device optical stacks comprising polarisation switch and in-plane polariser;

FIG. 20A is a schematic diagram illustrating in perspective side in perspective side view an alternative backlight comprising addressable first and second arrays of light sources;

FIG. 20B is a schematic diagram illustrating in perspective side view an alternative backlight comprising first and second waveguides and respective aligned first and second arrays of light sources;

FIG. 20C is a schematic diagram illustrating in top view operation of the backlight of FIG. 20B;

FIG. 20D is a schematic diagram illustrating in perspective rear view a light turning component;

FIG. 20E is a schematic diagram illustrating in top view a light turning component;

FIG. 21A is a schematic diagram illustrating in perspective side view an alternative backlight comprising an array of light sources that may be mini-LEDs and an array of light deflecting wells;

FIG. 21B is a schematic diagram illustrating in perspective side view an alternative backlight comprising an array of light sources provided on the edge of a waveguide, crossed brightness enhancement films, light control components; and an out-of-plane polariser arranged to output light to an additional polariser;

FIG. 22 is a schematic diagram illustrating in perspective side view the operation of a backlight comprising a light turning component, and a micro-louvre component;

FIG. 23A is a schematic diagram illustrating in perspective side view an alternative backlight comprising a light scattering waveguide, a rear reflector, crossed prismatic films and a light control element comprising louvres of thickness t1 with pitch pl and louvre width al arranged between light transmissive regions of width sl; and arranged on substrate;

FIG. 23B is a schematic diagram illustrating in top view operation of the backlight of FIG. 23A;

FIG. 24A is a schematic diagram illustrating in top view propagation of output light along axes from a SLM through a switchable non-diffractive view angle control arrangement in a narrow-angle state;

FIG. 24B is a schematic diagram illustrating in top view propagation of ambient illumination light through the switchable non-diffractive view angle control arrangement in a narrow-angle state;

FIG. 25A is a schematic diagram illustrating in top view propagation of output light from a SLM through the switchable non-diffractive view angle control arrangement in wide-angle state; and

FIG. 25B is a schematic diagram illustrating in top view propagation of ambient illumination light through the switchable non-diffractive view angle control arrangement in a wide-angle state.

### DETAILED DESCRIPTION

Terms related to optical retarders for the purposes of the present disclosure will now be described.

In a layer comprising a uniaxial birefringent material there is a direction governing the optical anisotropy whereas all directions perpendicular to it (or at a given angle to it) have equivalent birefringence.

The optical axis of an optical retarder refers to the direction of propagation of a light ray in the uniaxial birefringent material in which no birefringence is experienced. This is different from the optical axis of an optical system which may for example be parallel to a line of symmetry or normal to a display surface along which a principal ray propagates.

For light propagating in a direction orthogonal to the optical axis, the optical axis is the slow axis when linearly polarized light with an electric vector direction parallel to the slow axis travels at the slowest speed. The slow axis direction is the direction with the highest refractive index at the design wavelength. Similarly the fast axis direction is the direction with the lowest refractive index at the design wavelength.

For positive dielectric anisotropy uniaxial birefringent materials, the slow axis direction is the extraordinary axis of the birefringent material. For negative dielectric anisotropy uniaxial birefringent materials, the fast axis direction is the extraordinary axis of the birefringent material.

The terms half a wavelength and quarter a wavelength refer to the operation of a retarder for a design wavelength Ao that may typically be between 500 nm and 570 nm. In the present illustrative embodiments exemplary retardance values are provided for a wavelength of 550 nm unless otherwise specified.

The retarder provides a phase shift between two perpendicular polarization components of the light wave incident thereon and is characterized by the amount of relative phase, Γ, that it imparts on the two polarization components: which is related to the birefringence Δn and the thickness d of the retarder by

$$Γ = 2 \cdot π \cdot Δ n \cdot d / {λ}_{0} \qquad eqn . l$$

In eqn. 1, Δn is defined as the difference between the extraordinary and the ordinary index of refraction, i.e.

$$Δ n = {n}_{e} - {n}_{o} \qquad eqn . 2$$

For a half-wave retarder, the relationship between d, Δn, and λ₀ is chosen so that the phase shift between polarization components is Γ=π. For a quarter-wave retarder, the relationship between d, Δn, and Ao is chosen so that the phase shift between polarization components is Γ=π/2. The term half-wave retarder herein typically refers to light propagating normal to the retarder and normal to the spatial light modulator.

An absorption type polariser transmits light waves of a specific polarisation state and absorbs light (in a spectral waveband) of different polarisation states which may be orthogonal polarisation states to the specific polarisation state. For a given wavefront, an absorptive linear polariser absorbs light waves of a specific linear polarisation state and transmits light waves of the orthogonal polarisation state of the wavefront. The absorptive linear polariser comprises an absorption axis with unit vector direction kₑ which may alternatively be termed the optical axis or the director of the absorption material. Orthogonal directions kₒ to the absorption axis direction may be termed transmission axes.

A dichroic material has different absorption coefficients αₑ, αₒ for light polarized in different directions, where the complex extraordinary refractive index is:

$$\vec{{n}_{e}} = {n}_{e} + i \cdot {α}_{e} \qquad eqn . 3 A$$

and the complex ordinary refractive index is:

$$\vec{{n}_{o}} = {n}_{o} + i \cdot {α}_{o} \qquad eqn . 3 B$$

Absorptive linear polarisers may comprise a dichroic material such a dye or iodine. During manufacture a polyvinyl alcohol (PVA) layer is stretched so that the PVA chains align in one particular direction. The PVA layer is doped with iodine molecules, from which valence electrons are able to move linearly along the polymer chains, but not transversely. An incident polarisation state parallel to the chains is, at least in part, absorbed and the perpendicular polarisation state is substantially transmitted. Such a polariser may conveniently provide an in-plane polariser, that is a polariser wherein the absorption axis of the dichroic material is in a direction in which the plane of the polariser extends, as opposed to an out-of-plane polariser which has an absorption axis which has at least a component that is orthogonal to the plane of the out-of-plane polariser.

Another type of absorptive linear polariser is a liquid crystal dye type dichroic linear polariser. A thermotropic liquid crystal material is doped with a dye, and the liquid crystal material is aligned during manufacture, or by an electric field. The liquid crystal layers may be untwisted, or may incorporate a twist from one side of the device to the other. Alternatively, alignment may be provided by lyotropic liquid crystal molecules that self-align onto a surface by provision of amphiphilic compounds (with hydrophilic and hydrophobic molecular groups) during manufacture. The alignment may be aided by mechanical movement of the liquid by for example a Meyer rod in a coating machine. The liquid crystal material may be a curable liquid crystal material. The dye may comprise an organic material that is aligned by the liquid crystal material or is provided in the liquid crystal molecules or may comprise silver nano-particles. Such polarisers may provide in-plane polarisers or may provide out-of-plane polarisers, wherein the optical axis direction kₑ or the absorption axis is out of the plane of the polariser. The directions kₒ of the transmission axes may be in the plane of the out-of-plane polariser. The direction kₑ may alternatively be referred to as the extraordinary axis direction and the directions kₒ may be referred to as the ordinary axis directions of the dichroic molecules.

If the absorbing dye molecules are rod-shaped then the polariser absorbs along a single axis and transmits on orthogonal axes. If the absorbing dye molecules are disc-shaped rather than rod-shaped, then the polariser can absorb two orthogonal axes and transmit the third.

Some aspects of the propagation of light rays through a transparent retarder between a pair of polarisers will now be described.

The state of polarisation (SOP) of a light ray is described by the relative amplitude and phase shift between any two orthogonal polarization components. Transparent retarders do not alter the relative amplitudes of these orthogonal polarisation components but act only on their relative phase. Providing a net phase shift between the orthogonal polarisation components alters the SOP whereas maintaining net relative phase preserves the SOP. In the current disclosure, the SOP may be termed the polarisation state.

A linear SOP has a polarisation component with a non-zero amplitude and an orthogonal polarisation component which has zero amplitude.

A linear polariser transmits a unique linear SOP that has a linear polarisation component parallel to the electric vector transmission direction of the linear polariser and attenuates light with a different SOP. The term “electric vector transmission direction” refers to a non-directional axis of the polariser parallel to which the electric vector of incident light is transmitted, even though the transmitted “electric vector” always has an instantaneous direction. The term “direction” is commonly used to describe this axis.

Absorbing polarisers are polarisers that absorb one polarisation component of incident light and transmit a second orthogonal polarisation component. Examples of absorbing linear polarisers are dichroic polarisers.

Reflective polarisers are polarisers that reflect one polarisation component of incident light and transmit a second orthogonal polarisation component. Examples of reflective polarisers that are linear polarisers are multilayer polymeric film stacks such as DBEF™ or APF™ from 3M Corporation, or wire grid polarisers such as ProFlux™ from Moxtek. Reflective linear polarisers may further comprise cholesteric reflective materials and a quarter waveplate arranged in series.

A retarder arranged between a linear polariser and a parallel linear analysing polariser that introduces no relative net phase shift provides full transmission of the light other than residual absorption within the linear polariser.

A retarder that provides a relative net phase shift between orthogonal polarisation components changes the SOP and provides attenuation at the analysing polariser.

In the present disclosure an ‘A-plate’ refers to an optical retarder utilizing a layer of birefringent material with its optical axis parallel to the plane of the layer.

A ‘positive A-plate’ refers to positively birefringent A-plates, i.e. A-plates with a positive Δn.

In the present disclosure a ‘C-plate’ refers to an optical retarder utilizing a layer of birefringent material with its optical axis perpendicular to the plane of the layer. A ‘positive C-plate’ refers to positively birefringent C-plates, i.e. C-plates with a positive Δn. A ‘negative C-plate’ refers to negatively birefringent C-plates, i.e. C-plates with a negative Δn.

‘O-plate’ refers to an optical retarder utilizing a layer of birefringent material with its optical axis having a component parallel to the plane of the layer and a component perpendicular to the plane of the layer. A ‘positive O-plate’ refers to positively birefringent O-plates, i.e. O-plates with a positive Δn.

A biaxial-plate or ‘B-plate’ is a non-chiral retarder that has three different principal refractive indices nx, ny, nz wherein:

$$nx \neq ny \neq nz \qquad eqn . 4 A$$

The out-of-plane retardation of a B-plate is described by the parameter Rth wherein:

$$R th = ( ( nx + ny ) / 2 - nz ) d \qquad eqn . 4 B$$

A B-plate is typically fabricated by stretching organic polymer films along two orthogonal in-plane directions that become two of the three principal axes; the third being orthogonal to both and out-of-plane. The direction that is stretched the most induces the largest principal refractive index along that same direction. A smaller refractive index results along the orthogonal in-plane stretch direction leaving the smallest third principal refractive index out-of-plane.

The angular dependence of birefringence is different between uniaxial A-plates, uniaxial C-plates and biaxial B-plates. In particular A-plates and C-plates have only one propagation direction with no birefringence whereas B-plates can achieve increased control of modification of output polarisation states with respect to transmission angle.

Achromatic retarders may be provided wherein the material of the retarder is provided with a retardance Δn·d that varies with wavelength λ as

$$Δ n \cdot d / λ = σ \qquad eqn . 5$$

where σ is substantially a constant.

Examples of suitable materials include modified polycarbonates from Teijin Films. Achromatic retarders may be provided in the present embodiments to advantageously minimise colour changes between polar angular viewing directions which have low luminance reduction and polar angular viewing directions which have increased luminance reductions as will be described below.

Various other terms used in the present disclosure related to retarders and to liquid crystals will now be described.

A liquid crystal cell has a retardance given by Δn·d where Δn is the birefringence of the liquid crystal material in the liquid crystal cell and d is the thickness of the liquid crystal cell, independent of the alignment of the liquid crystal material in the liquid crystal cell.

Homogeneous alignment refers to the alignment of liquid crystals in liquid crystal displays where molecules align substantially parallel to a substrate. Homogeneous alignment is sometimes referred to as planar alignment. Homogeneous alignment may typically be provided with a small pre-tilt such as 2 degrees, so that the molecules at the surfaces of the alignment layers of the liquid crystal cell are slightly inclined as will be described below. Pretilt is arranged to minimise degeneracies in switching of cells or in alignment of curable liquid crystal layers before a curing step.

In the present disclosure, homeotropic alignment is the state in which rod-like liquid crystalline molecules align substantially perpendicularly to the substrate. In discotic liquid crystals homeotropic alignment is defined as the state in which an axis of the column structure, which is formed by disc-like liquid crystalline molecules, aligns perpendicularly to a surface. In homeotropic alignment, pretilt is the tilt angle of the molecules that are close to the alignment layer and is typically close to 90 degrees and for example may be 88 degrees.

In a twisted liquid crystal layer, a twisted configuration (also known as a helical structure or helix) of nematic liquid crystal molecules is provided. The twist may be achieved by means of a non-parallel alignment of alignment layers. Further, cholesteric dopants may be added to the liquid crystal material to break degeneracy of the twist direction (clockwise or anti-clockwise) and to further control the pitch of the twist in the relaxed (typically undriven) state. A supertwisted liquid crystal layer has a twist of greater than 180 degrees. A twisted nematic layer used in spatial light modulators typically has a twist of 90 degrees.

Liquid crystal molecules with positive dielectric anisotropy may be switched from a homogeneous alignment (such as an A-plate retarder orientation) to a homeotropic alignment (such as a C-plate or O-plate retarder orientation) by means of an applied electric field.

Liquid crystal molecules with negative dielectric anisotropy may be switched from a homeotropic alignment (such as a C-plate or O-plate retarder orientation) to a homogeneous alignment (such as an A-plate retarder orientation) by means of an applied electric field.

Rod-like molecules have a positive birefringence so that nₑ>nₒ as described in eqn. 2. Discotic molecules have negative birefringence so that nₑ<nₒ.

Positive retarders such as A-plates, positive O-plates and positive C-plates may typically be provided by stretched films or rod-like liquid crystal molecules. Negative retarders such as negative C-plates may be provided by stretched films or discotic-like liquid crystal molecules.

Parallel liquid crystal cell alignment refers to the alignment direction of homogeneous alignment layers being parallel or more typically antiparallel. In the case of pre-tilted homeotropic alignment, the alignment layers may have components that are substantially parallel or antiparallel. Hybrid aligned liquid crystal cells may have one homogeneous alignment layer and one homeotropic alignment layer. Twisted liquid crystal cells may be provided by alignment layers that do not have parallel alignment, for example oriented at 90 degrees to each other.

Transmissive spatial light modulators may further comprise retarders between the input display polariser and the output display polariser for example as disclosed in U.S. Pat. No. 8,237,876, which is herein incorporated by reference in its entirety. Such retarders (not shown) are in a different place to the passive retarders of the present embodiments. Such retarders compensate for contrast degradations for off-axis viewing locations, which is a different effect to the luminance reduction for off-axis viewing positions of the present embodiments.

A private mode of operation of a display is one in which a viewer sees a low contrast sensitivity such that an image is not clearly visible. Contrast sensitivity is a measure of the ability to discern between luminances of different levels in a static image. Inverse contrast sensitivity may be used as a measure of visual security, in that a high visual security level (VSL) corresponds to low image visibility.

For a privacy display providing an image to a viewer, visual security may be given as:

$$V = ( Y + R ) / ( Y - K ) \qquad eqn . 6$$

where V is the visual security level (VSL), Y is the luminance of the white state of the display at a snooper viewing angle (which may be termed a non-viewing direction), K is the luminance of the black state of the display at the snooper viewing angle and R is the luminance of reflected light from the display.

Panel contrast ratio is given as:

$$C = Y / K \qquad eqn . 7$$

so the visual security level may be further given as:

$$V = ( P \cdot {Y}_{max} + I \cdot ρ / π ) / ( P \cdot ( {Y}_{max} - {Y}_{max} / C ) ) \qquad eqn . 8$$

where: Yₘₐₓ is the maximum luminance of the display; P is the off-axis relative luminance typically defined as the ratio of luminance at the snooper angle to the maximum luminance Yₘₐₓ; C is the image contrast ratio; ρ is the surface reflectivity; π is a solid angle factor (with units steradians) and I is the illuminance. The units of Yₘₐₓ are the units of I divided by solid angle in units of steradian.

The luminance of a display varies with angle and so the maximum luminance of the display Yₘₐₓ occurs at a particular angle that depends on the configuration of the display.

In many displays, the maximum luminance Yₘₐₓ occurs head-on, i.e. normal to the display. Any display device disclosed herein may be arranged to have a maximum luminance Yₘₐₓ that occurs head-on, in which case references to the maximum luminance of the display device Yₘₐₓ may be replaced by references to the luminance normal to the display device.

Alternatively, any display described herein may be arranged to have a maximum luminance Yₘₐₓ that occurs at a polar angle to the normal to the display device that is greater than 0°. By way of example, the maximum luminance Yₘₐₓ may occur at a non-zero polar angle and at an azimuth angle that has for example zero lateral angle so that the maximum luminance is for an on-axis user that is looking down on to the display device. The polar angle may for example be 10 degrees and the azimuthal angle may be the northerly direction (90 degrees anti-clockwise from easterly direction). The viewer may therefore desirably see a high luminance at typical non-normal viewing angles.

The off-axis relative luminance, P is sometimes referred to as the privacy level. However, such privacy level P describes relative luminance of a display at a given polar angle compared to head-on luminance, and in fact is not a measure of privacy appearance.

The illuminance, I is the luminous flux per unit area that is incident on the display and reflected from the display towards the viewer location. For Lambertian illuminance, and for displays with a Lambertian front diffuser illuminance I is invariant with polar and azimuthal angles. For arrangements with a display with non-Lambertian front diffusion arranged in an environment with directional (non-Lambertian) ambient light, illuminance I varies with polar and azimuthal angle of observation.

Thus in a perfectly dark environment, a high contrast display has VSL of approximately 1.0. As ambient illuminance increases, the perceived image contrast degrades, VSL increases and a private image is perceived.

For typical liquid crystal displays the panel contrast C is above 100:1 for almost all viewing angles, allowing the visual security level to be approximated to:

$$V = 1 + I \cdot ρ / ( π \cdot P \cdot {Y}_{max} ) \qquad eqn . 9$$

In the present embodiments, in addition to the exemplary definition of eqn. 6, other measurements of visual security level, V may be provided, for example to include the effect on image visibility to a snooper of snooper location, image contrast, image colour and white point and subtended image feature size. Thus the visual security level may be a measure of the degree of privacy of the display but may not be restricted to the parameter V.

The perceptual image security may be determined from the logarithmic response of the eye, such that a Security Factor, S is given by:

$$S = {log}_{10} ( V ) \qquad eqn . 10$$

$$S = {log}_{10} ( 1 + α \cdot ρ / ( π \cdot P ) ) \qquad eqn . 11$$

where α is the ratio of illuminance I to maximum luminance Yₘₐₓ.

Desirable limits for S were determined in the following manner. In a first step a privacy display device was provided. Measurements of the variation of privacy level, P(θ) of the display device with polar viewing angle and variation of reflectivity ρ(θ) of the display device with polar viewing angle were made using photopic measurement equipment. A light source such as a substantially uniform luminance light box was arranged to provide illumination from an illuminated region that was arranged to illuminate the privacy display device along an incident direction for reflection to a viewer positions at a polar angle of greater than 0° to the normal to the display device. The variation I(θ) of illuminance of a substantially Lambertian emitting lightbox with polar viewing angle was determined by and measuring the variation of recorded reflective luminance with polar viewing angle taking into account the variation of reflectivity ρ(θ). The measurements of P(θ), ρ(θ) and I(θ) were used to determine the variation of Security Factor S(O) with polar viewing angle along the zero-elevation axis.

In a second step a series of high contrast images were provided on the privacy display including (i) small text images with maximum font height 3 mm, (ii) large text images with maximum font height 30 mm and (iii) moving images.

In a third step each viewer (with eyesight correction for viewing at 1000 mm where appropriate) viewed each of the images from a distance of 1000 mm, and adjusted their polar angle of viewing at zero elevation until image invisibility was achieved for one eye from a position near on the display at or close to the centre-line of the display. The polar location of the viewer's eye was recorded. From the relationship S(θ), the security factor at said polar location was determined. The measurement was repeated for the different images, for various display luminance Yₘₐₓ, different lightbox illuminance I(θ=0), for different background lighting conditions and for different viewers.

From the above measurements S<1.0 provides low or no visual security, and S≥1 makes the image not visible. In the range 1.0≤S<1.5, even though the image is not visible for practical purposes, some features of the image may still be perceived dependent on the contrast, spatial frequency and temporal frequency of image content, whereas in the range 1.5≤S<1.8, the image is not visible for most images and most viewers and in the range S≥1.8 the image is not visible, independent of image content for all viewers.

In practical display devices, this means that it is desirable to provide a value of S for an off-axis viewer who is a snooper that meets the relationship S≥Sₘᵢₙ, where: Sₘᵢₙ has a value of 1.0 or more to achieve the effect that in practical terms the displayed image is not visible to the off-axis viewer.

At an observation angle θ in question, the security factor Sₙ for a region of the display labelled by the index n is given from eqn. 10 and eqn. 11 by:

$${S}_{n} ( θ ) = l o {g}_{10} [ 1 + {ρ}_{n} ( θ ) \cdot α ( θ ) / ( π \cdot {P}_{n} ( θ ) ) ] \qquad eqn . 12$$

where: α is the ratio of illuminance I(θ) onto the display that is reflected from the display to the angle in question and with units lux (lumen·m⁻²), to maximum luminance Yₘₐₓ with units of nits (lumen·m⁻²·sr⁻¹) where the units of a are steradians, π is a solid angle in units of steradians, ρₙ(θ) is the reflectivity of the display device along the observation direction in the respective n^{th} region, and Pₙ(θ) is the ratio of the luminance of the display device along the observation direction in the respective n^{th} region.

In human factors measurement, it has been found that desirable privacy displays of the present embodiments described hereinbelow typically operate with security factor Sₙ≥1.0 at the observation angle when the value of the ratio α of illuminance I to maximum luminance Yₘₐₓ is 4.0. For example, the illuminance I(θ=−45°) that illuminates the display and is directed towards the snooper at the observation direction (θ=+45°) after reflection from the display may be 1000 lux and the maximum display illuminance Yₘₐₓ that is provided for the user may be 250 nits. This provides an image that is not visible for a wide range of practical displays.

More preferably, the display may have improved characteristics of reflectivity ρₙ(θ=45°) and privacy Pₙ(θ=45°) by operating with security factor Sₙ≥1.0 at the observation angle when the ratio α is 2.0. Such an arrangement desirably improves the relative perceived brightness and contrast of the display to the primary user near to the direction of Yₘₐₓ while achieving desirable security factor, Sₙ≥1.0. Most preferably, the display may have improved characteristics of reflectivity ρₙ(θ=45°) and privacy Pₙ(θ=45°) by operating with security factor Sₙ≥1.0 at the observation angle when the ratio α is 1.0. Such an arrangement achieves desirably high perceived brightness and contrast of the display to the primary user near to the direction of Yₘₐₓ in comparison to the brightness of illuminated regions around the display, while achieving desirable security factor, Sₙ≥1.0 for an off-axis viewer 47 at the observation direction.

The above discussion focusses on reducing visibility of the displayed image to an off-axis viewer who is a snooper, but similar considerations apply to visibility of the displayed image to the intended user of the display device who is typically on-axis. In this case, decrease of the level of the visual security level (VSL) V corresponds to an increase in the visibility of the image to the viewer. During observation S<0.2 may provide acceptable visibility (perceived contrast ratio) of the displayed image and more desirably S<0.1. In practical display devices, this means that it is desirable to provide a value of S for an on-axis viewer who is the intended user of the display device that meets the relationship S≤Sₘₐₓ, where Sₘₐₓ has a value of 0.2.

In the present discussion the colour variation Δε of an output colour (u_{w}′+Δu′, v_{w}′+Δv′) from a desirable white point (u_{w}′, v_{w}′) may be determined by the CIELUV colour difference metric, assuming a typical display spectral illuminant and is given by:

$$Δ ε = {( Δ {u}^{’ 2} + Δ {v}^{’ 2} )}^{1 / 2} \qquad eqn . 13$$

A diffractive effect of a liquid crystal layer relates to the interference or bending of waves around the corners of an obstacle or through an aperture into the region of the geometrical shadow of the obstacle/aperture. The diffractive effect arises from the interaction of plane waves incident onto the phase structure of the layer, rather than the propagation of rays through the layer.

The structure and operation of various privacy display apparatuses will now be described. In this description, common elements have common reference numerals. It is noted that the disclosure relating to any element applies mutatis mutandi to each device in which the same or corresponding element is provided. Accordingly, for brevity such disclosure is not repeated. Similarly, the various features of any of the following examples may be combined together in any combination.

It would be desirable to provide a switchable privacy display with high security factor to off-axis snoopers in a privacy mode of operation and high image visibility to off-axis users in a share mode of operation.

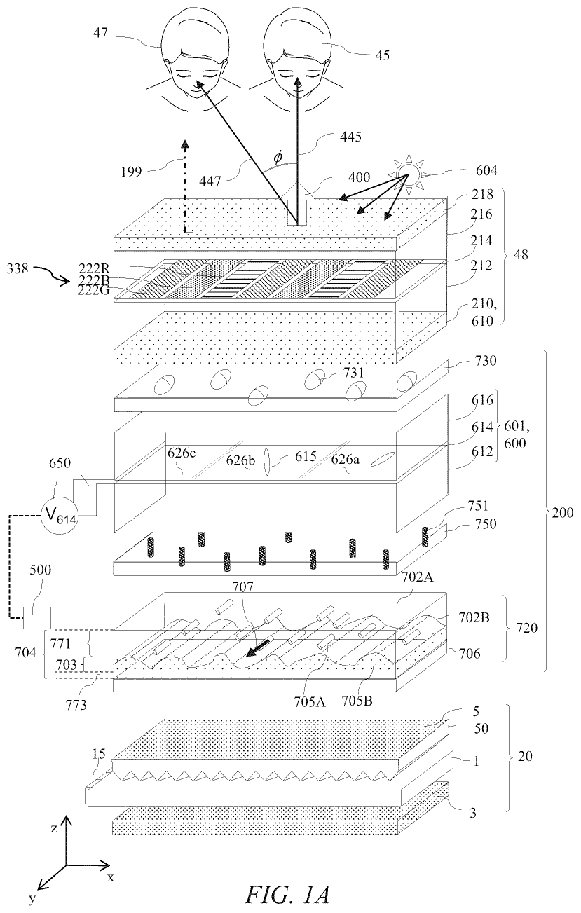

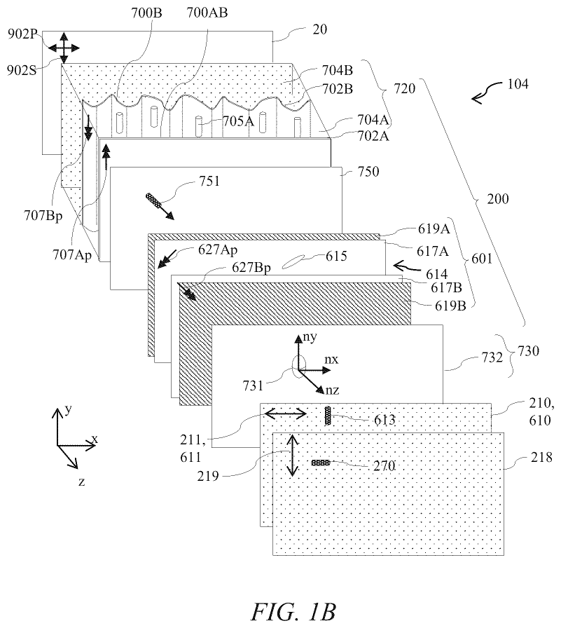

FIG. 1A is a schematic diagram illustrating in perspective side view a switchable privacy display device 100 comprising a backlight 20, a switchable light dispersion and absorption arrangement (SLDAA) 200 comprising a structured birefringent component 720, an out-of-plane polariser 750, a polarisation switch 600 and a transmissive SLM 48 comprising a display polariser 210 that is an in-plane polariser 610 of the SLDAA 200 arranged on the input side of the spatial light modulator (SLM) 48 and a further display polariser 218 arranged on the output side of the SLM 48; and FIG. 1B is a schematic diagram illustrating in perspective front view, alignment of optical layers in the optical stack of the display device 100 of FIG. 1A. Features of the embodiment of FIG. 1B not discussed in further detail may be assumed to correspond to the features with equivalent reference numerals as discussed for FIG. 1A.

FIG. 1A illustrates a display device 100 arranged to illuminate users 45, 47. In a privacy mode of operation (that may be referred to as a narrow-angle state) the user 45 is provided with an image with high image visibility and is located around a nominal user direction 445 that may be parallel to the normal direction 199 to the display device 100, or may be inclined to the normal direction 199. The user 47 in a privacy mode of operation may be termed a snooper 47 and is located in snooper direction 447 that is inclined to the nominal user direction 445, and the display device 100 is intended to provide light output rays in direction 447 with a high security factor. S to the snooper 47. In a share mode of operation (that may be referred to as a wide-angle state), both users 45, 47 are intended to see light output for an image on the display with high image visibility for directions 445, 447. In an illustrative embodiment, the off-axis angle ϕ may be 40° or greater in a laptop display device 100, or may be 25° or greater in an automotive passenger infotainment display device 100. In the present description, the directions 445, 447 may also be referred to as axes 445, 447 where directions 445, 447 indicate typical observer 45, 47 locations and axes 445, 447 indicate typical design considerations for the optical stack which are typically arranged to be the same as the directions 445, 447.

The embodiment of FIG. 1A illustrates a display device 100 comprising the SLM 48 arranged to output spatially modulated light. The display device 100 further comprises a backlight 20 arranged to output light, and the SLM 48 is a transmissive SLM 48 arranged to receive the output light from the backlight 20.

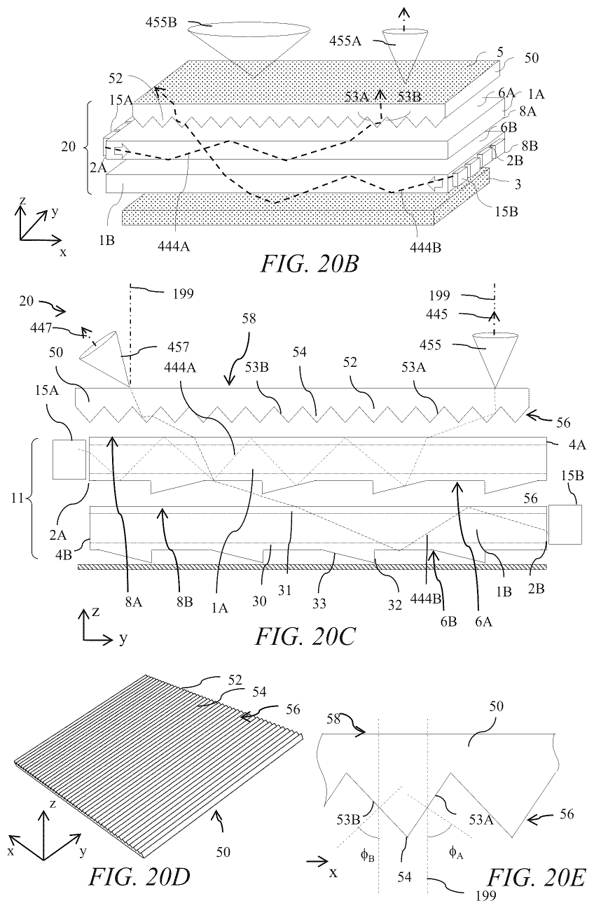

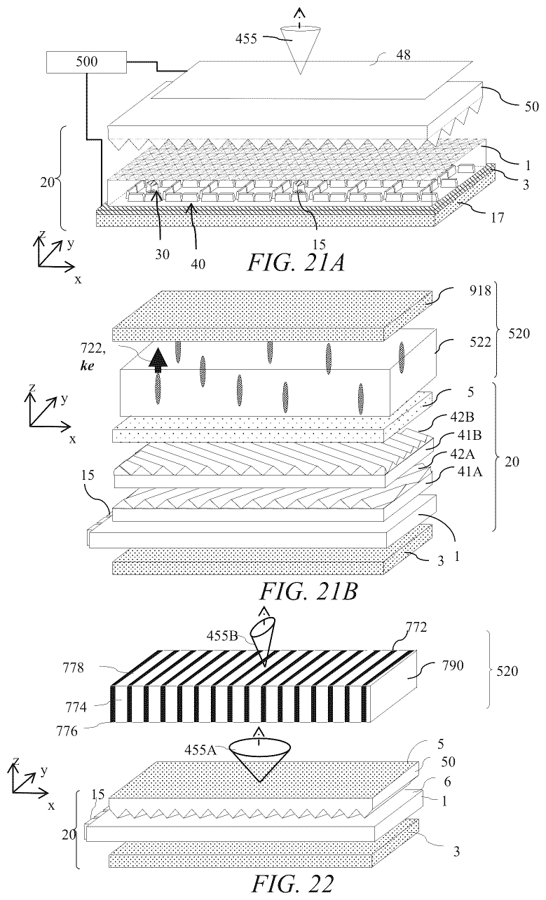

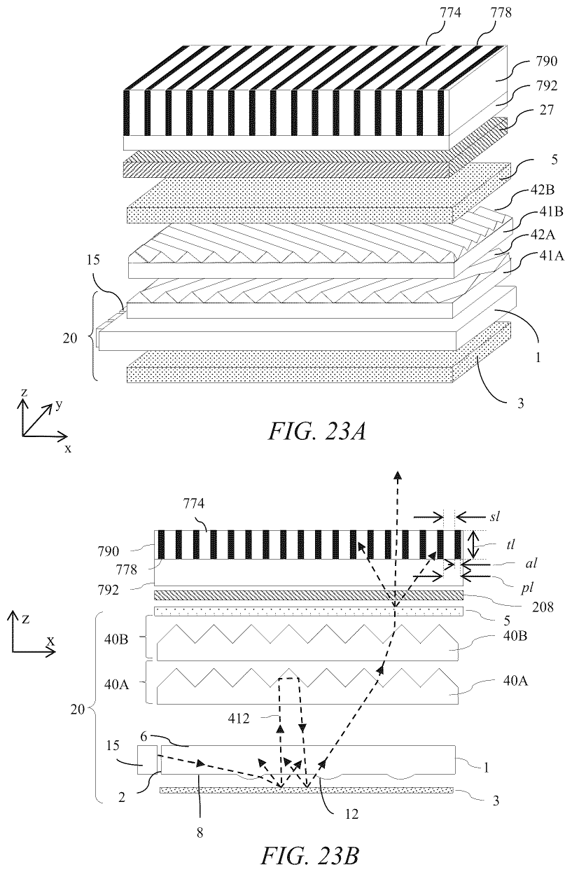

The display device 100 comprises at least one light source that in the embodiment of FIGS. 1A-B is a backlight 20 arranged to output light 400. The backlight 20 comprises a rear reflector 3 and a waveguide arrangement 11 comprising waveguide 1, light sources 15, light turning film 50 and light control components 5 that may comprise diffusers and arranged to receive light exiting from the waveguide 1 and directed through the SLM 48. Other types of backlight 20 are described hereinbelow and may be provided as alternatives to the backlight 20 of FIG. 1A, for example as illustrated in FIGS. 20A-E, FIGS. 21A-B, FIGS. 22A-B and FIGS. 23A-B. The backlight 20 of FIG. 1A may be referred to as a collimated backlight and desirably provides a luminance at polar angles to the normal direction 199 to the display device 100 greater than 45 degrees that is at most 33% of the luminance along the normal direction 199 to the display device 100, preferably at most 20% of the luminance along the normal to the display device 100, and most preferably at most 10% of the luminance along the normal to the display device 100.

The SLM 48 comprises a liquid crystal display device comprising transparent substrates 212, 216, and liquid crystal layer 214 having red, green and blue pixels 220, 222, 224. The SLM 48 has the display polariser 210 which is an input polariser; and the further display polariser 218 which is an output polariser on opposite sides thereof. The plurality of pixels 222 may further comprise white pixels 222W, yellow pixels 222Y or other coloured emission pixels 2220 (not shown). Advantageously colour gamut may be increased. The pixels 222R, 222G, 222B and pixels 222W, 222Y, 2220 when present together provide an addressable colour pixel 224.

The in-plane polariser 610 that is the display polariser 210 and further display polariser 218 are in-plane polarisers arranged to provide high extinction ratio for light from the pixels 220R, 220G, 220B of the SLM 48 and have electric vector transmission directions 611, 211, 219 respectively.

Typical in-plane display polarisers 210, 218, 610 may be absorbing polarisers such as dichroic polarisers such as an iodine polariser on stretched PVA arranged between TAC layers.

The propagation of light 400 through the optical stack of the display device 100 will now be described.

The at least one light source comprising backlight 20 is arranged to output light 400 towards the structured birefringent component 720 and out-of-plane polariser 750. The structured birefringent component 720 and out-of-plane polariser 750 are arranged to receive the light 400 output from the at least one light source comprising backlight 20 and to output light towards the polarisation switch 600.

The polarisation switch 600 is arranged to receive the light 400 output from the structured birefringent component 720 and out-of-plane polariser 750 and to output light 400 towards the in-plane polariser 610 that is the display polariser 210 of the SLM 48.

The in-plane polariser 610 is arranged to receive the light output from the polarisation switch 600 and to output light for forming the image 338. The in-plane polariser 610 is a linear polariser arranged to output light having a linear polarisation state provided by the electric vector transmission direction 611 of the in-plane polariser 610.

The out-of-plane polariser 750 is arranged between the structured birefringent component 720 and the polarisation switch 600. The structured birefringent component 720 is arranged between the at least one light source that is backlight 20 and the out-of-plane polariser 750.

The polarisation switch 600 is arranged between the out-of-plane polariser 750 and the in-plane polariser 610, and the polarisation switch 600 is also arranged between the structured birefringent component 720 and the in-plane polariser 610, and wherein the display device 100 is arranged to output an image 338 formed using light which has been output from the at least one light source and which has passed through the structured birefringent component 720, the out-of-plane polariser 750, the polarisation switch 600 and the in-plane polariser 610.

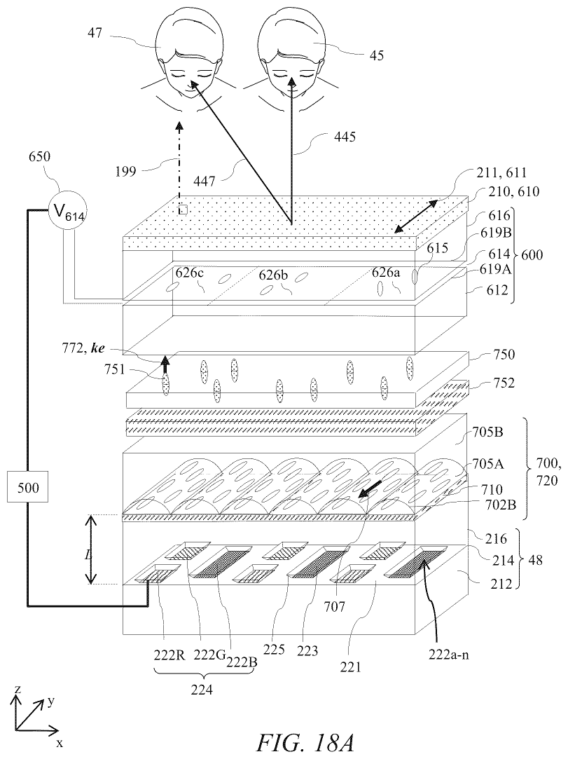

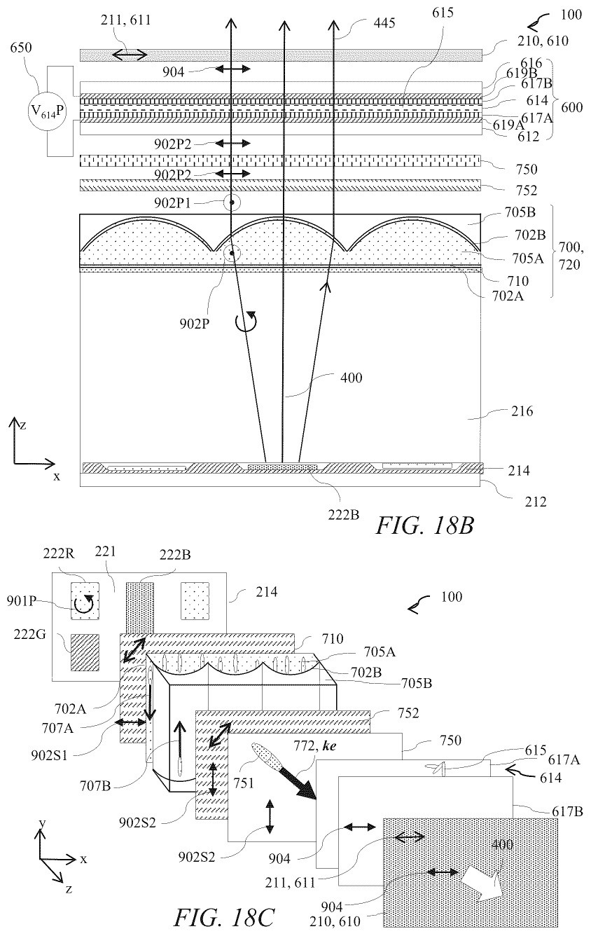

FIG. 1B illustrates that backlight 20 provides unpolarised or partially polariser light such that orthogonal polarisation states 902P, 902S are provided in the horizontal (lateral) and vertical (elevation) directions. Such polarisation states 902P, 902S could alternatively be provided by a reflective polariser (not shown) between the backlight 20 and the structured birefringent component 720, with linear output polarisation state at 45 degrees. In the embodiment of FIG. 1B, the polarisation state 902P, 902S are linear polarisation states, whereas in the alternative embodiment of FIGS. 18A-B, the orthogonal polarisation states 902S, 902P may be circular polarisation states and a further quarter waveplate may be provided.

The structured birefringent component 720 comprises a birefringent material 705A with a structured surface 702B and a further surface 702A that may be a planar surface for example. A further material 705B is arranged next to the structured surface 702B. The structured birefringent component 720 may further comprise support substrate 706 and the material 705B may be arranged between the structured surface 702B and the substrate 706. A further substrate (not shown) may be provided on the surface 702A.

In the present description the birefringent layer 704 comprises the region 703 through which the structured surface 702B extends. The birefringent layer 704 may further comprise the offsets 771, 773 of birefringent material 705A and material 705B respectively. Material 705B may be an isotropic material or may alternatively be a birefringent material with alignment orientations to achieve a switchable structured birefringent component 720.

The birefringent material 705A may have an alignment direction 707A with in-plane component 707Ap at the planar input surface 702A and an alignment direction 707B with in-plane component 707Bp at the profiled lens structured surface 702B. The alignment directions 707A. 707B may be provided by alignment layers 709A. 709B that are provided during manufacture of the birefringent lens 701 to provide alignment of the birefringent material 705A. An alignment layer 709B may be provided at the structured surface 702B between the isotropic material 705B and birefringent material 705A arranged during manufacture to provide alignment of the birefringent material 705A. Alternatively one or both alignment layers 709A. 709B may be removed in a manufacturing step of the birefringent lens and may not be present in the display device 100. The structured surface 702B has a profile and is extended in the y-direction. The alignment directions 707A. 707B may be parallel to the direction in which the structured surface 702B is extended.

The structured birefringent component 720 is non-switching, that is in operation the birefringent material 705A is not switched for example by the application of an electric field, and the birefringent material 705A may be a cured liquid crystal material such as a reactive mesogen material.

The out-of-plane polariser 750 is arranged between the structured birefringent component 720 and the in-plane polariser 610. The pixel layer 214 is arranged to output light towards the structured birefringent component 720. The structured birefringent component 720 is arranged to receive light output from the pixel layer 214 and to output light towards the out-of-plane polariser 750. The out-of-plane polariser 750 is arranged to receive light output from the structured birefringent component 720 and to output light towards the in-plane polariser 610, and the in-plane polariser 610 is arranged to receive light output from the out-of-plane polariser 750 and to output linearly polarised light.

The display device 100 further comprises a polarisation switch 600. The polarisation switch 600 is switchable between a first mode in which it is arranged to change the polarisation state of the light passing therethrough; and a second mode in which the polarisation switch 600 is arranged to affect the polarisation state of the light passing therethrough differently from the first mode and may be arranged to not change the polarisation state of the light passing therethrough.

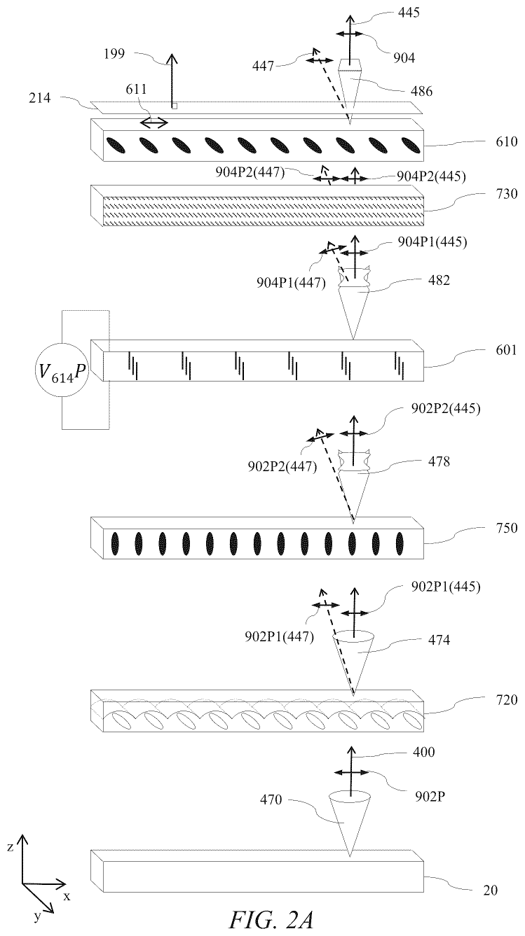

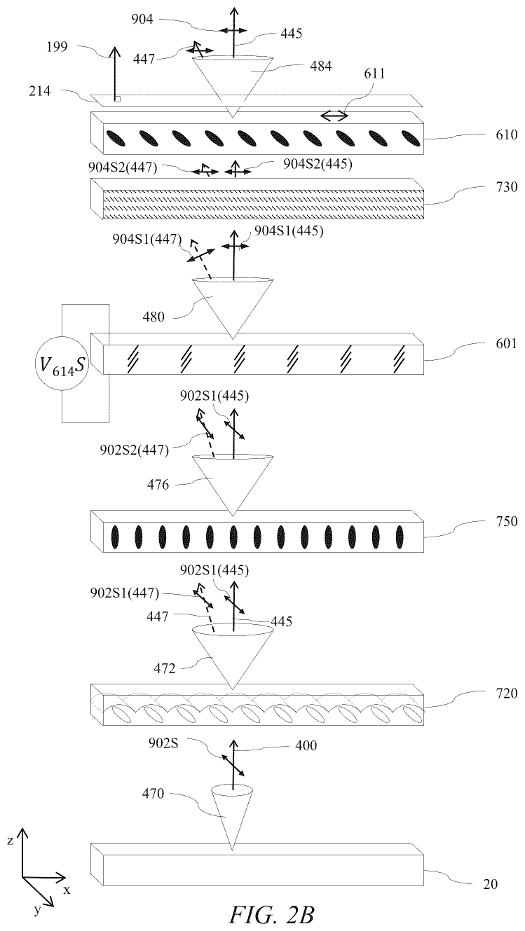

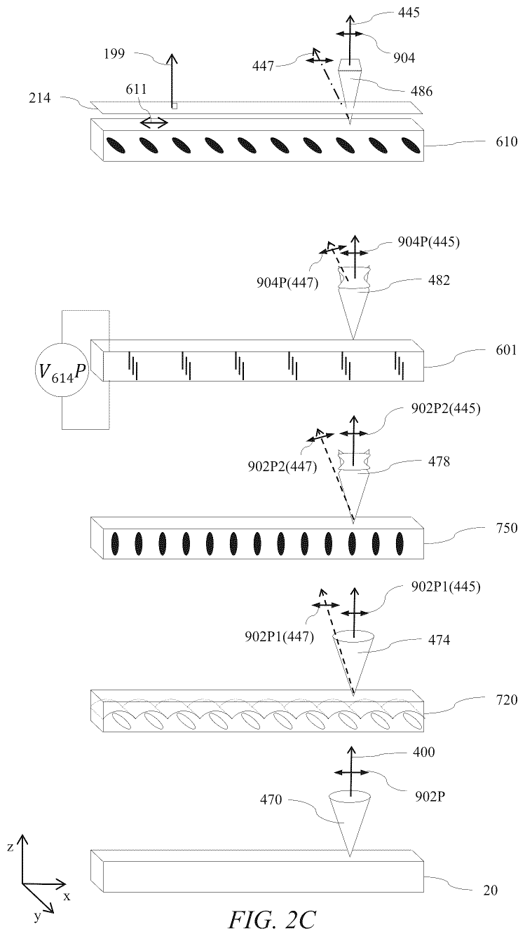

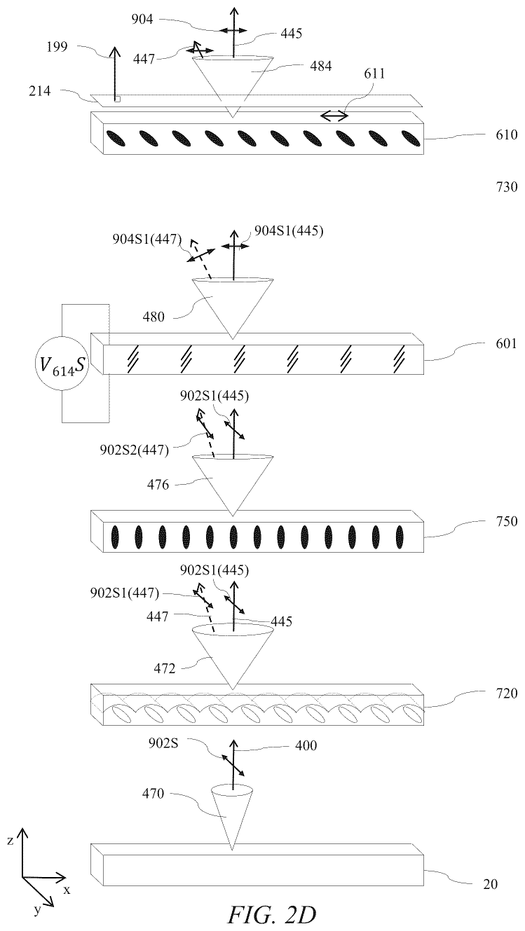

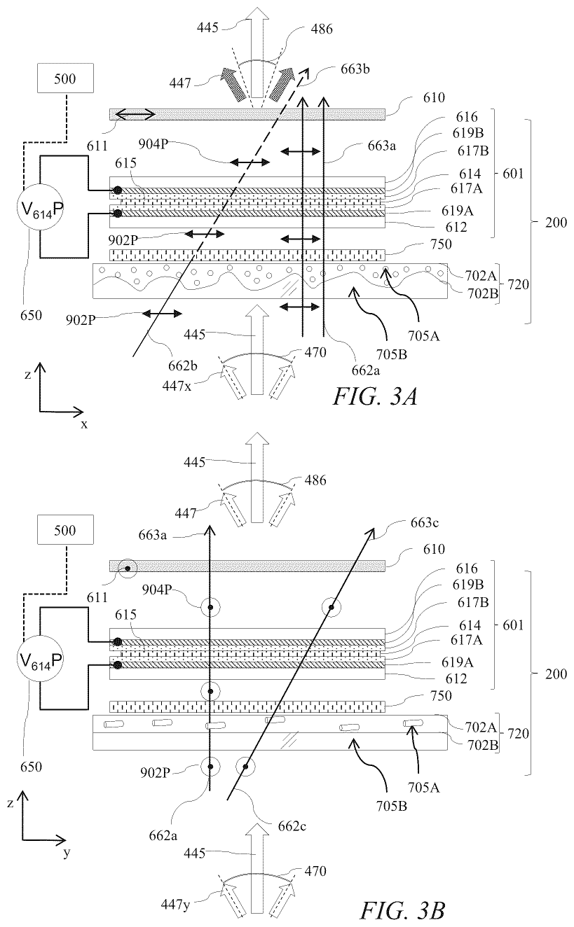

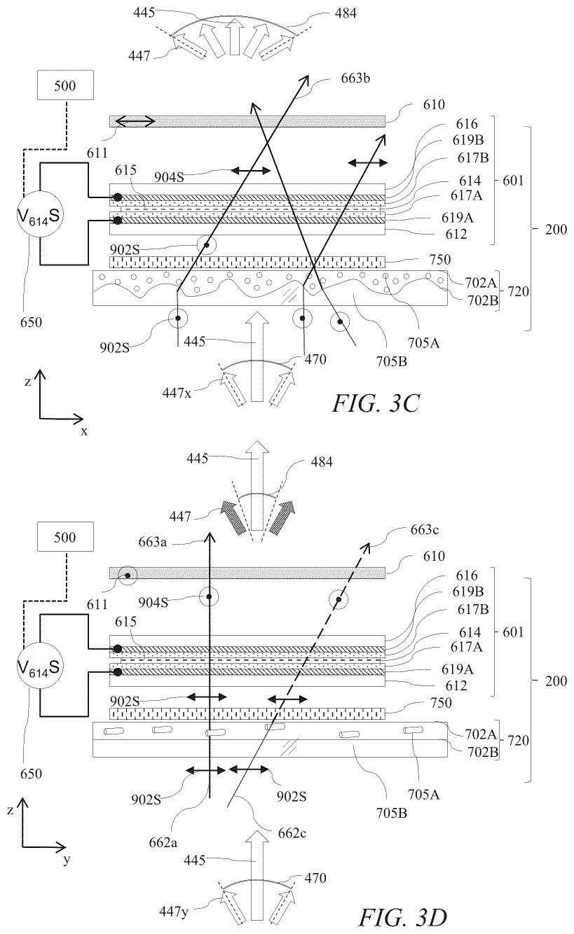

In the embodiments as will be described hereinbelow, such as in FIG. 2B, FIG. 2D and FIGS. 3C-D hereinbelow, the first mode is typically the wide-angle mode of operation and the second mode is the narrow-angle mode or privacy mode of operation such as in FIG. 2A, FIG. 2C and FIGS. 3A-B.

Most typically, the angular variation of the output polarisation state 904 of the polarisation switch 600 in the second mode is more uniform than in the first mode, and lower transmission may be achieved in non-viewing directions 447. Improved security factor in non-viewing directions 447 may be advantageously achieved in the second mode.

In alternative embodiments, it may be convenient to provide privacy operation in the second mode, for example to provide an output polarisation state 904 for improved visibility of the display device 100 when the user 45 is wearing polarised sunglasses.

In a privacy display device 100, the narrow angle mode is the privacy mode wherein snooper 47 in direction 447 receives an image 338 with high image security and the wide-angle mode is the share mode wherein users 45, 47 in directions 445, 447 each receive an image 338 with high image visibility.

In a low stray light display device 100, the such as used to reduce cabin stray light in a night-time operation of the display device 100 in an automotive vehicle, the second mode may be the low stray-light mode and the first mode may be the wide-angle mode, for example for day-time operation.

An illustrative embodiment for the arrangement of structured birefringent component 720 of FIGS. 1A-B is shown in TABLE 1.

TABLE 1

| Item | Property | Value |
|---|---|---|
| Birefringent material | Ordinary refractive index | 1.50 |
| 705A | Extraordinary refractive index | 1.72 |
| | Alignment state 707A direction | 90° |
| | Alignment state 707B direction | 270° |
| Material 705B | Refractive index | 1.50 |

The polarisation switch 600 layer comprises a switchable layer 614 liquid crystal material 615. The polarisation switch 600 comprises two surface alignment layers 617A, 617B disposed adjacent to the layer 614 of liquid crystal material 615 on opposite sides thereof and each arranged to provide alignment at the adjacent liquid crystal material 615. The polarisation switch 600 layer further comprises transmissive electrodes 619A, 619B arranged to apply a voltage for controlling the switchable liquid crystal layer 614. The transmissive electrodes 619A, 619B are on opposite sides of the switchable liquid crystal layer 614.

The polarisation switch 600 may further incorporate layers (not shown) that provide a touch function, such as capacitive touch that may be arranged between the electrode 619B and the output surface of the display device. Alternatively at least one of the electrodes 619A, 619B may be provided as part of the touch sensing structure.

The display device 100 further comprises a control system 500 arranged to control a voltage V₆₁₄ applied across the transmissive electrodes 619A, 619B. The liquid crystal polarisation switch layer 614 is arranged between (i) transparent substrate 612, electrode 619A and alignment layer 617A; and (ii) transparent substrate 616, electrode 619B and alignment layer 617B that are arranged on opposite sides of the liquid crystal polarisation switch layer 614. The substrate 706 may alternatively be the substrate 612 of the polarisation switch 600.

As illustrated in FIG. 1A, the transmissive electrodes 619A, 619B are patterned to provide at least two pattern regions 626a-c. The polar variation of luminance output (as described hereinbelow) may be different in the regions 626a-c to provide display properties that are different in the respective regions 626a-c. Advantageously some regions 626b-c may provide privacy output while other regions 626a may provide share mode output. In alternative embodiments the electrodes 619A, 619B may be uniform and a common optical output is provided across the display device 100. Advantageously cost and complexity may be reduced.

The display device 100 further comprises a control system 500 arranged to control the voltage V₆₁₄ applied across the transmissive electrodes 619A, 619B of the polarisation switch 600 layer. Driver 650 is arranged to drive the signal V₆₁₄ applied across the liquid crystal polarisation switch layer 614, and is controlled by controller 500. The transparent substrate 612 may be the same as the support substrate 706, advantageously achieving reduced thickness.

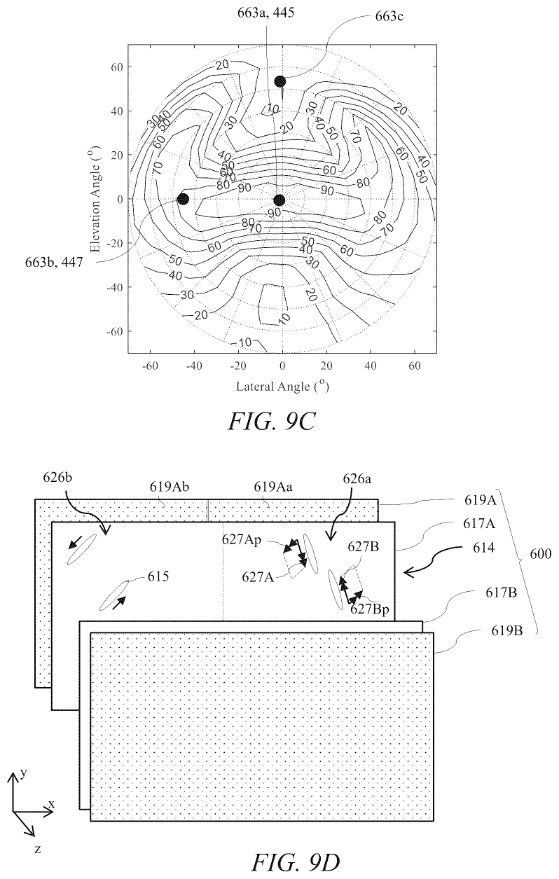

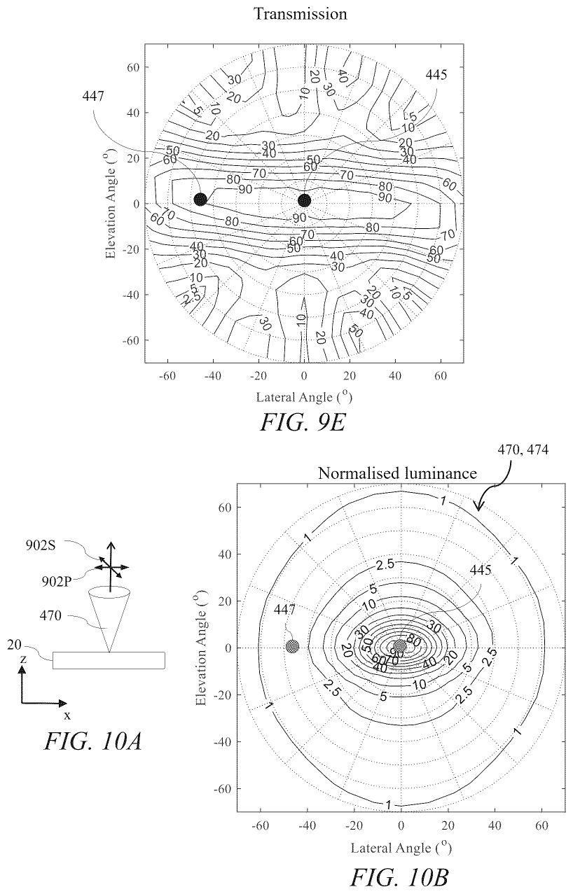

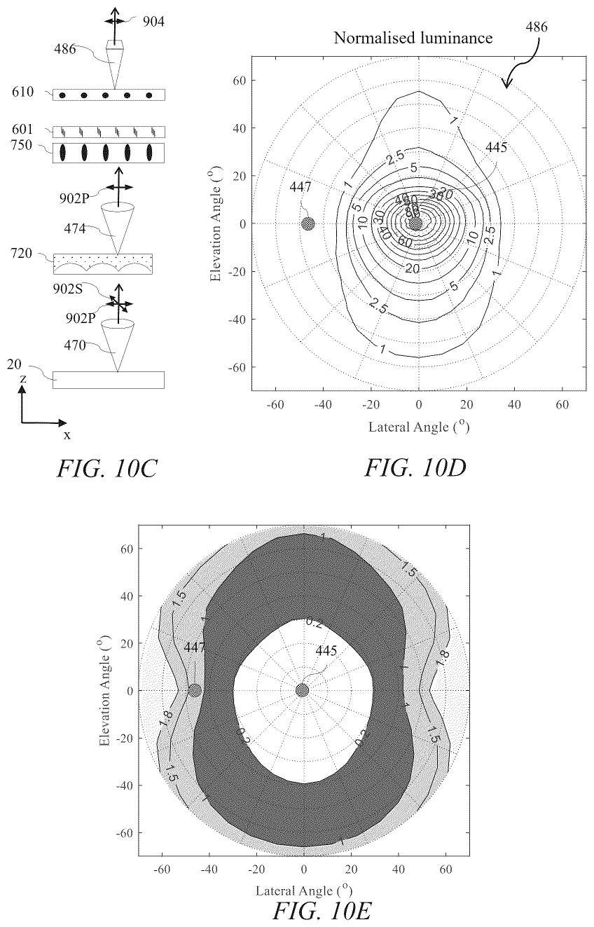

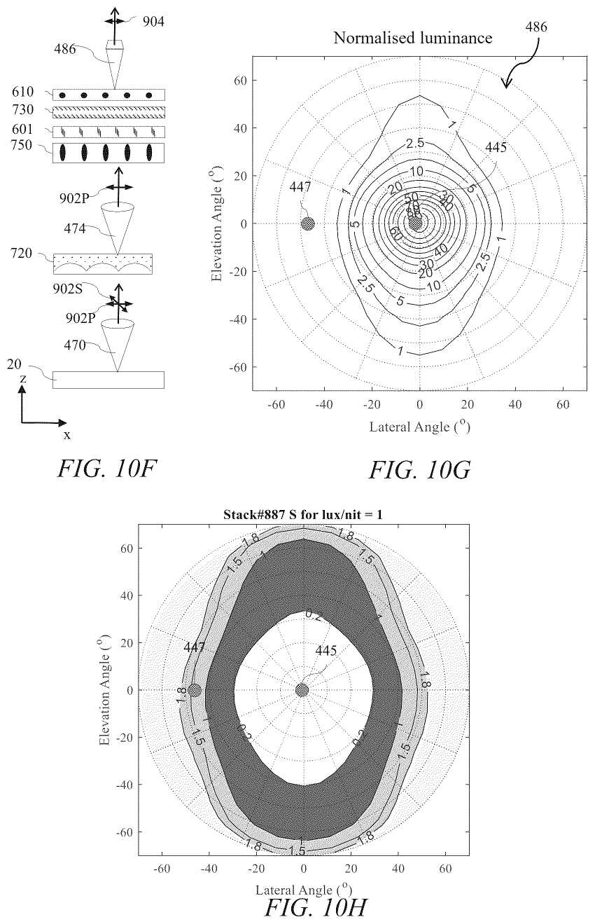

The display device 100 further comprises a biaxial retarder arrangement 730 arranged between the at least one light source and the in-plane polariser 610, wherein the light used to form the image 338 output by the display device 100 also passes through the biaxial retarder arrangement 730. The biaxial retarder arrangement 730 is arranged to receive light output from the structured birefringent component 720 and the out-of-plane polariser 750. As will be described further hereinbelow with respect to FIGS. 9D-E and FIG. 10H, the biaxial retarder arrangement may provide increased security factor in certain viewing regions.

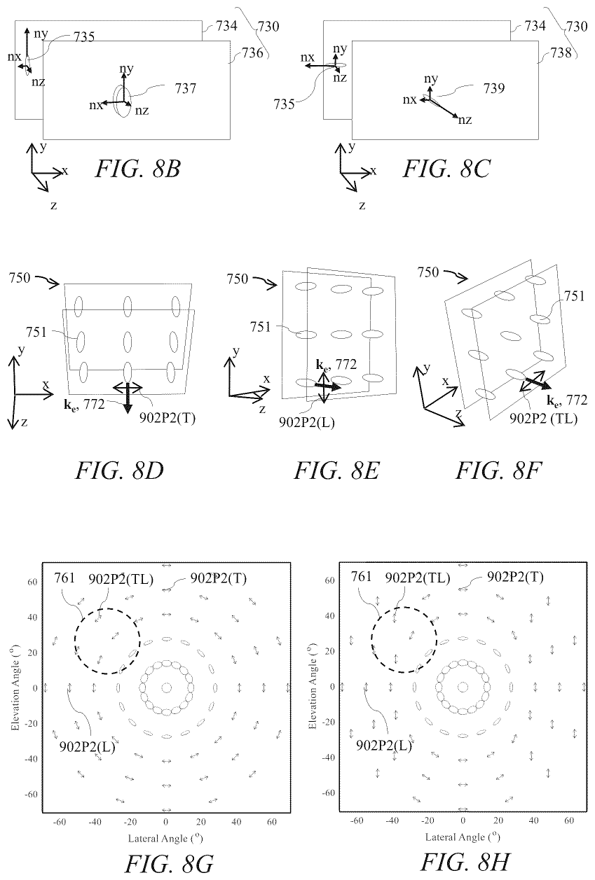

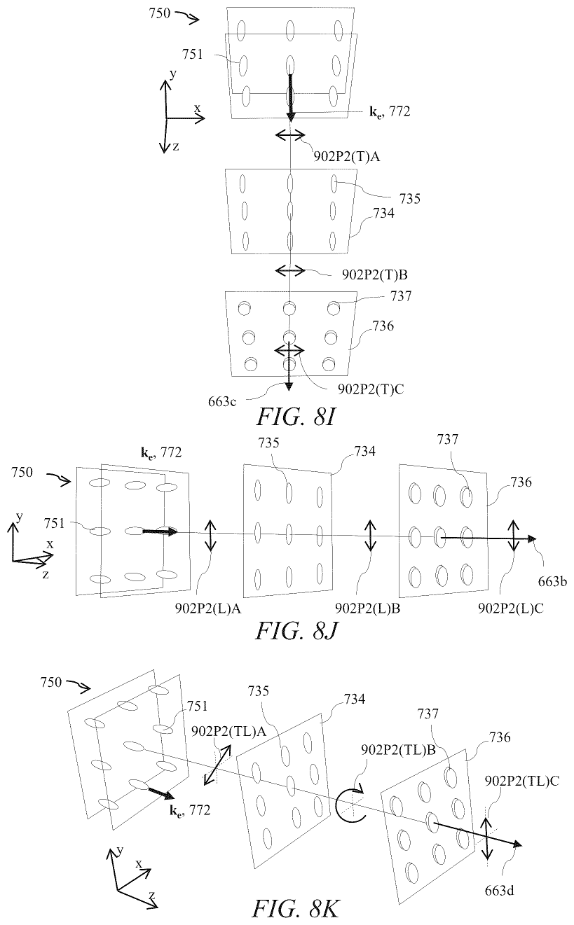

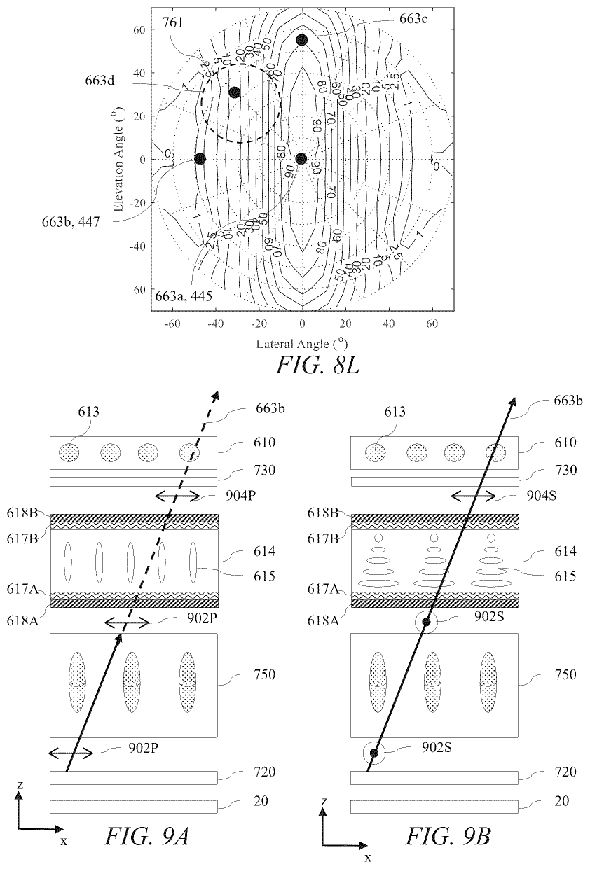

The biaxial retarder arrangement 730 of FIG. 1B comprises a B-plate 732 comprising biaxial molecules 731. A low thickness layer may be achieved and as will be described hereinbelow with respect to FIGS. 8A-L.

The propagation of light cones from the backlight 20 to the in-plane polariser 610 in the privacy mode and share mode will now be described with reference to FIGS. 2A-B.

FIG. 2A is a schematic diagram illustrating in perspective side view, operation of optical layers in the optical stack of the display device 100 of FIG. 1A for orthogonal polarisation states 902P, 902S wherein the polarisation switch 600 is arranged to provide narrow-angle state of operation; and FIG. 2B is a schematic diagram illustrating in perspective side view, operation of optical layers in the optical stack of the display device 100 of FIG. 1A for orthogonal polarisation states 902P, 902S wherein the polarisation switch 600 is arranged to provide wide-angle state of operation. Features of the embodiments of FIGS. 2A-B not discussed in further detail may be assumed to correspond to the features with equivalent reference numerals as discussed above, including any potential variations in the features.

Backlight 470 outputs a light cone 470. The cone may for example represent the angular extent of light for the half maximum luminance, the 10% luminance or the 1% luminance, that is for light rays within the cone the luminance is greater than a desirable value and outside the cone is less than the desirable value. As will be described in the illustrative embodiments hereinbelow, the angular luminance profiles are not geometric cones, rather have non-uniform profiles and the term cone is used herein for descriptive purposes.

Considering the privacy mode of operation of FIG. 2A, light rays 400 with polarisation state 902P are incident onto the structured birefringent component 720 which has substantially no optical effect, providing an output cone 474 which has substantially the same extent as the cone 470.

The out-of-plane polariser 750 is arranged to absorb a component 902P2 (447) of the light cone 474 which it receives in a direction 447 out of a plane defined by a pixel layer 214 of the display device 100. Typically the direction 447 is inclined at an acute angle to the normal direction 199.

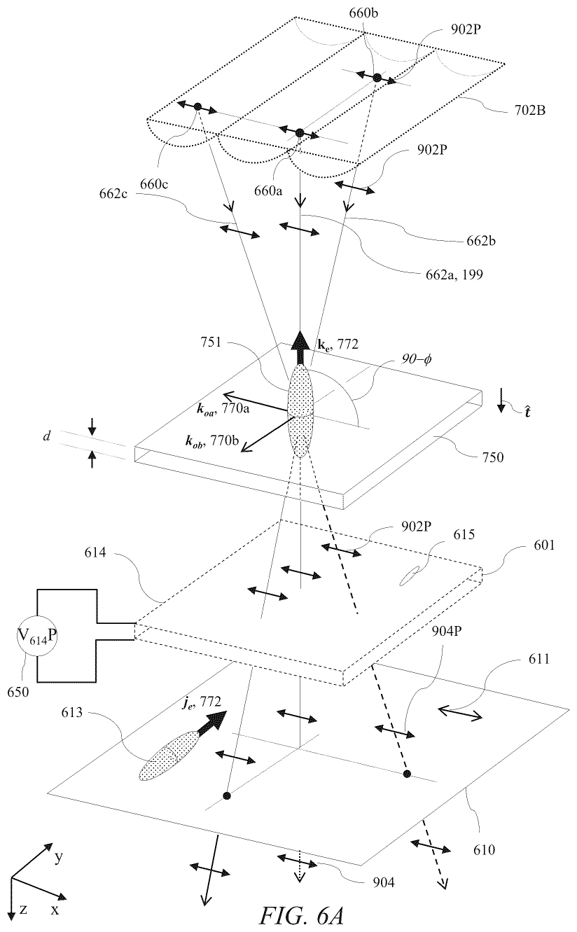

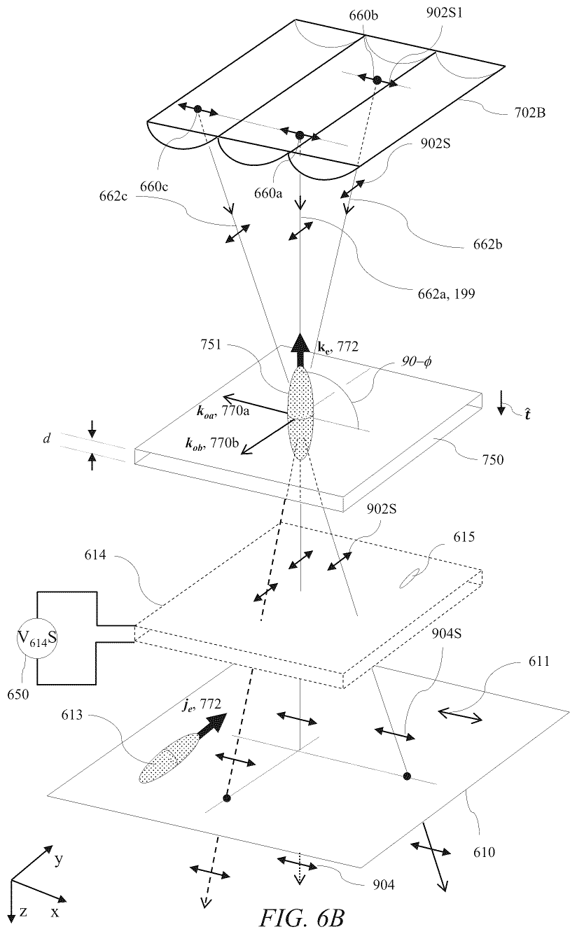

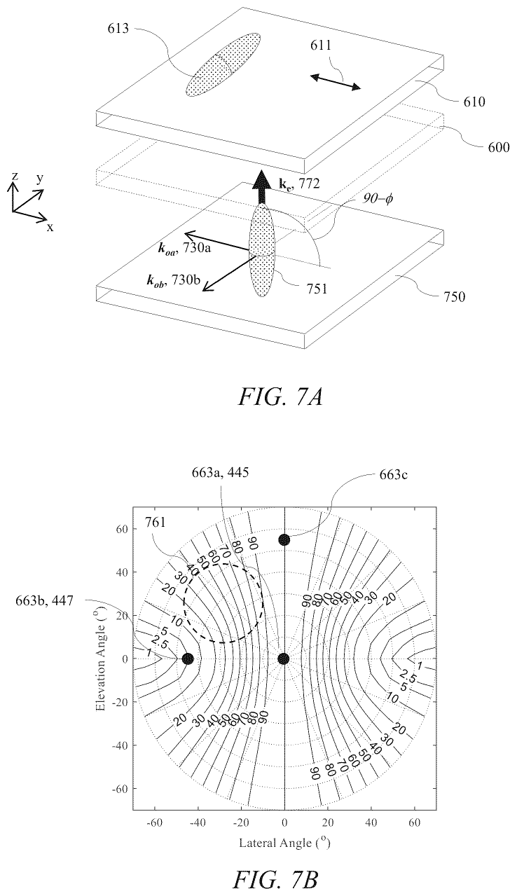

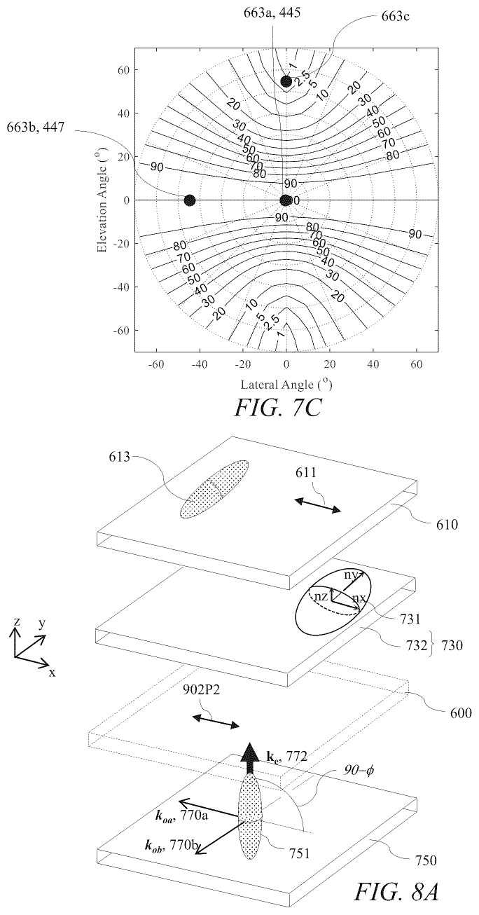

After propagation through the out-of-plane polariser 750, a cone 478 is provided that has a reduced extent in at least one direction as will be described further hereinbelow, for example with respect to FIGS. 6A-B and FIGS. 7A-B. The polarisation state 902P1 (445) in the direction 445 and polarisation state 902P1 (447) in the direction 447 are the same and may be substantially the same across the viewing directions 445, 447.

By comparison, the output polarisation state of the out-of-plane polariser 750 varies with angle such that in some off-axis directions 447, the polarisation state 902P2 (447) is different to the polarisation state 902P2 (445) in the direction 445, for example is a rotated linear polarisation state in the viewing quadrants (non-zero lateral angle and non-zero elevation).

Light cone 478 is transmitted through polarisation switch 600 and output as cone 482 which is substantially the same as cone 478, with output polarisation states 904P1 (445), 904P1 (447) that are substantially the same as input polarisation states 902P2 (445), 902P2 (447) in directions 445, 447 respectively.

In the embodiment of FIG. 2A in which the biaxial retarder arrangement 730 is present, the polarisation state 904P1 (445) may be substantially unmodified by the biaxial retarder arrangement 730 for rays in direction 445 whereas the polarisation state 904P1 (447) may be modified for off-axis rays in direction 447 such that the output polarisation state 904P2 (445) is aligned to polarisation state 904P2 (447).

More specifically, a rigorous description of the propagation of polarisation states 902S, 902P and 904S, 904P is provided by considering the interaction by means of the biaxial retarder arrangement 730 in both privacy and share modes of operation; the description of FIGS. 2A-D are provided for clarity of explanation in the present description.

As will be described further hereinbelow with respect to FIGS. 8A-L, generally the biaxial retarder arrangement 730 provides polarisation state rotation in the viewing quadrants, such as region 761 of FIG. 7B that is improved by the biaxial retarder arrangement 730 for FIG. 8L. The biaxial retarder arrangement 730 modifies the said rotated polarisation states such that the off-axis light from is returned to an unrotated state in the quadrants. The final output polarisation state is a combination of the light cones 480, 482 arising from said polarisation rotation by the structured birefringent component 720. A rigorous analysis of output as illustrated for example in FIG. 8L is provided by the summation of amplitude and phase for light in the cones 480, 482.

Light rays are incident onto the in-plane polariser 610 such that the cone 486 is output through the in-plane polariser 610 with uniform transmission for directions 445, 447.

FIG. 2A illustrates that output light cone 486 may be provided for the voltage V₆₁₄P provided on the polarisation switch 600 such that the luminance in directions 447 towards a snooper 47 is substantially reduced compared to the luminance in directions 445 towards the user 45. Advantageously security factor is increased.

The light output in cone 484 by the in-plane polariser 610 in the share mode of FIGS. 2C-D has a different light output transmission profile to the light in cone 486 output by the in-plane polariser 610 in the second mode.

Considering the share mode of operation of FIG. 2B, light rays 400 from the backlight 20 with polarisation state 902S are incident onto the structured birefringent component 720 which provides an output cone 472 with increased extent compared to the cone 470. After propagation through the out-of-plane polariser 750, a cone 476 is provided for the polarisation states 902S1 (445), 902S1 (447) that has a similar extent in at least one direction as will be described further hereinbelow, for example with respect to FIGS. 8A-L.

Considering FIGS. 2A-B, the structured birefringent component 720 is thus arranged to output at least some light in cone 474 having a first polarisation state 902P1 and at least some light having a different second polarisation state 902S1.

Light cone 476 is transmitted through polarisation switch 600 and output as cone 480 which is substantially the same as cone 476, with output polarisation state 904S1 (445), 904S1 (447) with light rays 445, 447 having slightly different linear polarisation states. Polarisation states 904S2 (445), 902S2 (447) are output from the biaxial retarder arrangement 730 and transmitted through the in-plane polariser 610 as output light in the share mode with cone 484.

It is desirable to achieve the highest security factor in privacy mode and lowest stray light in stray light mode. In the privacy mode of FIG. 2B, the polarisation switch 600 is arranged to change the polarisation state of the light passing therethrough from a first linear polarisation state 902 to a second linear polarisation state 904 that is orthogonal to the first linear polarisation state 902. In the second mode of FIG. 2A, the polarisation switch 600 is arranged not to change the polarisation state 902 of the light passing therethrough so that the output polarisation state 904 from the polarisation switch 600 is the same as the input polarisation state 902 from the polarisation switch 600.

Typically known polarisation switches 600 may achieve the lowest off-axis direction 447 luminance when the polarisation state 902P is not affected by the polarisation switch 600, that is in the second mode. In alternative embodiments, the first mode may be the narrow-angle mode and the second mode may be the wide-angle mode. Such embodiments may advantageously achieve improved image visibility in wide-angle mode.

FIG. 2C is a schematic diagram illustrating in perspective side view, operation of optical layers in the optical stack of FIG. 1A for orthogonal polarisation states 902P, 902S wherein the polarisation switch 600 is arranged to provide narrow-angle state of operation and the biaxial retarder arrangement 730 is omitted; and FIG. 2D is a schematic diagram illustrating in perspective side view, operation of optical layers in the optical stack of FIG. 1A for orthogonal polarisation states wherein the polarisation switch 600 is arranged to provide wide-angle state of operation and the biaxial retarder is omitted. Features of the embodiment of FIGS. 2C-D not discussed in further detail may be assumed to correspond to the features with equivalent reference numerals as discussed above, including any potential variations in the features.

In the alternative embodiments of FIGS. 2C-D in which the biaxial retarder arrangement 730 is not present, the polarisation state 904P1 (447) is not correctly aligned for full transmission through the in-plane polariser 610. Instead, some light of the share mode with polarisation state 904S1 (447) is transmitted through the in-plane polariser 610. As illustrated in FIG. 7B hereinbelow, in the region 761 undesirably luminance is increased, whereas the biaxial retarder advantageously achieves reduced luminance in the region 761 as illustrated in FIG. 8L hereinbelow.

Most generally the polarisation switch layer 614 is switchable between a first mode in which it is arranged to change a polarisation state 902 of the light passing therethrough and a second mode in which it is arranged to affect the polarisation state 902 of the light passing therethrough differently from the first mode. In a first mode which is the share mode in FIG. 2B and FIG. 2D, the polarisation switch 600 is arranged to change the polarisation state of the light passing therethrough from a first linear polarisation state 902 to a second linear polarisation state 904 that is orthogonal to the first linear polarisation state 902. In a second mode, which is the privacy mode in FIG. 2A and FIG. 2C the polarisation switch layer 614 is arranged not to change the polarisation state 902 of the light passing therethrough such that the output polarisation state 904 is substantially the same as the input polarisation state 902. Thus in the privacy mode of operation the output polarisation state 904 from the polarisation switch 600 is provided to be substantially the same as the polarisation state 902P, that is no modification of the polarisation state 902P is provided.

The operation of the structured birefringent component 720 and polarisation switch 600 in privacy mode will now be further described.

FIG. 3A is a schematic diagram illustrating in top view, operation of optical layers in the optical stack of the display device 100 of FIG. 1A wherein the polarisation switch 600 is arranged to provide narrow-angle state of operation; and FIG. 3B is a schematic diagram illustrating in side view, operation of optical layers in the optical stack of the display device 100 of FIG. 1A wherein the polarisation switch 600 is arranged to provide narrow-angle state of operation. Features of the embodiment of FIGS. 3A-B not discussed in further detail may be assumed to correspond to the features with equivalent reference numerals as discussed above, including any potential variations in the features.

Light cone 470 comprises on axis light rays along direction 445 and off-axis light rays along directions 447x, 447y. Illustrative light rays comprising on-axis light ray 662a, and off-axis light rays 662b, 662c are also provided.

The polarisation state 902P is incident onto the structured birefringent component 720 with birefringent material 705A liquid crystal molecule alignment directions 707A. 707B arranged to provide the ordinary refractive index to the light rays 445 with polarisation state 902P propagating within the structured birefringent component 720. Such light rays 445 are incident onto the structured surface 702B that has no index step to the refractive index of the isotropic material 705B, and provides substantially no optical power to the light rays 662a, 662b, 662c. The structured birefringent component 720 thus provides no optical effect for the incident light cone 470.

By comparison the out-of-plane polariser 750 provides reduction of off-axis luminance for at least rays 663b as described elsewhere herein.

The operation of the structured birefringent component 720 and polarisation switch 600 in share mode will now be further described.

FIG. 3C is a schematic diagram illustrating in top view, operation of optical layers in the optical stack of the display device 100 of FIG. 1A wherein the polarisation switch 600 is arranged to provide wide-angle state of operation; and FIG. 3D is a schematic diagram illustrating in side view, operation of optical layers in the optical stack of the display device 100 of FIG. 1A wherein the polarisation switch 600 is arranged to provide wide-angle state of operation. Features of the embodiment of FIG. 3C-D not discussed in further detail may be assumed to correspond to the features with equivalent reference numerals as discussed above, including any potential variations in the features.

By way of comparison with FIGS. 3A-B the alternative embodiments of FIG. 3C-D illustrate share mode operation. The polarisation state 902S is incident onto the structured birefringent component 720 with birefringent material 705A liquid crystal molecule alignment directions 707A, 707B arranged to experience the extraordinary refractive index of the birefringent material 705A for the light rays 663a with polarisation state 902S propagating within the structured birefringent component 720. Such light rays 445 are incident onto the structured surface 702B with an index step to the refractive index of the isotropic material 705B, and provides optical power to the light rays incident across the aperture 708 of the lens 701. The deflected rays 663b provide scatter of rays into the output cone 484. The refractive index step between materials 705A, 705B for the polarisation state 902P remains the same for different output directions 447x. In the case of a one-dimensional profile of the structured surface 702B as illustrated in FIG. 1A, no deflection is provided for light rays 663c. Advantageously luminance reduction of light rays 663a in direction 445 arising from light redistribution in the elevation direction may be reduced. The out-of-plane polariser 750 provides reduction of light rays 663c in the elevation direction.

A narrow angle operational display mode will now be described.

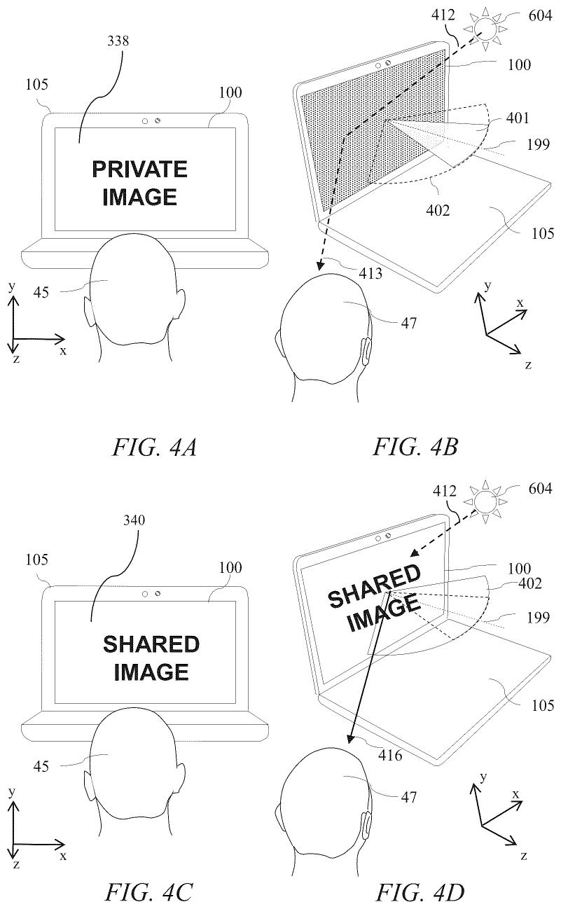

FIG. 4A is a schematic diagram illustrating a perspective front view of a laptop computer 105 illuminated by an ambient light source 604 comprising a switchable privacy display device 100 operating in privacy mode; and FIG. 4B is a schematic diagram illustrating a look-down off-axis perspective view of a laptop computer 105 illuminated by an ambient light source 604 comprising a switchable privacy display device 100 operating in privacy mode. Features of the embodiment of FIGS. 4A-B not discussed in further detail may be assumed to correspond to the features with equivalent reference numerals as discussed above, including any potential variations in the features.

FIGS. 4A-B illustrate a narrow-angle operational display mode that may be termed a “Uniform Privacy Mode”, in which the control system 500 controls the SLM 48 to display an operational image 338. The observer 45 thus sees the operational image 338.

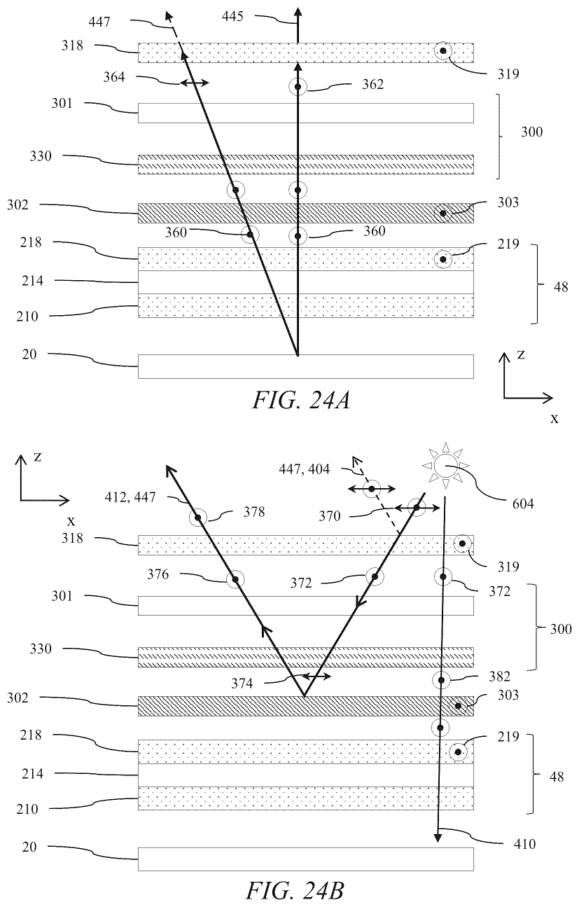

Considering incident ambient light rays 412 that may be seen by the head-on display observer 45, the operation is the same as that described with respect to FIG. 24A hereinbelow and the display device 100 has substantially low reflectivity across the display device 100.

FIG. 4B illustrates the appearance of the display to an off-axis display off-axis observer 47 when the operational image 338 is output from the SLM 48. Observer 45 that is a user has high image visibility and off-axis observer 47 that is an unwanted snooper is provided with a high security factor so that the image 338 is difficult to discern or is invisible. A privacy display operation mode is advantageously achieved.

A wide-angle operational display mode will now be described.

FIG. 4C is a schematic diagram illustrating a perspective front view of a laptop computer 105 illuminated by an ambient light source 604 comprising a switchable privacy display device 100 operating in share mode; and FIG. 4D is a schematic diagram illustrating a look-down off-axis perspective view of a laptop computer 105 illuminated by an ambient light source 604 comprising a switchable privacy display device 100 operating in share mode. Features of the embodiment of FIGS. 4C-D not discussed in further detail may be assumed to correspond to the features with equivalent reference numerals as discussed above, including any potential variations in the features.

FIGS. 4C-D illustrate a wide-angle operational display mode that may be termed a “Uniform Share Mode”, in which the control system 500 controls the SLM 48 to display an operational image 338.

In the embodiments of FIGS. 4C-D the control system 500 controls the SLM 48 to display an operational image 340 such that the operational image 338 is visible at the narrow angle and at the wide-angle. The observers 45, 47 thus see the operational image 340.

Considering incident ambient light rays 412 that may be seen by the head-on display observer 45, the operation is the same as that described with respect to FIG. 4A and the display device 100 has substantially low reflectivity across the display device 100.

FIG. 4D illustrates the appearance of the display to an off-axis display off-axis observer 47 when the operational image 340 is output from the SLM 48.

The structure of various polarisers will now be further described.

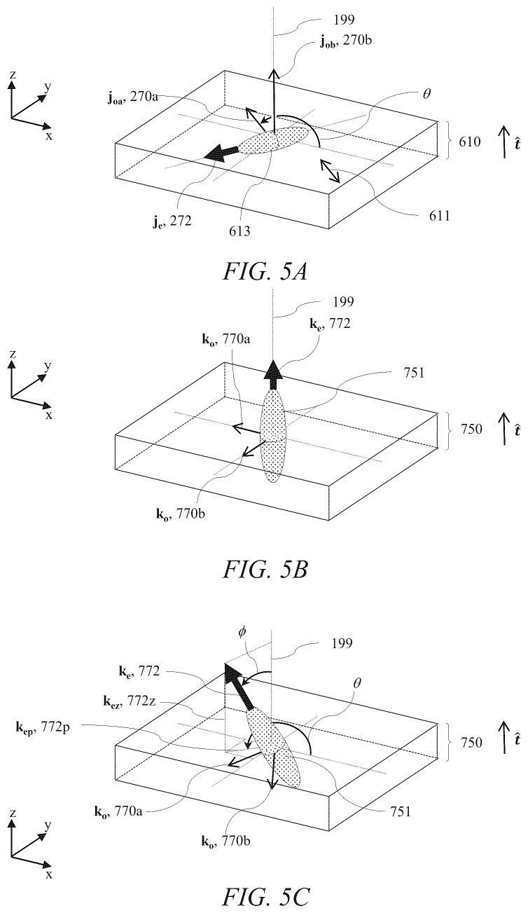

FIG. 5A is a schematic diagram illustrating in perspective side view an in-plane polariser that is the in-plane polariser 610; FIG. 5B is a schematic diagram illustrating in perspective side view an out-of-plane polariser 750 comprising an absorption axis ke, 772 with no in-plane component; and FIG. 5C is a schematic diagram illustrating in perspective side view an out-of-plane polariser 750 comprising an absorption axis ke, 772 with an in-plane component kep, 772p. Features of the embodiments of FIGS. 5A-C not discussed in further detail may be assumed to correspond to the features with equivalent reference numerals as discussed above, including any potential variations in the features.

FIG. 5A illustrates that an in-plane polariser 210 comprises a dichroic molecule 613 (such as iodine contained within a PVA layer) with an absorption axis 272 that has direction jₑ that is in the direction \hat{t} through the thickness of the layer of the in-plane polariser 210, that is the direction jₑ is in the plane in which the in-plane polariser 210 extends. For an incident wavefront with a linear polarisation state, the electric vector transmission direction for an incident polarisation state is the in-plane direction jₒₐ, 270a and is oriented at an angle θ to the easterly direction.

By way of comparison with FIG. 5A, the direction of the absorption axis 772 of an out-of-plane polariser 750 is normal to the plane of the out-of-plane polariser 750. The out-of-plane polariser 750 of FIG. 5B comprises molecules 751 that may be different material to the molecules 613 of the in-plane polariser 210 and have an orientation so that the absorption axis direction kₑ, 772 is normal to the plane of the out-of-plane polariser 750, that is parallel to the direction \hat{t} through the thickness of the layer of the out-of-plane polariser 750.

By way of comparison with FIG. 5B, in the out-of-plane polariser 750 of FIG. 5C, the direction of the absorption axis 772 of the out-of-plane polariser 750 is inclined at an acute angle ϕ to the normal 199 orthogonal to the plane of the out-of-plane polariser 750. The molecules 751 have an orientation so that the absorption axis 772 has a component 772z that is in a direction k_{ez} inclined to the normal 199 to plane of the out-of-plane polariser 750; and a component 772p that is in a direction kₑₚ in the plane of the out-of-plane polariser 750 and with the orientation θ.

The operation of out-of-plane polariser 750 and in-plane polariser 210 will now be further described.

FIG. 6A is a schematic diagram illustrating in perspective side view operation of an array of birefringent lenses 701, out-of-plane polariser 750, switchable layer 614 of liquid crystal material 615 and an in-plane in-plane polariser 610 for light rays 662a, 662b, 662c, inclined in lateral and elevation directions for the narrow-angle state of operation; FIG. 6B is a schematic diagram illustrating in perspective side view operation of an array of birefringent lenses 701, out-of-plane polariser 750, switchable layer 614 of liquid crystal material 615 and an in-plane in-plane polariser 610 for light rays 662a, 662b, 662c, inclined in lateral and elevation directions for the wide-angle state of operation. Features of the embodiments of FIGS. 6A-B not discussed in further detail may be assumed to correspond to the features with equivalent reference numerals as discussed above, including any potential variations in the features.

The out-of-plane polariser 750 has an absorption axis in a direction having a component ke, 772 out of a plane defined by the pixel layer 214.

FIG. 6A illustrates light ray 662 propagation with polarisation state 902P from a structured birefringent component 720 through a molecule 751 of the out-of-plane polariser 750, polarisation switch layer 601 and in-plane polariser 610. The operation of the structured birefringent component 720 for the polarisation state 902P is described further hereinabove.

Light ray 662a from location 660a along the normal 199 propagates with output polarisation state 902P onto the molecule 751. The ray 662a is provided along the absorption axis kₑ direction 772 of the molecule 751, and parallel to the transmission axis kₒₐ, 770a, so that low absorption takes place and the light ray 662a is transmitted with high luminous flux through the out-of-plane polariser 750.

The linear polarisation state 902P is incident on the input of the polarisation switch 601. In the privacy mode, the polarisation switch 601 is arranged to not change the polarisation state 902P of the light passing therethrough. A first voltage V₆₁₄P is applied to the layer 614 of liquid crystal material 615 so that the linear output polarisation state 904P is not modified through the layer 614 to provide output polarisation state 904P that is the same as the polarisation state 902P.

In-plane polariser 210 comprises molecules 613 with absorption axis je, 622 such that the polariser 210 has electric vector transmission direction 219 arranged to transmit linear polarisation state 904P. Light ray 662a with high luminous flux is transmitted by the in-plane polariser 210 with electric vector transmission direction 219.

Light ray 662b from location 660b is incident on the molecule 751 with polarisation state 902P aligned orthogonally to the absorption axis kₑ direction 772 so that substantially no absorption takes place by the molecules 751 of the out-of-plane polariser 750 and the light ray 662b is transmitted by the layer 614 of liquid crystal material 615, polarisation switch 601 and in-plane polariser 210 with high luminous flux.

By comparison with light rays 662a, 662b, for light ray 662c from location 660c the polarisation state 902P has a component along the ray 662c that is aligned with the absorption axis kₑ direction 772 of the molecule 751. Such alignment provides some absorption at the molecule 751 so that the output ray 662c from the out-of-plane polariser 750 has reduced luminous flux. The amount of absorption is determined by the thickness, d, refractive indices ne, no and absorption coefficients αₑ(ϕ,θ) αₒ(ϕ,θ) of the out-of-plane polariser 750 for polar angle (ϕ, θ), at the angle of incidence of the ray 662c for the polarisation state 904P.

Thus, the light rays 662a, 662b have a transmission that is greater than the transmission of the light ray 662c.

By way of comparison with FIG. 6A, in the share mode as illustrated in FIG. 6B, the polarisation switch 601 is arranged to change the polarisation state 902S of the light passing therethrough to polarisation state 904S.

FIG. 6B illustrates light ray 662a propagation with polarisation state 640 through the structured birefringent component 720a-n.

As in the privacy mode, light ray 662a from location 660a along the normal 199 propagates along the absorption axis kₑ direction 772 of the molecule 751, and parallel to the transmission axis kₒₐ, 770a, so that low absorption takes place and the light ray 662a is transmitted with high luminous flux through the out-of-plane polariser 750.

In the share mode, the polarisation switch 601 is arranged to modify the polarisation state 902S to polarisation state 904S. A second voltage V₆₁₄S is applied to the layer 614 of liquid crystal material 615 so that the linear polarisation state 902S is modified through the layer 614. Light ray 662a is transmitted by the in-plane polariser 210 with high transmission and with the optical properties of the lens array 701a-n in the share mode of operation.

By comparison with FIG. 6A, light ray 662b from location 660b is incident on the molecule 751 with polarisation state 902S with a component aligned to the absorption axis kₑ direction 770b so that some absorption takes place by the molecules 751 of the out-of-plane polariser 750. The light ray 662b is transmitted by the layer 614 of liquid crystal material 615, polarisation switch 210 and in-plane polariser 210 with high luminous flux.

For the light ray 662c from location 660c the polarisation state 902S2 has no component along the ray 662c that is aligned with the absorption axis kₑ direction 772 of the molecule 751 so that the output ray 663c from the out-of-plane polariser 750 has higher transmission than for the ray 662b.

Illustrative examples of transmission of out-of-plane and in-plane polarisers arranged in series will now be provided.

FIG. 7A is a schematic diagram illustrating in perspective side view a polarisation switch 600 arranged between an in-plane polariser that is in-plane polariser 610 and an out-of-plane polariser 750; and FIG. 7B is a schematic graph illustrating a polar variation of transmission for the arrangement of FIG. 7A and TABLE 2 for operation in the privacy mode; and FIG. 7C is a schematic graph illustrating a polar variation of transmission for the arrangement of FIG. 7A for operation in the share mode. Features of the embodiment of FIGS. 7A-B not discussed in further detail may be assumed to correspond to the features with equivalent reference numerals as discussed above, including any potential variations in the features.

In the current description, the lateral angle with zero elevation is the angle in a plane that is typically defined as the plane comprising the x-axis and z-axis of the respective figures and is most typically the angle across the horizontal with respect to the frame of reference of the observer 45. Similarly the elevation angle with zero lateral angle is the angle in a plane that is typically defined as the plane comprising the y-axis and z-axis of the respective figures and is most typically the angle across the vertical with respect to the frame of reference of the observer 45. Angles with both non-zero elevation and non-zero lateral angle may be referred to as being in the viewing quadrants in the frame of reference of the observer 45.

TABLE 2 provides an illustrative embodiment of FIG. 7A with no biaxial retarder arrangement 730 and FIGS. 7B-C illustrates the variation of transmission with viewing angle in first and second modes of operation for an idealised polarisation switch 601 that provides 0 and 90 degree rotation of polarisation state 902P to polarisation state 904.

TABLE 2

| Item | Property | Value |
|---|---|---|
| Out-of-plane | Material 751 ordinary refractive | 1.506 + |
| polariser 750 | index, \vec{nₒ} | 0.00165i |
| | Material 751 extraordinary refractive | 1.53 + |
| | index, \vec{nₑ} | 0.116i |
| | Thickness, d | 5 μm |
| | Absorption axis 622 tilt φ to surface | 0° |
| | normal 199 | |
| Polarisation switch | Polarisation rotation | 90° |
| 601 share mode | | |
| Polarisation switch | Polarisation rotation | 0° |
| 601 privacy mode | | |
| Biaxial retarder | — | — |
| arrangement 730 | | |
| In-plane polariser 610 | Electric vector transmission | 0° |
| | direction 611 | |

Considering FIG. 7B, while low transmission may be achieved along the zero-elevation direction, in the quadrant region 761, increased transmission is undesirably provided. FIG. 7C illustrates that in the share mode, reduced luminance may be provided in the elevation directions. Intermediate polarisation states 904 may provide a mix of the profiles of FIGS. 7B-C to achieve improved rotational symmetry in share mode. Such intermediate polarisation states may be provided by control of the voltage applied across the electrodes 619A, 619B of the polarisation switch layer 601 to provide intermediate states of alignment of the layer 614 of liquid crystal material 615.

It may be desirable to reduce luminance in the quadrant regions 761 in privacy mode of operation.

FIG. 8A is a schematic diagram illustrating in perspective side view a polarisation switch 600 arranged between an in-plane polariser that is in-plane polariser 610, a biaxial retarder arrangement 730 comprising biaxial material 731 and an out-of-plane polariser 750. Features of the embodiment of FIG. 8A not discussed in further detail may be assumed to correspond to the features with equivalent reference numerals as discussed above, including any potential variations in the features.

By way of comparison with FIG. 7A, the biaxial retarder arrangement 730 of FIG. 8A comprises biaxial molecules 731 that provide off-axis retardation properties for input polarisation state 904P1 of FIGS. 2A-B or 902P2 of FIG. 18B hereinbelow.

Alternative embodiments of biaxial retarder arrangement 730 will now be described.

FIG. 8B is a schematic diagram illustrating in perspective front view, an alternative biaxial retarder arrangement 730 comprising an A-plate and a negative C-plate; and FIG. 8C is a schematic diagram illustrating in perspective front view, an alternative biaxial retarder arrangement comprising an A-plate and a positive C-plate. Features of the embodiments of FIGS. 8B-C not discussed in further detail may be assumed to correspond to the features with equivalent reference numerals as discussed above, including any potential variations in the features.

By way of comparison with FIG. 8A, in the alternative embodiment of FIG. 8B, the biaxial retarder arrangement 730 comprises a negative C-plate 736 comprising birefringent material 737 arranged to receive the light from an A-plate 734 comprising birefringent material 735 with optical axis direction aligned to the vertical direction or y-axis; that is the extraordinary index ne is the same as the index ny. Negative C-plates may be more conveniently manufactured at low cost than positive C-plates.

By way of comparison with FIG. 8B, in the alternative embodiment of FIG. 8C, the biaxial retarder arrangement 730 comprises a positive C-plate 738 comprising birefringent material 739 arranged to receive the light from an A-plate 734 comprising birefringent material 735 with optical axis direction aligned to the horizontal direction or x-axis; that is the extraordinary index ne is the same as the index ny. Positive C-plate 738 may be provided by a coating manufacturing method, achieving reduced thickness.

The complexity of manufacture of the A-plate 735 and C-plates 736, 738 may be reduced compared to the B-plate 732 of FIG. 8A, advantageously achieving reduced cost.

The operation of the biaxial retarder arrangement 730 will now be described further.

FIG. 8D is a schematic diagram illustrating in perspective top view an out-of-plane polariser; FIG. 8E is a schematic diagram illustrating in perspective left side view an out-of-plane polariser; and FIG. 8F is a schematic diagram illustrating in perspective upper left quadrant view an out-of-plane polariser. Features of the embodiments of FIGS. 8D-E not discussed in further detail may be assumed to correspond to the features with equivalent reference numerals as discussed above, including any potential variations in the features.

In operation, the out-of-plane polariser 750 with absorption axis ke 772 provides absorption of the incident unpolarised transmitted polarisation state without output polarisation state 902P2 that varies with viewing direction 663, such as polarisation states 902P2(T) for the top look-down direction 663c, 902P2(L) for the left side viewing direction 663b and 902P2 (TL) for the left side top quadrant viewing direction 663d.

FIG. 8G is a schematic graph illustrating a polar variation of output polarisation state 902P2 from an out-of-plane polariser 750 without a biaxial retarder arrangement 730; and FIG. 8H is a schematic graph illustrating a polar variation of output polarisation state 902P2 from an out-of-plane polariser 750 arranged with a desirable biaxial retarder arrangement 730, for example as illustrated in FIG. 8A. Features of the embodiments of FIGS. 8G-H not discussed in further detail may be assumed to correspond to the features with equivalent reference numerals as discussed above, including any potential variations in the features.

FIG. 8G illustrates that in the region 761, the polarisation state 902P2 (TL) is rotated with respect to the polarisation state 902P2(L), providing the undesirable increased transmission of FIG. 7B.

It would be desirable to reduce the transmission in the region 761 by modifying the polarisation state 902P2 (TL) and substantially not modifying the polarisation states 902P2(L) and 902P2(T) such as is illustrated in FIG. 8H.

FIG. 8I is a schematic diagram illustrating in perspective top view propagation of a polarisation state 902 through an out-of-plane polariser 750 and a biaxial retarder arrangement 730; FIG. 8J is a schematic diagram illustrating in perspective left side view propagation of a polarisation state 902 through an out-of-plane polariser 750 and a biaxial retarder arrangement 730; FIG. 8K is a schematic diagram illustrating in perspective upper left quadrant view propagation of a polarisation state 902 through an out-of-plane polariser 750 and a biaxial retarder arrangement 730. Features of the embodiments of FIGS. 8I-K not discussed in further detail may be assumed to correspond to the features with equivalent reference numerals as discussed above, including any potential variations in the features.

FIGS. 8B-C illustrate that the biaxial retarder arrangement 730 may be formed as a C-plate arranged to receive the light from an A-plate. Principal axes comprising components nx, ny, nz of the A-plate and C-plate are aligned respectively parallel with the orthogonal x, y and z system axes and preserve polarization in the lateral viewing direction (for zero elevation angle) and elevation viewing directions (for zero lateral angle) so that no modification of polarisation states 902P2(T) and 902P2(L) is achieved, as illustrated in FIGS. 8I-K for the directions 663c, 663b respectively where the polarisation states 902P2(T) A, 902P2(T) B and 902P2(T) C are the same and the polarisation states 902P2(L) A, 902P2(L) B and 902P2(L) C are the same.

By comparison, in the viewing quadrant direction 663d as illustrated in FIG. 8I, the biaxial retarder 730 may be provided to provide rotation of polarisation state 902P2A at a desirable angle, such as illustrated by direction 663d in FIG. 8L hereinbelow. Such embodiments of biaxial retarder arrangement may achieve the desirable polarisation state 639 profiles of FIG. 8H.

FIG. 8L is a schematic graph illustrating a polar variation of transmission for the arrangement of FIG. 8A comprising the display device 100 arrangement of TABLE 2 with the biaxial retarder 732 of TABLE 3A and a polarisation switch 600 arranged in the second (privacy) mode that provides no polarisation rotation. Features of the embodiment of FIG. 8L not discussed in further detail may be assumed to correspond to the features with equivalent reference numerals as discussed above, including any potential variations in the features.

The biaxial retarder arrangement 730 is typically selected to minimize transmission in the non-viewing direction 447 in the privacy state where the polarisation switch 600 does not substantially change the transmitted polarisation state 904. In the share mode, a perfect LC switch would indeed do what the figures show.

By way of comparison with FIG. 7B, the alternative embodiment of FIG. 8L illustrates that luminance is reduced in the quadrant regions such as regions 761 of FIG. 8L by means of the biaxial retarder arrangement 730. Advantageously the size of the region for which security factor, S>1 may be increased.

TABLE 4 illustrates a B-plate for arrangement between an out-of-plane polariser 750 and an in-plane polariser 610.

TABLE 3A

| Item | Type | Property | Value (Range) |
|---|---|---|---|
| Biaxial | B-plate | Refractive index profile | ny > nx > nz |
| retarder | 732 | (nx − ny)d | −150 nm |
| arrangement | | | (−130 nm |
| 730 | | | to −170 nm) |
| | | (nx − nz)d | +300 nm |
| | | | (+270 nm |
| | | | to +330 nm) |
| | | Rth | +370 nm |
| | | | (+340 nm |
| | | | to +400 nm) |
| | | nx alignment | 0° in plane |
| | | ny alignment | 90° in plane |
| | | nz alignment | 90° out of plane |

In other words, the biaxial retarder arrangement 730 may comprise a B-plate 732. The B-plate 732 may comprise material 731 with principal components of refractive index nx, ny, nz and a thickness d, and wherein for light at a wavelength of 550 nm: the value of (nx−ny)d is in a range between −130 nm and −170 nm, the value of (nx−nz)d is in a range between +270 nm and +330 nm, and the value of a parameter Rth is in a range between +340 nm and +400 nm, wherein Rth=(nx+ny)/2−nz)d. A low thickness component may be provided that may be formed with low cost, for example by double stretching.

Alternative biaxial retarder arrangements 730 will now be further described. In an alternative arrangement of B-plate, a negative Rth may be provided, and the B-plate is rotated by 90 degrees so that the values of nx and ny are reversed compared to the embodiment of TABLE 3A. The embodiment of TABLE 3A is more conveniently provided by double stretching, in comparison to said alternative arrangement.

TABLE 3B provides illustrative arrangements for the embodiment of FIG. 8B.

TABLE 3B

| Item | | Property | Value (Range) |
|---|---|---|---|
| Biaxial retarder | A-plate 734 | (ne − no)d | +100 nm |
| arrangement 730 | | | (+85 nm |
| | | | to +115 nm) |
| | | ne alignment | 90° in plane |
| | Negative C-plate | (ne − no)d | −220 nm |
| | 737 | | (−190 nm |
| | | | to −250 nm) |
| | | ne alignment | 90° out of plane |

The biaxial retarder arrangement 730 may comprise a C-plate 736 arranged to receive the light output from an A-plate 734. For light at a wavelength of 550 nm the A-plate 734 has a retardance in a range between +85 nm and +115 nm, and the C-plate 736 is a negative C-plate with a retardance in a range between −190 nm and −250 nm. The complexity of manufacture of the retarders 734, 736 may be reduced, achieving reduced cost.

TABLE 3C provides illustrative arrangements for the embodiment of FIG. 8C to achieve the equivalent transmission profile of FIG. 8L.

TABLE 3C

| Item | | Property | Value (Range) |
|---|---|---|---|
| Biaxial retarder | A-plate 734 | (ne − no)d | +100 nm |
| arrangement 730 | | | (+85 nm |
| | | | to +115 nm) |
| | | ne alignment | 0° in plane |
| | Positive C-plate 738 | (ne − no)d | +250 nm |
| | | | (+220 nm |
| | | | to +280 nm) |
| | | ne alignment | 90° out of plane |

For light at a wavelength of 550 nm the A-plate 734 has a retardance in a range between +85 nm and +115 nm, and the positive C-plate 738 has a retardance in a range between +220 nm and +280 nm. The thickness of the positive C-plate 738 may be reduced compared to the thickness of the negative C-plate 736, for example by providing cured reactive mesogen layers on the A-plate 734.

The profile of FIG. 8L is provided for polarisation switch 600 that achieves substantially uniform polarisation state transmission in the second mode of operation which is typically the privacy mode. Performance of the first mode which is typically the share mode is modified by the selection of polarisation switch layer 601 and driving properties as will now be described.

It will be appreciated that the combination of values provided in TABLES 3A-C represent particularly beneficial or advantageous embodiments because in privacy mode the luminance in the viewing quadrants such as region 761 of the display device 100 may be reduced as shown in FIG. 8L in comparison to alternative combinations of values and advantageously image security improved.

In operation, the angular variation of output polarisation state of the out-of-plane polariser 750 of FIG. 8G may be modified by the means of the biaxial retarder arrangement 730 with said combination of values to achieve the angular variation of output polarisation state of FIG. 8H, which provides said reduction of luminance in region 761.

FIG. 9A is a schematic diagram illustrating in top view a SLDAA 200 comprising a twisted nematic polarisation switch 600 layer arranged in narrow-angle state; FIG. 9B is a schematic diagram illustrating in top view a SLDAA 200 comprising a twisted nematic polarisation switch 600 layer arranged in wide-angle state; and FIG. 9C is a schematic graph illustrating a polar variation of transmission for the arrangement of FIG. 9B, the display device 100 arrangement of TABLE 2, the biaxial retarder arrangement 730 of TABLE 3A and the polarisation switch 600 of TABLE 4. Features of the embodiment of FIGS. 9A-C not discussed in further detail may be assumed to correspond to the features with equivalent reference numerals as discussed above, including any potential variations in the features.

An illustrative embodiment for the liquid crystal polarisation switch layer 614 driven by driver 650 is given in TABLE 4 for a third minimum cell design to advantageously achieve low chromatic variation of polarisation state switching.

TABLE 4

| | LC polarisation switch layer 614 | | | | | | |
|---|---|---|---|---|---|---|---|
| | Alignment | | | | | | |
| | layers | Alignment | | | | | |
| Mode | 617A, 617B | direction | Pretilt/deg | Δn.d/nm | Twist | Δε | Voltage/V |
| Share | Homogeneous | 90° | 2 | 168 | 90° | +13.2 | V₆₁₄S: 5.0 |
| Privacy | Homogeneous | 180° | 2 | | | | V₆₁₄P: 0.0 |

Alternatively second or first minimum cell designs with lower Δn·d values can be chosen to achieve reduced switching time between privacy and share modes. Alternatively, the liquid crystal polarisation switch layer 614 can be made thicker still with the cell operating well in to the Mauguin limit. By comparison with FIG. 7C, reduced transmission is provided in directions 447 to the user 47 in share mode.

An alternative polarisation switch 600 will now be described.

FIG. 9D is a schematic diagram illustrating in perspective front view a polarisation switch 600 comprising a vertically aligned polarisation switch layer 614 with privacy and share mode regions 626a, 626b; and FIG. 9E is a schematic graph illustrating a polar variation of transmission for the polarisation switch of FIG. 9D the display device 100 arrangement of TABLE 2, the biaxial retarder arrangement 730 of TABLE 3A and the polarisation switch 600 of TABLE 5. Features of the embodiments of FIGS. 9D-E not discussed in further detail may be assumed to correspond to the features with equivalent reference numerals as discussed above, including any potential variations in the features.

The polarisation switch 600 may provide a switchable half wave plate to provide polarisation state 902 rotation to output polarisation state 904. The regions 626a, 626b may be provided by patterning of the electrode 619a or alternatively by patterning of electrode 619b.

TABLE 5

| | LC polarisation switch layer 614 | | | | | | |
|---|---|---|---|---|---|---|---|
| | Alignment | | | | | | |
| | layers | Alignment | | | | | |
| Mode | 617A, 617B | direction | Pretilt/deg | Δn.d/nm | Twist | Δε | Voltage/V |
| Share | Homeotropic | 45° | 88 | 312 | 0° | +10.3 | V₆₁₄S: 7.0 |
| Privacy | Homeotropic | 225° | 88 | | | | V₆₁₄P: 0 |

Patterning of share and privacy mode regions is provided by a gap between electrodes 619Aa and 619Ab. The profile of transmission in privacy mode is substantially the same as for FIG. 8L. By way of comparison with FIG. 9C, FIG. 9E illustrates that improved transmission may be achieved in the lateral direction.

Additional retarders (not shown) such as half wave A-plates and half wave C-plates may be provided to achieve improved chromaticity of rotation, advantageously achieving reduced colour change between share and privacy mode of operation such as through Pancharatnum retarder arrangements.

The operation of illustrative display devices 100 will now be discussed in more detail.

FIG. 10A is a schematic diagram illustrating in top view a collimated backlight 20 and output cone 470 and FIG. 10B is a schematic graph illustrating a polar variation of luminance for an illustrative embodiment of FIG. 10A wherein the backlight 20 comprises the light source array 15, optical waveguide 1 and light turning film 50 of FIG. 1A. Features of the embodiment of FIGS. 10A-B not discussed in further detail may be assumed to correspond to the features with equivalent reference numerals as discussed above, including any potential variations in the features.

For an observer in direction 447 receives light with luminance greater than 1% of the peak luminance seen by the observer at direction 445. Such a luminance provides an inadequate security factor for privacy mode operation, and an inadequate luminance for share mode operation for high image visibility in comparison to the luminance of reflected light from the display. It would be desirable to reduce the privacy mode luminance in direction 447 and increase the share mode luminance in direction 447.

FIG. 10C is a schematic diagram illustrating in top view the optical stack of a display device 100 not comprising a biaxial retarder arrangement 730 and in-plane polariser 610 and operating in privacy mode, FIG. 10D is a schematic graph illustrating a polar variation of luminance for an illustrative embodiment of FIG. 10C comprising the backlight 20 profile of FIG. 10B and the transmission profile of FIG. 7B, and FIG. 10E is a schematic graph illustrating a polar variation of security factor for 1 lux/nit illuminance to peak luminance ratio for an illustrative embodiment of FIGS. 10C-D and including front surface reflection from the display device 100. Features of the embodiment of FIGS. 10C-E not discussed in further detail may be assumed to correspond to the features with equivalent reference numerals as discussed above, including any potential variations in the features.

The arrangement of FIGS. 10C-E advantageously achieves a security factor greater than 1.0 at the direction 447 and so desirable image security factor is provided. Such an arrangement may be suitable for applications such as laptops, cell phones or monitors.

FIG. 10F is a schematic diagram illustrating in top view the optical stack of a display device 100 further comprising a biaxial retarder arrangement 730 and operating in privacy mode, FIG. 10G is a schematic graph illustrating a polar variation of luminance for an illustrative embodiment of FIG. 10F comprising the backlight 20 profile of FIG. 10B and the transmission profile of FIG. 8L, and FIG. 10H is a schematic graph illustrating a polar variation of security factor for 1 lux/nit illuminance to peak luminance ratio for an illustrative embodiment of FIGS. 10F-G and including front surface reflection from the display device 100. Features of the embodiment of FIGS. 10F-H not discussed in further detail may be assumed to correspond to the features with equivalent reference numerals as discussed above, including any potential variations in the features.

By way of comparison with FIGS. 10C-E the alternative embodiment of FIGS. 10F-H provides an increased size of the region for which desirable security factor is provided. Advantageously visibility of the displayed image to off-axis snoopers 47 is reduced over a larger polar region. Further the size of the region for which low image visibility and low image security is provided is reduced.

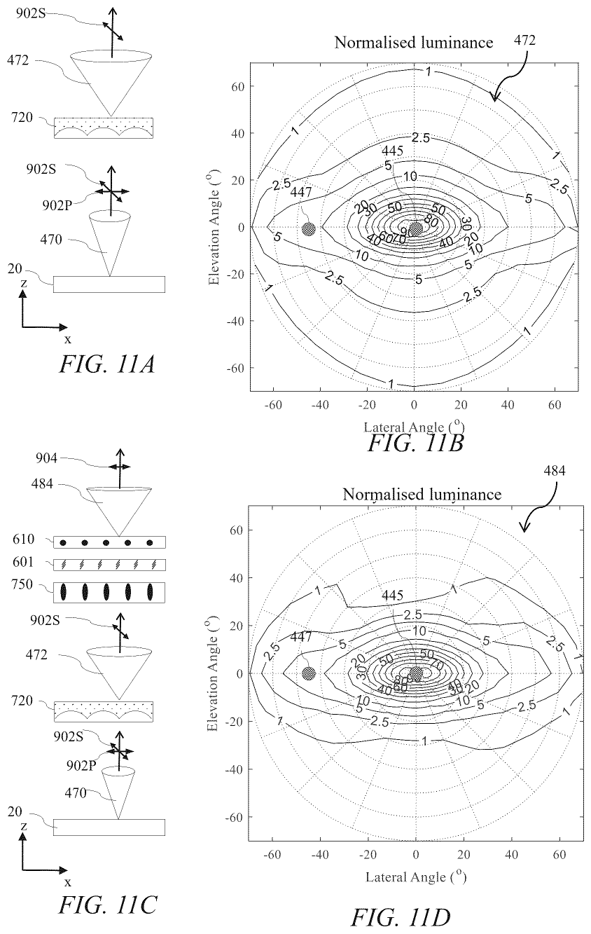

FIG. 11A is a schematic diagram illustrating in top view a collimated backlight 20, a structured birefringent component 720 and output cone 472, FIG. 11B is a schematic graph illustrating a polar variation of luminance for an illustrative embodiment of FIG. 11A wherein the backlight 20 comprises the light source array 15, optical waveguide 1 and light turning film 50 of FIG. 1A and the structured birefringent component 720 is arranged to disperse light in the lateral direction; FIG. 11C is a schematic diagram illustrating in top view a collimated backlight 20, a structured birefringent component 720 a twisted nematic liquid crystal polarisation switch 600 and an in-plane polariser 610, and FIG. 11D is a schematic graph illustrating a polar variation of luminance for an illustrative embodiment of FIG. 11C wherein the backlight 20 comprises the light source array, optical waveguide and light turning film of FIG. 1A, the structured birefringent component 720 is arranged to disperse light in the lateral direction, and the transmission profile of the twisted nematic liquid crystal polarisation switch 600 is as illustrated in FIG. 9C. Features of the embodiment of FIGS. 11C-D not discussed in further detail may be assumed to correspond to the features with equivalent reference numerals as discussed above, including any potential variations in the features.

By way of comparison with FIGS. 10A-B, the alternative embodiments of FIGS. 11A-D illustrate that the luminance to an off-axis user 47 in direction 447 is increased. Advantageously improved image visibility is provided over an increased range of polar angles. By way of comparison with FIG. 11B, the embodiment of FIG. 11D illustrates that there may be some reduction of size of the polar region for which desirable image visibility is achieved in share mode. The biaxial retarder arrangement 730 and arrangement of polarisation switch 600 may be arranged to improve the share mode image visibility such as in FIG. 9E in comparison to FIG. 9C hereinabove.

Arrangements of structured birefringent component 720 will now be described.

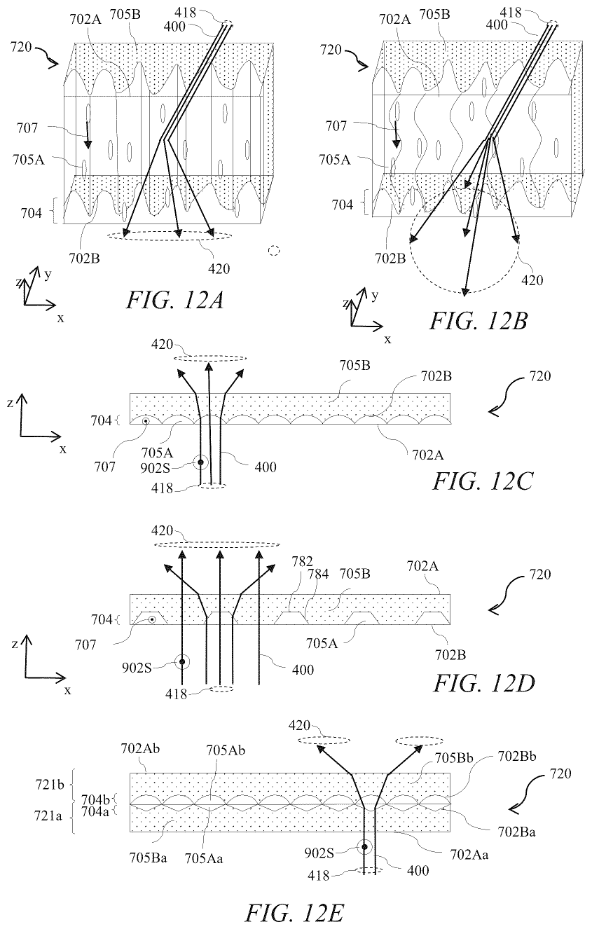

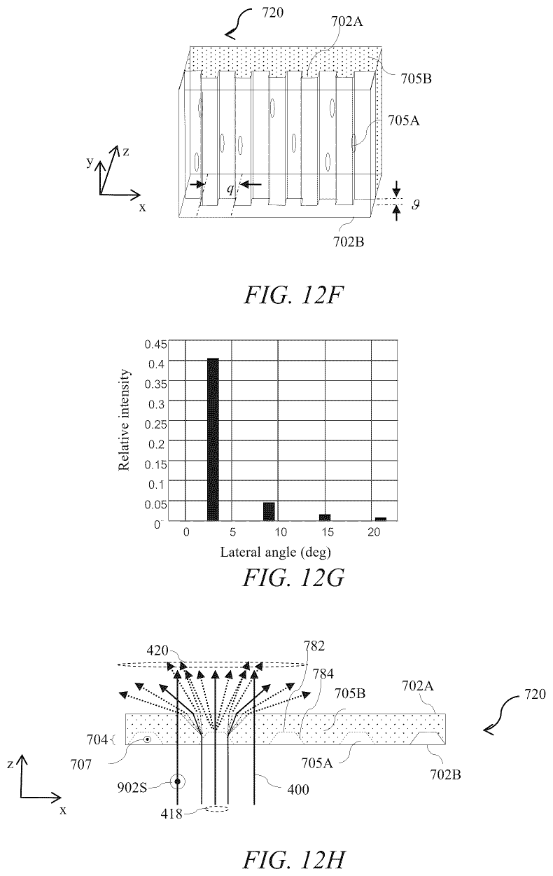

FIG. 12A is a schematic diagram illustrating in perspective front view a structured birefringent component 720 comprising a structured surface 702B of birefringent layer 704 comprising a one-dimensional random structure. Features of the embodiment of FIG. 12A not discussed in further detail may be assumed to correspond to the features with equivalent reference numerals as discussed above, including any potential variations in the features.

By way of comparison with FIG. 1A, the alternative embodiment of FIG. 12A illustrates that the structured surface 702B may comprise a randomised one-dimensional surface structure. Moiré patterning between the structure of the structured surface 702B and the pixels 222 may be advantageously achieved. Considering a collimated input beam 418 of parallel light rays 400, the output beam 420 in share mode has increased lateral width. The final output profile is the convolution of the input light cone 470 with the beam 420 and may achieve improved image visibility for users 47 in directions 447 as described hereinabove.

FIG. 12B is a schematic diagram illustrating in perspective front view a structured birefringent component 720 comprising a structured surface 702B of birefringent layer 704 comprising a two-dimensional random structure. Features of the embodiment of FIG. 12B not discussed in further detail may be assumed to correspond to the features with equivalent reference numerals as discussed above, including any potential variations in the features.

By way of comparison with FIG. 12A, the alternative embodiment of FIG. 12B illustrates a two-dimensional structure of the structured surface 702B that provides spreading of light into beam 420. Improved image visibility in both lateral and elevation directions may be achieved.

FIG. 12C is a schematic diagram illustrating in top view a structured birefringent component 720 comprising a structured surface 702B of birefringent layer 704 comprising a lens array structure. Features of the embodiment of FIG. 12C not discussed in further detail may be assumed to correspond to the features with equivalent reference numerals as discussed above, including any potential variations in the features.

The structure of FIG. 12C is similar to that of FIG. 1A for comparison purposes. The structured surface 702B may further be provided as a two-dimensional array of lenses to achieve improved image visibility in lateral and elevation directions. The component 720 may alternatively be arranged so that light passes from the material 705B into the material 705A. Total internally reflected rays may be modified and the output beam 420 modified.

FIG. 12D is a schematic diagram illustrating in top view a structured birefringent component 720 comprising a structured surface 702B of birefringent layer 704 comprising a prismatic array structure. Features of the embodiment of FIG. 12D not discussed in further detail may be assumed to correspond to the features with equivalent reference numerals as discussed above, including any potential variations in the features.

By way of comparison with FIG. 12C, the alternative embodiment of FIG. 12D illustrates in-plane facets 782 and tilted facets 784. The output beam 420 may be modified to provide a desirable trade-off between head-on luminance in direction 445 and off axis luminance in direction 447 by adjustment of the proportion of in-plane facets 782 and tilted facets 784.

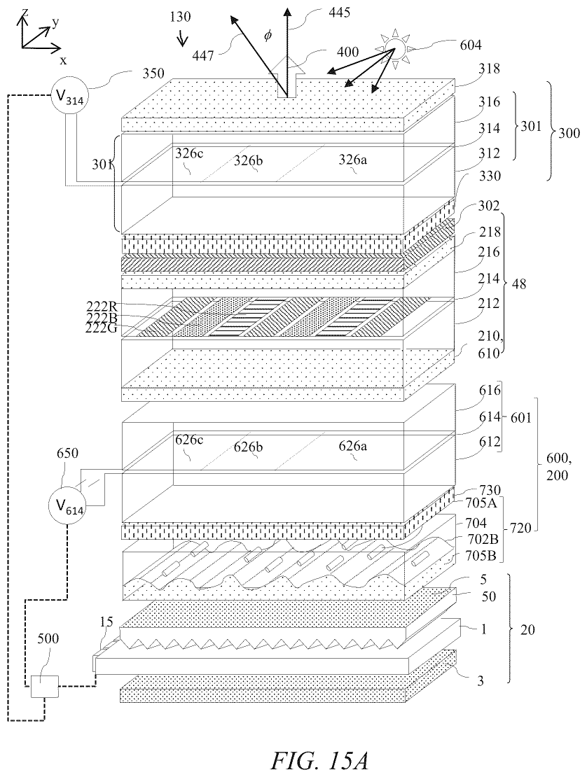

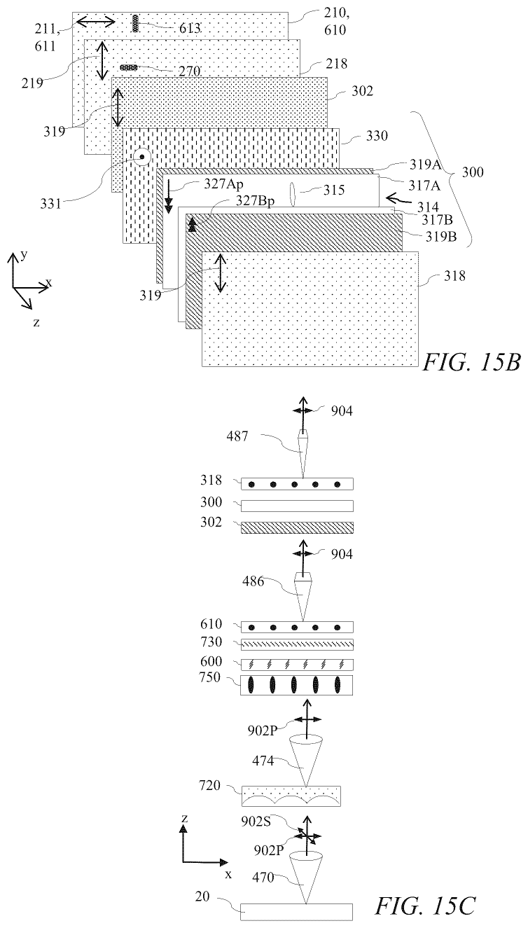

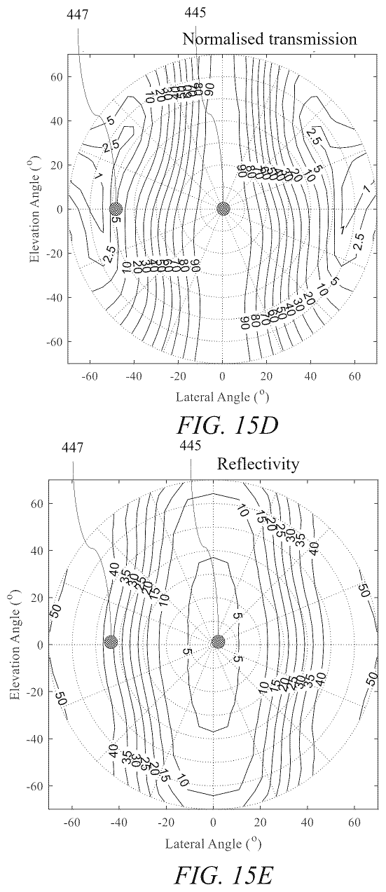

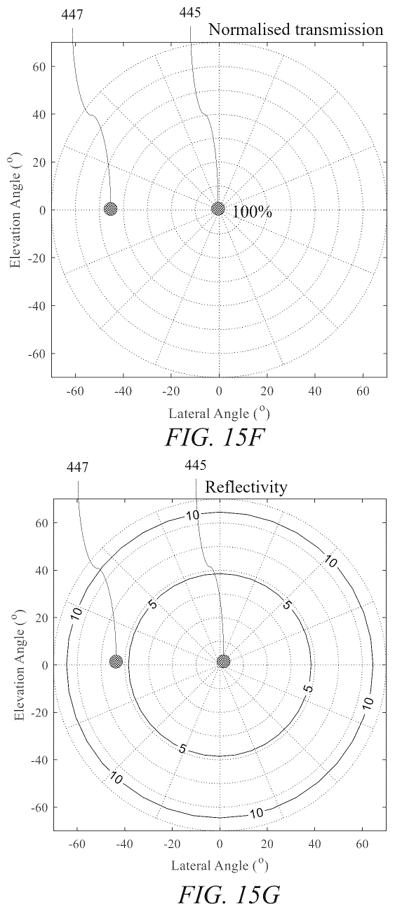

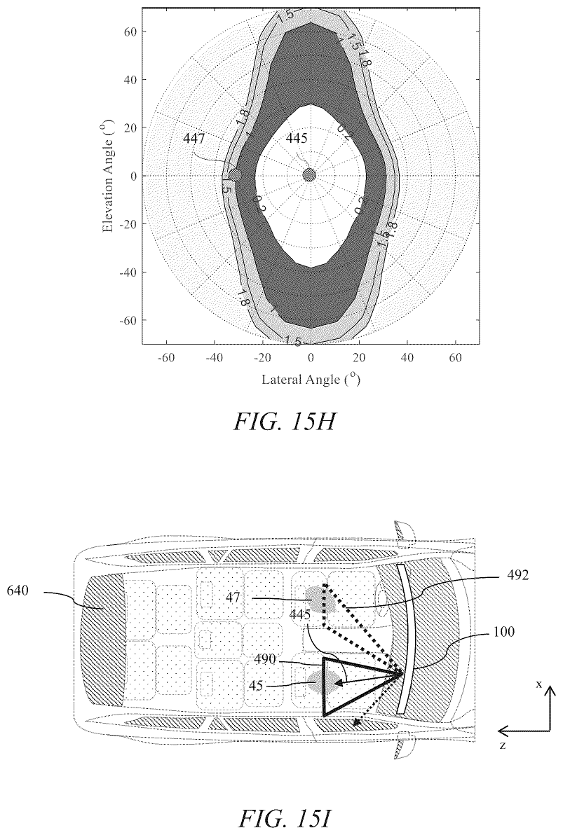

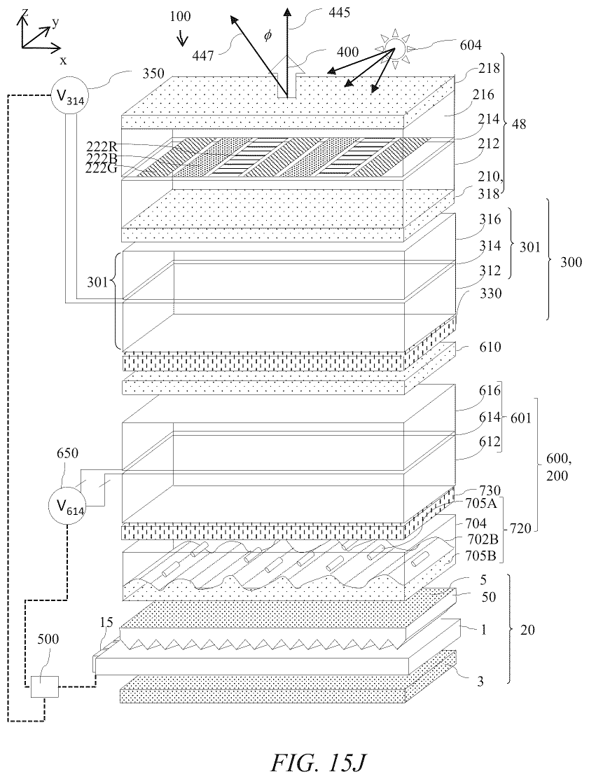

In alternative embodiments, the prismatic facets 784 may be arranged to primarily achieve deflection to one side of the display device 100, for example for automotive applications. For example some of the facets may be vertical and others may be inclined. Image visibility in share mode to a driver 47 for example as illustrated in FIG. 15H may be improved.

FIG. 12E is a schematic diagram illustrating in top view a birefringent component comprising a passive birefringent sub-component 721a comprising a first material 705Ba that may be isotropic for example, a prismatic surface relief structure 702Ba and a first birefringent material 705Aa; and a further passive birefringent sub-component 721b comprising a second birefringent material 705Ab, a lensing surface relief structure 702Bb and a second material 705Bb that may be isotropic for example. Features of the embodiment of FIG. 12E not discussed in further detail may be assumed to correspond to the features with equivalent reference numerals as discussed above, including any potential variations in the features.

By way of comparison with FIG. 12C, the alternative embodiment of FIG. 12E illustrates that the structured birefringent component 720 may comprise a more that one sub-component 721a, 721b that may be arranged to increase the spreading of beams 720 and improve off-axis image visibility.

FIG. 12F is a schematic diagram illustrating in perspective front view a diffractive structured birefringent component 720; and FIG. 12G is a schematic graph illustrating a profile of diffracted luminance into diffractive orders 430 for the embodiment of FIG. 12F in wide-angle state; and FIG. 12H is a schematic diagram illustrating in top view a birefringent component 720 comprising a structured surface 702B of birefringent layer comprising a diffractive and refractive prismatic structure with inclined diffractive facets 782, 784. Features of the embodiment of FIGS. 12F-G not discussed in further detail may be assumed to correspond to the features with equivalent reference numerals as discussed above, including any potential variations in the features.

By way of comparison with FIG. 12C, the alternative embodiment of FIG. 12F illustrates that diffractive structures with pitch q and phase depth 9 may be provided to achieve diffractive light spreading such as illustrated by FIG. 12G. Advantageously the thickness and cost of the layer of birefringent material 705A may be reduced.

The embodiments of FIGS. 12A-F are non-exhaustive descriptions for the arrangements of structures 702B and may be used as alternatives or in combination. For example the prismatic structures of FIG. 12D may further comprise the diffractive structures of FIG. 12F to provide improved spreading of light in share mode and achieve desirable image visibility to users 47.

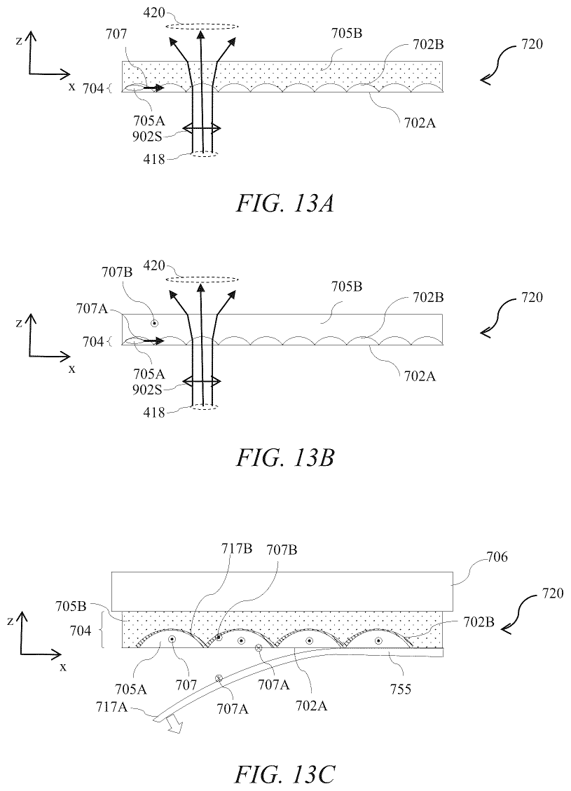

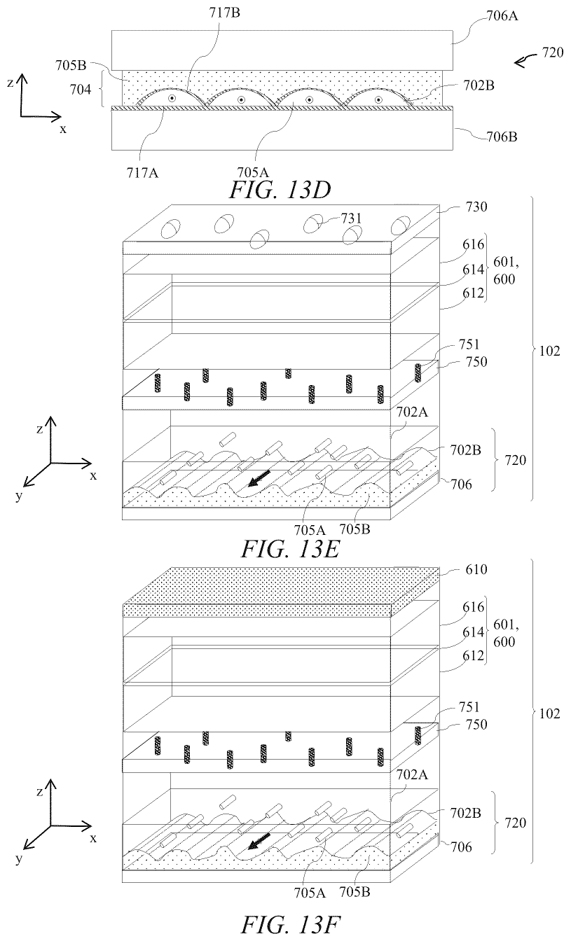

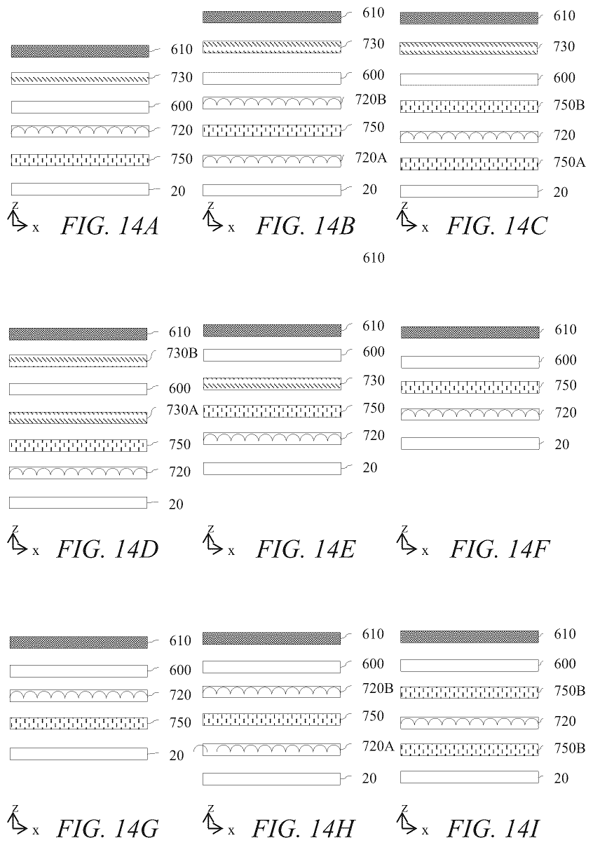

Alternative arrangements of alignment of the birefringent material 705A and the material 705B will now be described. The arrangements of FIGS. 13A-C may further be provided with the structures 702B of FIGS. 12A-F or further alternatives of structures 702B.

FIG. 12H illustrates that the output luminance profile may be further modified by incorporating diffractive structures into the refractive surface relief of the structured surface 702B. Further modification of luminance profile is achieved and advantageously improved image 338 visibility in wide-angle mode.

In general, the structured birefringent component 720 comprises one or more of: a refractive structure having optical power in only one dimension; a refractive structure having optical power in two dimensions; a diffractive structure having optical power in only one dimension; a diffractive structure having optical power in two dimensions.

FIG. 13A is a schematic diagram illustrating in top view a structured birefringent component 720 comprising an alternative alignment of birefringent material 705A. Features of the embodiment of FIG. 13A not discussed in further detail may be assumed to correspond to the features with equivalent reference numerals as discussed above, including any potential variations in the features.

By way of comparison with FIG. 12C, the alternative embodiment of FIG. 13A illustrates that the alignment direction 707 of the birefringent material 705A may be provided at an alternative angle, for example across the lateral direction. The polarisation state 902S that is provided with optical power by the birefringent component 720 is rotated. A further half waveplate (not shown) may be provided between the structured birefringent component 720 and the out-of-plane polariser 750 to achieve desirable output properties.

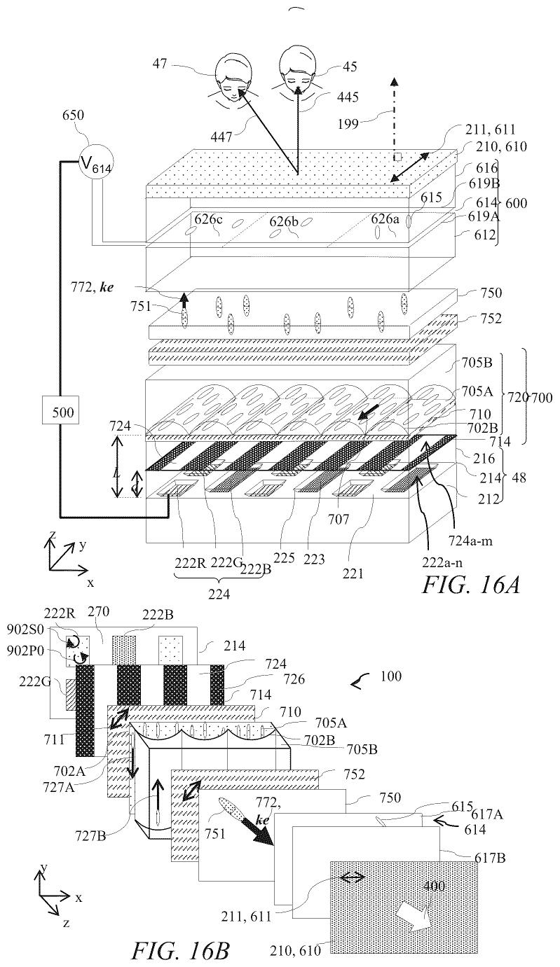

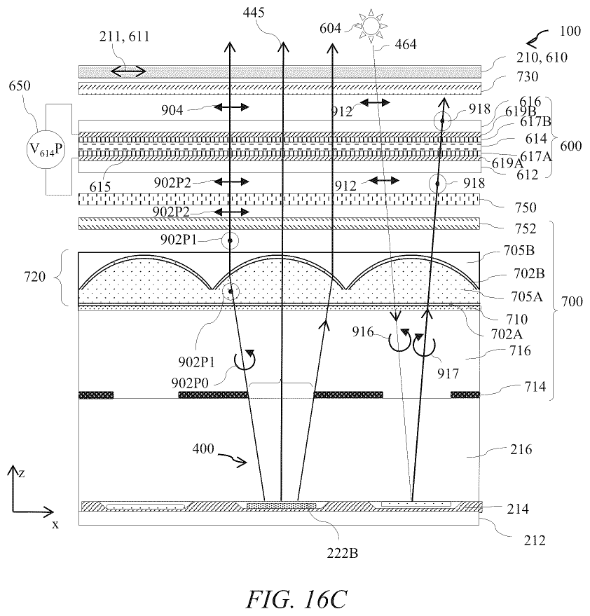

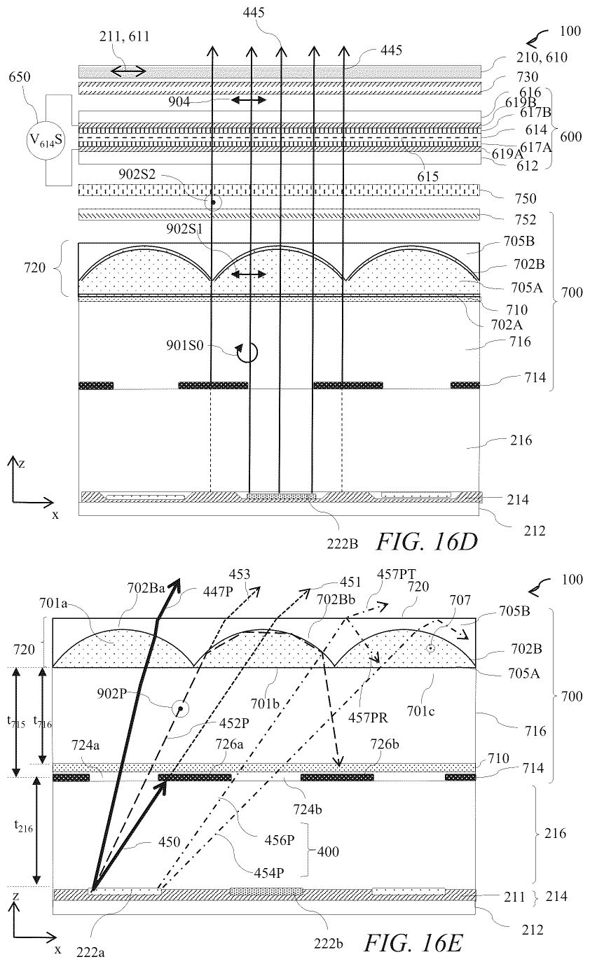

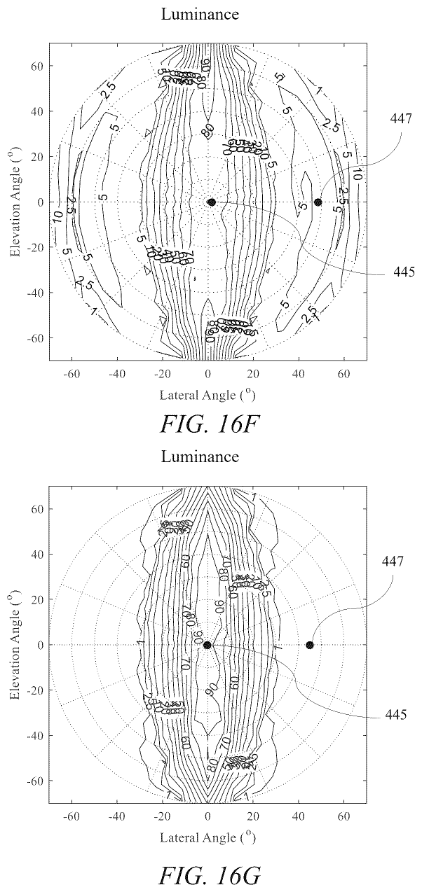

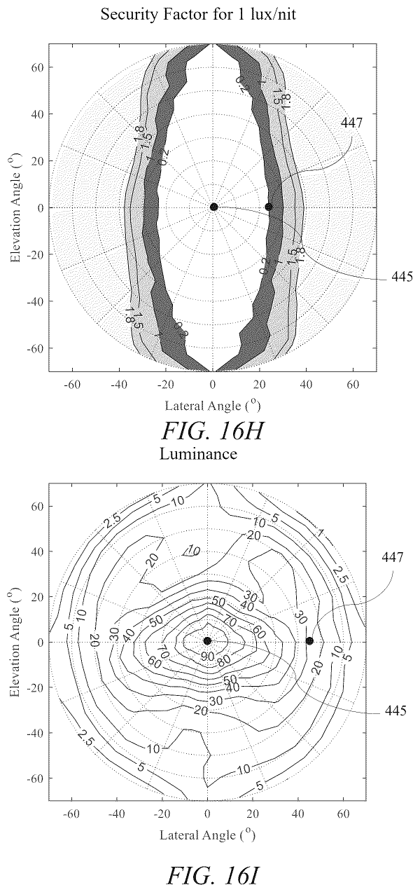

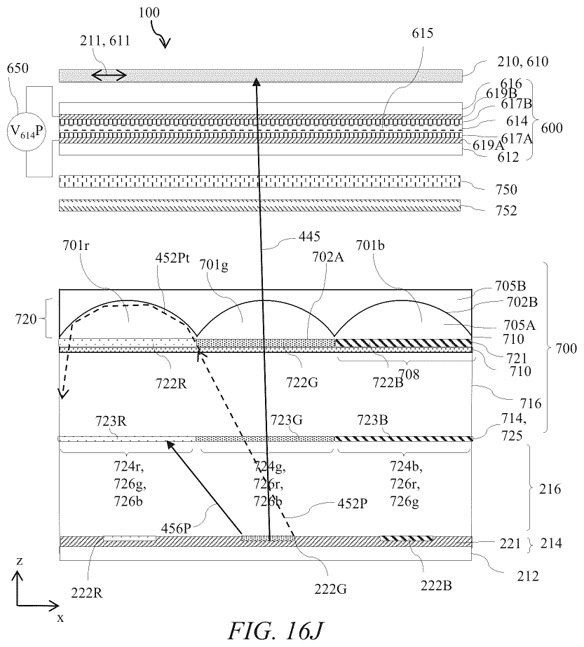

In operation, the backlight 20 may be partially polarised such that, considering FIGS. 2A-B, more light may be provided in the polarisation state 902P that the polarisation state 902S. It may be desirable to have higher luminance in the share mode than the privacy mode to compensate for the luminance reduction of the light spreading function. Further, such an arrangement may be provided for the arrangement of FIG. 18A and FIG. 16A as described hereinbelow. Advantageously, the half waveplate 752 may be omitted and the cost, thickness and complexity reduced.

FIG. 13B is a schematic diagram illustrating in top view a structured birefringent component 720 comprising an alternative arrangement of material 705B. Features of the embodiment of FIG. 13B not discussed in further detail may be assumed to correspond to the features with equivalent reference numerals as discussed above, including any potential variations in the features.

By way of comparison with FIG. 12C, the alternative embodiment of FIG. 13A comprises first and second birefringent materials 705A, 705B. The alignment directions 707A, 707B are illustrated as orthogonal. The extraordinary index of the material 705A may be the same as the ordinary index of the material 705B for example to achieve index matching in privacy mode. Increased refractive index step and the structured surface 702B may be provided to achieve increased optical power and increased light dispersion into beam 420. Increased image visibility may be provided to off-axis users 47.

FIG. 13C is a schematic diagram illustrating in top view a step in the manufacture of a structured birefringent component 720 comprising an arrangement of surface alignment layer 717B. Features of the embodiment of FIG. 13C not discussed in further detail may be assumed to correspond to the features with equivalent reference numerals as discussed above, including any potential variations in the features.

Isotropic material 702B may be provided on the substrate 706 and the structured surface 702B formed in the material 702B, for example by moulding or UV casting.

An alignment layer 717B may be provided at the structured surface 702B. The alignment direction 707B at the alignment layer 717B may be provided by for example photoalignment or by rubbing of the alignment layer 717B.

A flexible substrate 755 such as PET may have its surface rubbed with alignment direction 707B to provide the alignment layer 717A. The flexible substrate 755 is provided adjacent the material 705B and the gaps of the structured surface 702B filled with the birefringent material 705A that may be a reactive mesogen material in a nematic phase for example. The material 705A may take up the alignment from alignment layer 717A, 717B and is cured, for example by UV illumination.

In the step of FIG. 13C, the flexible substrate 755 and hence the alignment layer 717A is removed from the from the cured liquid crystal material 705A by peeling, to leave a structure similar to that illustrated in FIG. 12C. A thin structured birefringent component 720 with desirable alignment directions 707A, 707B may be provided.

In alternative embodiments, the material 705B may be provided by a birefringent material that may be a cured liquid crystal material such as a reactive mesogen material. Embodiments such as illustrated in FIG. 13B may be provided.

FIG. 13D is a schematic diagram illustrating in top view a structured birefringent component 720 comprising an alternative arrangement of surface alignment layers 717A, 717B. Features of the embodiment of FIG. 13D not discussed in further detail may be assumed to correspond to the features with equivalent reference numerals as discussed above, including any potential variations in the features.

By way of comparison with FIG. 13C, the alternative embodiment of FIG. 13D illustrates that the substrate 706 may be provided by first substrate 706A and a further substrate 706B with alignment layer 717A may be provided. The material 705A may be a non-cured liquid crystal material. A wider selection of birefringent material 705A properties may be achieved.

Examples of view angle control optical elements 102 will now be described.

FIG. 13E is a schematic diagram illustrating in perspective side view a view angle control optical element comprising a structured birefringent component, a polarisation switch and a biaxial retarder; and FIG. 13F is a schematic diagram illustrating in perspective side view a view angle control optical element comprising a structured birefringent component, a polarisation switch and an in-plane polariser. Features of the embodiments of FIGS. 13E-F not discussed in further detail may be assumed to correspond to the features with equivalent reference numerals as discussed above, including any potential variations in the features.

The alternative embodiments of FIGS. 13E-F illustrate a view angle control optical element 102 for use with an in-plane polariser 610 and at least one light source (such as backlight 20 or emissive pixels 222) of a display device 100, the view angle control optical element 102 comprising: a structured birefringent component 720; an out-of-plane polariser 750; and a polarisation switch 600 for switching the display device between a first mode of operation and a second mode of operation, wherein: the out-of-plane polariser 750 is arranged between the structured birefringent component 720 and the polarisation switch 600; or the structured birefringent component 720 is arranged between the out-of-plane polariser 750 and the polarisation switch 600.

In other words, view angle control optical elements 102 may be provided for use with at least one light source of a display device 100, the view angle control optical elements 102 comprising: a structured birefringent component 720; an out-of-plane polariser 750; a polarisation switch 600 for switching the display device 100 between a first mode of operation and a second mode of operation; and for use with an in-plane polariser 610, wherein the polarisation switch 600 is arranged between the out-of-plane polariser 750 and the in-plane polariser 610, and the polarisation switch 600 is also arranged between the structured birefringent component 720 and the in-plane polariser 610.

The view angle control elements 102 may be provided for assembly with spatial light modulators 48, and polar control retarders 300 as will be described hereinbelow.

Alternative arrangements of the optical stack of FIG. 1A will now be described.

FIG. 14A, FIG. 14B, FIG. 14C, FIG. 14D, FIG. 14E, FIG. 14F, FIG. 14G, FIG. 14H and FIG. 14I are schematic diagrams illustrating in top view various alternative structures of parts of optical stacks of display device 100. Features of the embodiments of FIGS. 14A-I not discussed in further detail may be assumed to correspond to the features with equivalent reference numerals as discussed above, including any potential variations in the features.

By comparison with FIG. 1A, the alternative embodiment of FIG. 14A illustrates that the out-of-plane polariser 750 may be arranged between the light source comprising backlight 20 and the structured birefringent component 720.

By comparison with FIG. 1A, the alternative embodiment of FIG. 14B illustrates that plural structured birefringent components 720A, 720B may be provided. Increased luminance may be provided in wide-angle mode, advantageously increasing image 338 visibility.

By comparison with FIG. 1A, the alternative embodiment of FIG. 14C illustrates that plural out-of-plane polarisers 750A, 750B may be provided. Reduced off-axis luminance in direction 447 may be provided in narrow-angle mode, advantageously increasing security factor.

By comparison with FIG. 1A, the alternative embodiment of FIG. 14D illustrates that plural biaxial retarders 730A. 730B may be provided. Improved control of the polarisation state incident onto the in-plane polariser 610 may be achieved. Considering FIG. 8L, increased security factor may advantageously be achieved in region 761.

By comparison with FIG. 1A, the alternative embodiment of FIG. 14E illustrates that the biaxial retarder arrangement 730 may be provided between the out-of-plane polariser 750 and the polarisation switch. Modified control of the polarisation state incident onto the in-plane polariser 610 may be achieved.

By comparison with FIG. 1A, the alternative embodiments of FIGS. 14F-I illustrates that the biaxial retarder arrangement 730 may be omitted. Cost, thickness and complexity may advantageously be reduced.

It would be desirable to increase the region for which high security factor is achieved for an off-axis snooper.

FIG. 15A is a schematic diagram illustrating in perspective side view an alternative switchable privacy display device 100 comprising the arrangement of FIG. 1A and further comprising a reflective polariser 302, a polar control retarder 300 and an additional polariser 318 arranged to receive light from the further display polariser 218 of the SLM 48; and FIG. 15B is a schematic diagram illustrating in perspective front view, alignment of optical layers in SLM 48 and output layers of the optical stack of FIG. 15A; and FIG. 15C is a schematic diagram illustrating in top view, operation of optical layers in the optical stack of FIG. 15A wherein the polarisation switch 600 and switchable liquid crystal retarder 300 are each arranged to provide narrow-angle state of operation. Features of the embodiment of FIGS. 15A-C not discussed in further detail may be assumed to correspond to the features with equivalent reference numerals as discussed above, including any potential variations in the features.

By way of comparison with FIG. 1A, the display device 100 further comprises: a polar control retarder 300. Polar control retarder 300 comprises a passive compensation retarder 330 and a switchable liquid crystal retarder 301.

The SLM 48 is arranged between the polarisation switch 600 and the at least one polar control retarder 300, and the display device 100 comprises an additional polariser 318 arranged on an output side of the polar control retarder 300. The polar control retarder 300 comprises a switchable liquid crystal retarder 301 comprising a layer 314 of liquid crystal material 315.

The switchable liquid crystal retarder 301 comprises two surface alignment layers 317A, 317B disposed adjacent to the liquid crystal material on opposite sides thereof and each arranged to provide alignment at the adjacent liquid crystal material. The switchable liquid crystal retarder 301 further comprises transmissive electrodes 319A. 319B arranged to apply a voltage V₃₁₄ for controlling the layer 314 of liquid crystal material 315. The transmissive electrodes 319A, 319B are on opposite sides of the layer 314 of liquid crystal material 315. The control system 500 is further arranged to control the voltage V₃₁₄ applied across the transmissive electrodes 319A, 319B of the switchable liquid crystal retarder 301. The switchable liquid crystal retarder layer 314 is arranged between (i) transparent substrate 312, electrode 319A and alignment layer 317A; and (ii) transparent substrate 316, electrode 319B and alignment layer 317B that are arranged on opposite sides of the liquid crystal polarisation switch layer 314.

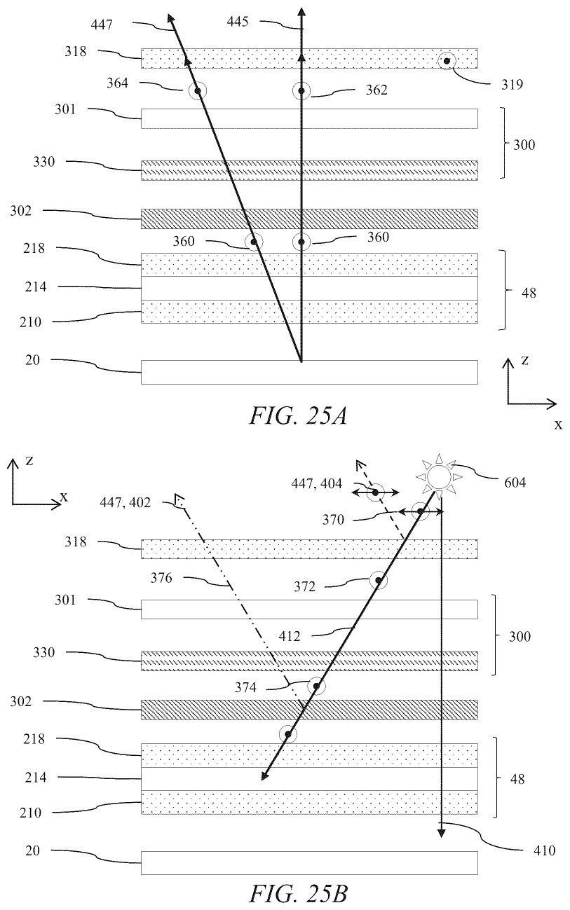

The operation of the polar control retarder is described further with reference to FIG. 24A and FIG. 25A hereinbelow. The one polar control retarder 300 is arranged, in a switchable state of the switchable liquid crystal retarder 301, simultaneously to introduce no net relative phase shift to orthogonal polarisation components of light passed by the SLM 48 along a first axis 445 and to introduce a net relative phase shift to orthogonal polarisation components of light passed by the SLM 48 along a second axis 447 inclined to first axis 445. The passive compensation retarder 330 is arranged simultaneously to introduce no net relative phase shift to orthogonal polarisation components of light passed by the in-plane polariser 610 and by the SLM 48 along the first axis 445 and to introduce a net relative phase shift to orthogonal polarisation components of light passed by the in-plane polariser 610 along the second axis 447. The principles of operation and alternative embodiments of the polar control retarder 300 comprising liquid crystal layers 314 and passive compensation retarders 330 arranged between an in-plane polariser such as display polariser 210 or further display polariser 218 and an additional polariser 318 are described in U.S. Pat. No. 11,092,851, which is herein incorporated by reference in its entirety.

The display device 100 further comprises a reflective polariser 302 arranged between the SLM 48 and the at least one polar control retarder 300. The reflective polariser 302 is arranged between the further display polariser 218 and the at least one polar control retarder 300, the reflective polariser 302 being a linear polariser arranged to pass the same linearly polarised polarisation component as the further display polariser 218. The principles of operation and alternative embodiments of the polar control retarder 300 arranged between further display polariser 218 and additional polariser 318 are described in U.S. Pat. No. 10,976,578, which is herein incorporated by reference in its entirety. The operation of the polar control retarder arranged between reflective polariser 302 and additional polariser 318 is described further with reference to FIG. 24B and FIG. 25B hereinbelow.

At least one of the electrodes 319A, 319B may be patterned into regions 326a, 326b, 326c that correspond to and are in alignment with the regions 626a, 626b, 626c of FIG. 1A. The output of the polar control retarder 300 may be different in different regions to achieve different regions of privacy and share mode operation across the display device 100.

By way of comparison with the embodiment of FIGS. 1A-B and FIG. 2A, the alternative embodiment of FIGS. 15A-C illustrate that the output cone 487 may have reduced width compared to cone 486 and as will be described with respect to FIG. 15D hereinbelow. Further increased reflectivity in privacy mode may be achieved, as described further in FIG. 15E and FIGS. 24A-B hereinbelow.

Further, in the wide-angle mode of operation, the size of the cone 484 of FIG. 2B may be substantially unaltered from the cone 484, as illustrated by the profiles of FIGS. 15F-G and as described further in FIGS. 25A-B hereinbelow.

The polar control retarder 300 is different to the polarisation switch 600. The polarisation switch 600 is arranged to provide switching between two different output polarisation states 904P, 904S as described hereinabove. By comparison, the polar control retarder 300 is arranged to provide in a narrow angle mode of operation a polarisation state incident onto the additional polariser 318 that varies with polar angle. Such variation of polarisation state provides difference of transmission with viewing angle as illustrated for example in FIG. 15D. Advantageously reduced luminance and increased transmission in directions 447 towards snooper 47 may be achieved and security factor increased.

Illustrative profiles of transmission and reflection for polar control retarder 300 of the display device 100 of FIG. 15A will now be described.

FIG. 15D is a schematic graph illustrating a polar variation of transmission for the switchable liquid crystal retarder arrangement 300 of FIG. 15A and TABLE 6-7 in narrow-angle state; FIG. 15E is a schematic graph 300 illustrating a polar variation of reflectivity for the switchable liquid crystal retarder arrangement of FIG. 15A and TABLE 6-7 in narrow-angle state; FIG. 15F is a schematic graph 300 illustrating a polar variation of transmission for the switchable liquid crystal retarder arrangement of FIG. 15A and TABLE 6-7 in wide-angle state; and FIG. 15G is a schematic graph 300 illustrating a polar variation of reflectivity for the switchable liquid crystal retarder arrangement of FIG. 15A and TABLE 6-7 in wide-angle state. Features of the embodiments of FIGS. 15C-F not discussed in further detail may be assumed to correspond to the features with equivalent reference numerals as discussed above, including any potential variations in the features.

TABLE 6

| | | Illustrative |
|---|---|---|
| Item | Property | embodiment |
| Further display | Electric vector transmission | 90° |
| polariser 218 | direction, 911 | |
| Surface alignment | Type | Homogeneous |
| layer 317A | In-plane alignment direction 927Ap | 90° |
| | angle θ_{A} | |
| | Pretilt angle | 2° |
| Surface alignment | Type | Homeotropic |
| layer 317B | In-plane alignment direction 927Bp | 270° |
| | angle θ_{B} | |
| | Pretilt angle | 90° |
| LC layer 314 | Retardance | 1000 nm |
| Passive | Type | Negative |
| compensation | | C-plate |
| retarder 330 | Retardance | −800 nm |
| Additional | Electric vector transmission | 90° |
| polariser 318 | direction, 919 | |

TABLE 7

| Item | Wide-angle state | Narrow-angle state |
|---|---|---|
| FIG. | 15E, 15F | 15C, 15D |
| V₃₁₄ | +10 V | +1.4 V |

FIG. 15H is a schematic graph illustrating a polar variation of security factor for 1 lux/nit illuminance to peak luminance ratio for an illustrative embodiment of FIGS. 10F-G and FIGS. 15C-D and including front surface reflection from the display device 100; and FIG. 15I is a schematic diagram illustrating in top view an automotive vehicle 640 comprising the display device 100 of the present disclosure. Features of the embodiments of FIGS. 15H-I not discussed in further detail may be assumed to correspond to the features with equivalent reference numerals as discussed above, including any potential variations in the features.

By way of comparison with FIG. 10H, in the alternative embodiment of FIG. 15H the location 447 for which the security factor, S>1 is reduced in lateral angle and the region for which high image security to the driver 47 of FIG. 151 is reduced. The size of the cone 492 for which no driver 47 distraction is achieved is increased and occupant safety advantageously improved.

The passenger 45 may see an image on the display device 100 with high image visibility. The regions 326a-c and regions 626a-c may be provided across the display device 100 of the vehicle 640 so that pillar to pillar arrangement may be achieved with different image performance across the display device 100.

It may be desirable to provide a switchable privacy display device 100 with reduced frontal reflectivity in comparison to the embodiment of FIG. 15A. In one embodiment, the reflective polariser 302 may be omitted.

FIG. 15J is a schematic diagram illustrating in perspective side view an alternative switchable privacy display device 100 comprising the arrangement of FIG. 1A and comprising an additional polariser 318 that is the in-plane polariser 610, a passive compensation retarder 330, a switchable liquid crystal retarder 300 and arranged on the input side of a transmissive SLM 48 comprising input polariser 210. Features of the embodiment of FIG. 15J not discussed in further detail may be assumed to correspond to the features with equivalent reference numerals as discussed above, including any potential variations in the features.

By way of comparison with FIG. 15A, the alternative embodiment of FIG. 15J is arranged with the polar control retarder 300 located between the in-plane polariser 610 and the SLM 48. The in-plane polariser 610 is arranged between the at least one polar control retarder 300 and the polarisation switch 600, and wherein the at least one polar control retarder 300 is arranged between the in-plane polariser 610 and the SLM 48, and wherein the SLM 48 comprises an additional polariser 318 as its input polariser.

As for the embodiment of FIG. 15A, the at least one polar control retarder 300 comprises a switchable liquid crystal retarder 301 comprising a layer 314 of liquid crystal material 315, wherein the at least one polar control retarder 300 is arranged, in a switchable state of the switchable liquid crystal retarder 301, simultaneously to introduce no net relative phase shift to orthogonal polarisation components of light passed by the in-plane polariser 610 along a first axis 445 and to introduce a net relative phase shift to orthogonal polarisation components of light passed by the in-plane polariser 610 along a second axis 447 inclined to first axis 445.

In operation, frontal reflections from the display device are lower than for FIG. 15A. Advantageously increased image contrast may be achieved. Direct front surface reflections, such as from sunlight towards a driver 47 may be reduced.

It would be desirable to provide a switchable emissive display device 100 with high image fidelity.

FIG. 16A is a schematic diagram illustrating in perspective side view a switchable privacy display device 100 comprising an OLED emissive SLM 48, a parallax barrier layer 714, a reflection reduction retarder 710, structured birefringent component 720, a half-wave retarder 752, out-of-plane polariser 750, polarisation switch 600, and in-plane polariser 610 arranged on the output side of the SLM 48; and FIG. 16B is a schematic diagram illustrating in perspective front view, alignment of optical layers in the optical stack of the display device 100 of FIG. 16A. Features of the embodiments of FIGS. 16A-B not discussed in further detail may be assumed to correspond to the features with equivalent reference numerals as discussed above, including any potential variations in the features.

By way of comparison with FIG. 1A, the alternative embodiment of FIG. 16A comprises emissive pixels 222, so that the at least one light source is an emissive pixel layer 214. The emissive pixel layer 214 comprises a plurality of pixels 222 arranged in a pixel array. The display device 100 comprises a pixel layer 214 comprising a plurality of red, green and blue pixels 222R, 222G, 222B arranged in a pixel array 222a-n. The emissive pixels 222 may comprise inorganic micro-LEDs or may comprise OLED light emitting materials.

SLM 48 may comprise a backplane substrate 212, and first transparent layer 216, with the pixel layer 214 arranged therebetween. The plurality of pixels 222 comprise switchable light blocking apertures and the pixels 222R. 222G, 222B comprise the light emitting regions of organic light emitting material 223 that are arranged in wells 225, separated by gaps 221.

The light emitting diodes of the pixels 222 may emit light in a narrow spectral band, such as red, green or blue spectral bands. Alternatively the light emitting diodes of the pixels 222 may emit the same colour light and may be provided with respective red, green and blue colour conversion elements such as quantum dots or phosphors. Alternatively the light emitting diodes of the pixels 222 may each emit white light such as by blue light emitting diodes combined with a white colour conversion material such as a phosphor or quantum dot material; and a colour filter array may be arranged to filter the white light into respective red, green or blue spectral bands. Such colour filter array is arranged at the pixel layer 214 to receive light from the light emitting diodes of the pixels 222.

A parallax barrier layer 714 comprising a plurality of apertures 724 is arranged in an aperture array 724a-m. In the embodiment of FIG. 16A, the plurality of apertures 724 comprise a one-dimensional array aperture array 724a-m, wherein each of the apertures 724 are extended in the y-direction, that is orthogonal to the normal 199 (z-axis) to the parallax barrier layer 714 and orthogonal to a predetermined direction (x-axis). The parallax barrier layer 714 comprises light blocking regions 726 arranged between the plurality of apertures 724. The parallax barrier layer 714 may typically be provided by printing or deposition of a light absorbing material such as an ink in the light blocking regions 726. The thickness of the parallax barrier 714 may be small, for example a few micrometers or less.

The display device 100 further comprises a structured birefringent component 720 comprising a plurality of lenses 701 arranged in a lens array 701a-m.

A reflection reduction retarder 710 is arranged between the pixel layer 214 and the structured birefringent component 720. The reflection control polarisation conversion retarder 710 may be formed on the surface 702A of the birefringent lens 701a-n, by lamination of an A-plate retarder. Advantageously cost and complexity may be reduced. Alternatively the reflection control polarisation conversion retarder 710 may be provided as a liquid crystal layer such as a UV cured reactive mesogen liquid crystal material. Advantageously low thickness may be achieved.

A first transparent layer 216 is arranged on the pixel plane 214. A second transparent layer 716 is arranged between the parallax barrier layer 714 and the structured birefringent component 720. The separation L of the birefringent lens 701 to the pixel plane 214 may comprise the thickness of the birefringent lens array 701, the retarder 710, the second transparent layer 716, the parallax barrier layer 714 and the first transparent layer 216. Such manufacturing methods may achieve a separation L determined by the thickness of layers 216, 716, 710 that may together be sufficiently thin to advantageously achieve desirable viewing angle characteristics.

The birefringent lens 701, retarder 710 and second transparent layer 716 may be provided as a parallax component 700 that may further comprise support substrate 706 and/or parallax barrier layer 714.

The aperture array 724a-m and the lens array 701a-m are one-dimensional arrays which extend in the common one-dimensional direction that is in the y-direction, orthogonal to the predetermined direction. In alternative embodiments, the aperture array 724a-m and the lens array 701a-m may be arrays in two directions in the plane of the respective arrays to achieve imaging of pixels 222 in both directions.

Displays comprising emissive pixels 222, parallax barriers 714, birefringent lens arrays 701, polarisation switches 600 and in-plane display polarisers 610, 210 are described further in U.S. Provisional Patent Appl. No. 63/678,425, which is herein incorporated by reference in its entirety.

The operation of the display device 100 of FIG. 16A will now be described.

FIG. 16C is a schematic diagram illustrating in top view the switchable privacy display device 100 of FIG. 16A arranged in the privacy mode of operation; and FIG. 16D is a schematic diagram illustrating in top view the switchable privacy display device 100 of FIG. 16A arranged in the share mode of operation. Features of the embodiments of FIGS. 16C-D not discussed in further detail may be assumed to correspond to the features with equivalent reference numerals as discussed above, including any potential variations in the features.

Considering FIG. 16C, the structured birefringent component 720 comprises a plurality of birefringent lenses 701, such that each pixel of the emissive pixel layer 214 is aligned with a respective birefringent lens 701.

Light 400 from the pixels 222 at the pixel plane 214 is output substantially unpolarised and can be resolved into orthogonal circular polarisation states 902P0, 902S0.

Circular polarisation state 902P0 is converted by the polarisation conversion retarder 710 that is a quarter waveplate to the polarisation state 902P1 at the input to the structured birefringent component. Such light is provided with optical power by the structured surface 702B as described further hereinabove. By comparison with the embodiment of FIG. 1A, in the alternative embodiment of FIG. 16A, the structured birefringent component 720 provides optical power to light that is output in privacy mode.

The display device 100 further comprises a half-wave retarder 752 arranged between the structured birefringent component 720 and the out-of-plane polariser 750. In the present embodiments the half wave retarder 752 (and quarter wave retarder 710 hereinbelow) may be provided for a nominal design wavelength such as 550 nm. Such retarders 752, 710 may be A-plate retarders and may comprise more than one retarder, for example as a Pancharatnum stack to achieve improved chromaticity.

The half-wave retarder 752 is arranged to rotate a linear polarisation state 902P1 between the structured birefringent component 720 and the out-of-plane polariser 750 to the polarisation state 902P2. Such polarisation state 902P2 is incident onto the out-of-plane polariser 750 and has off-axis luminance in directions 447.

Polarisation switch 600 is driven by voltage V614P such that the layer 614 is arranged to output polarisation state 904 that is the same as the polarisation state 902P2. The light which is output through the in-plane polariser 610 has experienced (i) the optical power of the birefringent lens array 701a-m and (ii) the luminance reduction of the out-of-plane polariser 750. Advantageously increased luminance reduction is achieved towards the snooper 47.

The operation of the array of birefringent lenses 701 is different to the operation of the structured birefringent components 720 such as those in FIG. 1A and FIG. 12C hereinabove. In FIG. 1A, the layer 704 is used to provide dispersion of light from the backlight 20 in the wide-angle mode of operation. By comparison the array of birefringent lenses 701 is arranged to provide imaging of the pixels 222 of the SLM 48 in the privacy mode of operation.

FIG. 16C further illustrates that the reflection control polarisation conversion retarder 710 is arranged to convert a polarisation state of light passing therethrough between the circular polarisation state 914 and the linear polarisation state 916. Considering illustrative light ray 464 from external light source 464 with input polarisation state 912, the polarisation conversion retarder 710 provides circular polarisation state 916 onto the pixel plane that is reflected as polarisation state 917 and converted to polarisation state 918 at the polarisation conversion retarder 710 such that the output polarisation state 918 is absorbed by the in-plane polariser 610. Such reflection reduction is provided in both share mode and privacy mode of operation. Advantageously visibility of reflections from the display device 100 is reduced and improved image contrast achieved.

FIG. 16D illustrates that polarisation state 902S0 that is orthogonal to the polarisation state 902P0 is incident onto the reflection control polarisation conversion retarder 710 and state 902S1 is incident onto the birefringent lenses 701 such that no optical power is provided and light rays 445 may be undeflected. Polarisation state 902S2 is output from the half-wave retarder 752 and polarisation switch 600 is driven by voltage V614S such that the layer 614 is arranged to output polarisation state 904 that is the different to the polarisation state 902S2.

The propagation of light rays 447 in off-axis directions will now be described.

FIG. 16E is a schematic diagram illustrating in top view reduction of stray light by reflection from birefringent lenses 701 for the display device 100 in privacy mode of operation. Features of the embodiment of FIG. 16E not discussed in further detail may be assumed to correspond to the features with equivalent reference numerals as discussed above, including any potential variations in the features.

Each of the plurality of birefringent lenses 701 is arranged to reflect at least some of the light received from pixels 222 which are not aligned with that birefringent lens 701.

The display device 100 further illustrates that the parallax barrier layer 714 is arranged to prevent at least some of the light 400 from each of the plurality of pixels 222 from reaching birefringent lenses 701 which are not aligned with that pixel.

FIG. 16E illustrates various light rays that may propagate within the display device 100 operating in privacy mode. For illustrative purposes, the display polariser 210 and polarisation switch 600 are omitted, however the behaviour with said components is similar or the same. Further, the location of the retarder 710 is adjusted to be next to the plane of the parallax barrier layer 714.

Light ray 447P is a light ray that is output from the left-hand edge of pixel 222a is transmitted through the aligned aperture 724a and incident onto the birefringent lens 701a. Desirable light rays 447P are described as in the zeroth lobe of output from the display device 100.

Light rays 450 that are directed towards the adjacent lens 701b from the pixel (as illustrated by notional ray 451) are blocked by the light blocking region 726 of the parallax barrier layer 714. Such undesirable notional light rays 451 are advantageously not output from the display device 100.

As illustrated in TABLE 1, the thicknesses t₂₁₆, t₇₁₆ of the first and second transparent layers 216, 716 respectively are the same, with negligible thicknesses of the offset of the parallax barrier layer 714, retarder 710, and offset 713. Such an arrangement achieves improved light blocking of the light from the pixel 222a to the lens 701b, advantageously achieving reduced stray light and improved security factor, S over and increased lateral field of view.

Intermediate light rays 452P are directed from the left edge of pixel 222a towards the lens 701b and are reflected by total internal reflection at the structured surface 702Bb. Undesirable notional light rays 453 are advantageously not output from the display device 100. The reflected light rays 452P provide for increased aperture 724 width without increased stray light so that the width α of each of the plurality of apertures 724 in the at least one direction may be at least half of the pitch p of the pixel array 222a-n in the at least one direction. Advantageously display luminance may be increased along the direction 445.

Further light rays 452P that do not reflect by total internal reflection at the structured surface 702Bb may have an angle of incidence at the structured surface 702Bb that is close to the Brewster angle. Such light rays have the s-polarisation state 902P at the structured surface 702Bb and so are preferentially reflected, reducing the luminance of a transmitted ray 453. Thus reflection that is not total internal reflection may be used to provide reflection at the structured surface 702Bb. The alignment direction 707b of the birefringent material 705A at the structured surface 702Bb of the lens 701b may be provided to increase the amount of reflected light for such rays 452P.

In other words, the parallax barrier layer 714 is arranged to prevent at least some of the light as illustrative light rays 450 from each of the plurality of pixels 222a from reaching lenses 701b which are not aligned with that pixel 222a, and wherein the each of the plurality of lenses 701 is arranged to reflect at least some of the light as illustrative ray 452P received from pixels 222a which are not aligned with that lens 701b. Further, the lens layer 704 is arranged to reflect at least some of the light that it receives by total internal reflection at a lens 701b structured surface 702Bb. The reflected light ray 452P is redirected back towards the parallax barrier and absorbed in the light blocking region 726b.

Considering light ray 454P from the right side of the pixel is transmitted by the neighbouring aperture 724b, is transmitted through lens 701c and is incident with an angle of incidence at a planar surface 720 of the display device 100. The planar surface 720 provides a planar interface between a material such as polymer or glass and air, and may be a surface of the transparent support substrate 706, polarisation switch 600, display polariser 210 or additional polariser as illustrated in FIG. 1 for example.

The angle of incidence of the light ray 454P is greater than the critical angle and the ray 454P is desirably reflected by total internal reflection. The display device 100 thus further comprises at least one planar surface 720 wherein the at least one planar surface 720 is arranged to receive light output from the lens layer 704 and to reflect at least some of the light such as light ray 454P that it receives by total internal reflection. Advantageously luminance at higher output angles is reduced. Further the lens layer 704 is arranged to refract at least some of the light it receives such that the refracted light is reflected by total internal reflection at the at least one planar surface 720.

Considering light ray 456P from the right hand side of the pixel 222a that is transmitted through the left hand side of the aperture 724b, light may be refracted by the lens 701b towards the normal to the surface 720, that is the angle of incidence onto the surface 720 may be reduced so that light is not reflected by total internal reflection at the surface 720. Transmitted light ray 457PT provide undesirable stray light at wider lateral angles. Some light 456PR is reflected by Fresnel reflection at the surface 720. As the polarisation state 902P is s-polarised at the surface 720, the reflectivity of the light ray 457PR is increased in comparison to p-polarised light. The birefringent lens 701 may have alignment directions 707 of the birefringent material 705A that achieve reduced luminance in the rays 457PT so that visibility at high lateral angles is advantageously reduced.

The embodiments of the type of FIG. 16A and FIG. 18A hereinbelow comprising emissive pixels 222 may further comprise, polar control retarder 300 and additional polariser 318 and optionally reflective polariser 302 such as illustrated in FIG. 15A to achieve improved security factor in privacy mode of operation.

Illustrative embodiments will now be described.

FIG. 16F is a schematic graph illustrating the polar variation of luminance output for the embodiment of FIG. 16C and TABLE 8 in privacy mode of operation for the case of Lambertian emission of light from the pixels 222 of the spatial light modulator 48 for a case in which the out-of-plane polariser 750 is omitted; FIG. 16G is a schematic graph illustrating the polar variation of luminance output for the embodiment of FIG. 16C in privacy mode of operation for the case of Lambertian emission of light from the pixels of the spatial light modulator wherein the out-of-plane polariser 730 is provided with the transmission profile of FIG. 8L; FIG. 16H is a schematic graph illustrating a polar variation of security factor for 1 lux/nit illuminance to peak luminance ratio for an illustrative embodiment of FIG. 16C wherein the out-of-plane polariser 730 is provided and further comprising a polar control retarder and additional polariser of FIG. 15A and FIGS. 15D-E; and FIG. 16I is a schematic graph illustrating the polar variation of luminance output for the embodiment of FIG. 16D in share mode of operation for the case of Lambertian emission of light from the pixels of the spatial light modulator and the transmission profile of FIG. 9C. Features of the embodiments of FIGS. 16G-I not discussed in further detail may be assumed to correspond to the features with equivalent reference numerals as discussed above, including any potential variations in the features.

An illustrative embodiment for the arrangement of FIG. 16C is shown in TABLE 8.

TABLE 8

| Item | Property | Value | |
|---|---|---|---|
| Pixel 222R | Average lens pitch for 1000 lenses in x-direction | 80.000 | μm |
| | Width in x-direction | 40 | μm |
| First transparent layer 216 | Thickness | 25 | μm |
| Parallax barrier layer 714 | Aperture 724 width | 40 | μm |
| | Average aperture 724 pitch for 1000 apertures in x- | 79.996 | μm |
| | direction | | |
| Second transparent layer 716 | Thickness | 25 | μm |
| Reflection control | Retardance | 137.5 | nm |
| polarisation conversion | Thickness | 0.6 | μm |
| retarder 710 | Optical axis 711 direction | 45° | |
| Birefringent lens 701 | Average lens pitch for 1000 lenses in x-direction | 79.992 | μm |
| | Radius | 45 | μm |
| | Cusp offset thickness | 0 | μm |

| | | |
|---|---|---|
| Materials 705A, 705B | Refractive index | See |
| | | TABLE 1 |
| Out-of-plane polariser 750 | Material 751 arrangement | See |
| | | TABLE 3 |
| Switch layer 614 | Liquid crystal material 615 arrangement | See |
| | | TABLE 4 |
| Biaxial retarder arrangement | B-plate arrangement | See |
| 730 | | TABLE 3 |
| In-plane polariser 610 | Electric vector transmission direction 611 | 90° |

FIGS. 16H-I illustrates that a privacy display device 100 comprising an emissive SLM 48 may be provided that is suitable for the automotive vehicle 640 of FIG. 15I. Such an arrangement may be provided with a single switch layer 614, reducing cost and complexity. Further the display device 100 does not provide high frontal reflectivity, increasing aesthetic and practical performance in high illuminance external conditions.

Alternative arrangements to provide reduced off-axis luminance will now be described.

FIG. 16J is a schematic diagram illustrating in top view an alternative display device 100 wherein the parallax barrier layer 714 is provided by a first colour filter array 725 and a second colour filter array 721 is provided in a layer between the parallax barrier layer 714 and the array of birefringent lenses 701. Features of the embodiment of FIG. 16J not discussed in further detail may be assumed to correspond to the features with equivalent reference numerals as discussed above, including any potential variations in the features.

By way of comparison with FIG. 16J, the alternative embodiment of FIG. 16J illustrates that the parallax barrier 714 may be provided by colour filters. The display device 100 further comprises a colour filter layer 721 comprising a plurality of colour filters 722R, 722G, 722B respectively arranged in a colour filter array, wherein each of the plurality of pixels 222R, 222G, 222B is aligned with a respective colour filter of the plurality of colour filters 722R, 722G, 722B, wherein the colour filter layer 721 is arranged between the structured birefringent component 720 and the pixel layer 214. The colour filter layer 721 is arranged to prevent at least some of the light 452P from each of the plurality of pixels 222 from reaching birefringent lenses 701 which are not aligned with that pixel 222.

Each of the plurality of birefringent lenses 701 may further be arranged to reflect at least some of the light 452Pt received from pixels 222 which are not aligned with that lens.

The display device 100 further comprises a colour filter layer 725 comprising a plurality of colour filters 723R, 723G, 723B respectively arranged in a colour filter array, wherein each of the plurality of pixels 222R, 222G, 222B is aligned with a respective colour filter of the plurality of colour filters 723R, 723G, 723B, wherein the colour filter layer 725 is arranged between the structured birefringent component 720 and the pixel layer 214. The colour filter layer 725 is arranged to prevent at least some of the light 456P from each of the plurality of pixels 222 from reaching birefringent lenses 701 which are not aligned with that pixel 222.

In alternative embodiments, one of the layers 721, 725 may be omitted, and further parallax barrier 714 may be provided. The embodiments of FIG. 16J and modifications thereof may advantageously achieve reduced luminance for off-axis viewing directions 447 in privacy mode of operation.

The operation of the out-of-plane polariser 750 in the embodiments of FIGS. 16A-F will now be described.

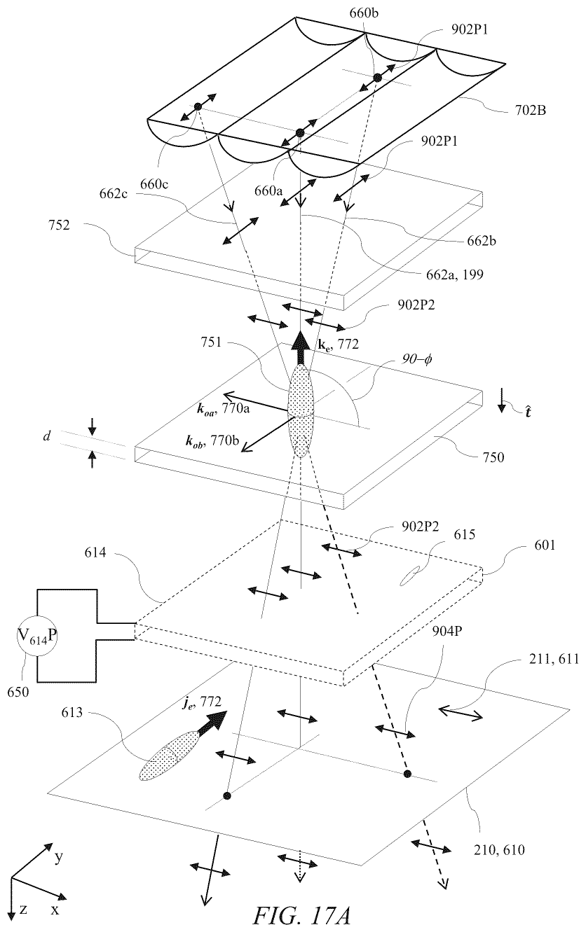

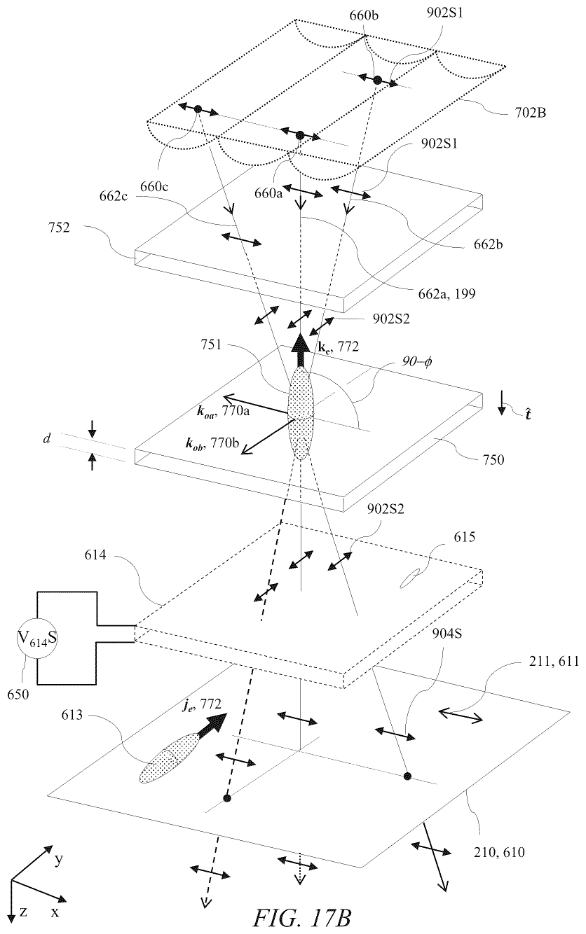

FIG. 17A is a schematic diagram illustrating in perspective side view operation of an array of birefringent lenses 701, half wave retarder 752, out-of-plane polariser 750, switchable layer 614 of liquid crystal material 615 and an in-plane polariser 610 for light rays 662a, 662b, 662c inclined in lateral and elevation directions for the narrow-angle state of operation; and FIG. 17B is a schematic diagram illustrating in perspective side view operation of an array of birefringent lenses 701, half wave retarder 752, out-of-plane polariser 750, switchable layer 614 of liquid crystal material 615 and an in-plane in-plane polariser 610 for light rays 662a, 662b, 662c inclined in lateral and elevation directions for the wide-angle state of operation. Features of the embodiments of FIGS. 17A-B not discussed in further detail may be assumed to correspond to the features with equivalent reference numerals as discussed above, including any potential variations in the features.

By way of comparison with FIGS. 6A-B, the alternative embodiments of FIGS. 17A-B illustrate the function of the half-wave retarder 752 that rotates the polarisation states 902P1, 902P2.

In the privacy mode of FIG. 17A, the structured birefringent component 720 operates to provide optical power and the out-of-plane polariser 750 provides luminance reduction; and in the share mode of FIG. 17B, the structured birefringent component 720 operates to provide no optical power and the out-of-plane polariser 750 provides no luminance reduction.

The operation of the birefringent lens array 701 for the polarisation state 902P is described further hereinabove.

It may be desirable to reduce complexity of the display device 100 in comparison to the embodiment of FIG. 16A.

FIG. 18A is a schematic diagram illustrating in perspective side view a switchable privacy display device 100 comprising an OLED emissive SLM 48, structured birefringent component 720, out-of-plane polariser 750, a polarisation switch 600, and a display polariser 210 that is the in-plane polariser 610 arranged on the output side of the SLM 48; FIG. 18B is a schematic diagram illustrating in top view the switchable privacy display device 100 of FIG. 18A arranged in the privacy mode of operation; and FIG. 18C is a schematic diagram illustrating in perspective front view, alignment of optical layers in the optical stack of the display device 100 of FIG. 18A. Features of the embodiments of FIGS. 18A-C not discussed in further detail may be assumed to correspond to the features with equivalent reference numerals as discussed above, including any potential variations in the features.

By way of comparison with the embodiments of FIGS. 16A-C and FIG. 16J, the alternative embodiments of FIGS. 18A-C do not comprise the parallax barrier 714 or colour filter layers 721, 725. The number of alignment steps during manufacture is reduced and advantageously cost and complexity reduced.

Alternative arrangements of optical stacks for the display device 100 of FIGURE

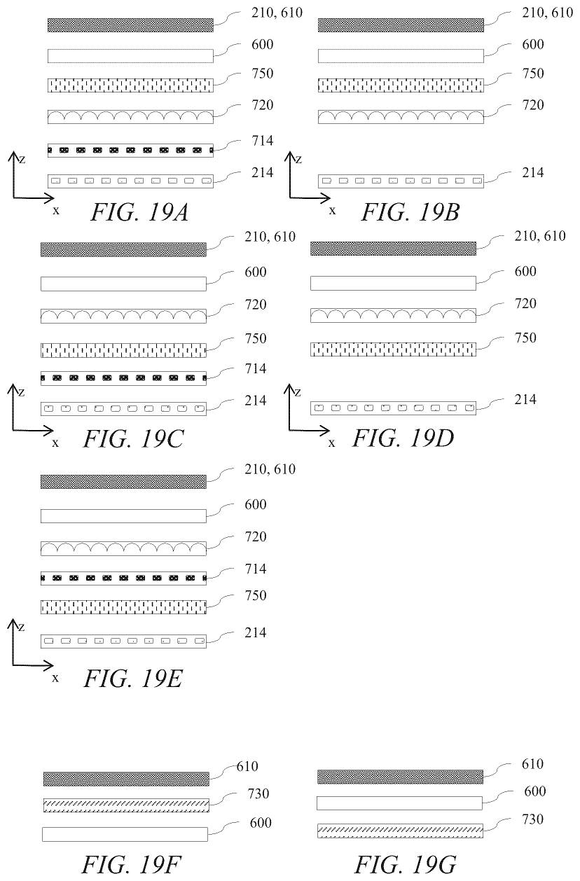

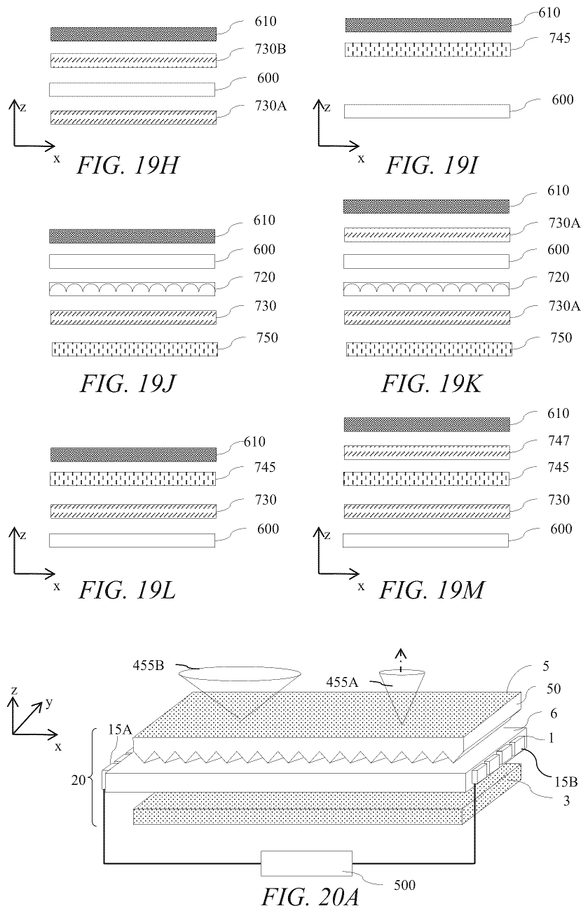

FIGS. 19A-E are schematic diagrams illustrating in top view various alternative structures of optical stacks of the display devices 100 comprising array of birefringent lenses. Features of the embodiments of FIGS. 19A-G not discussed in further detail may be assumed to correspond to the features with equivalent reference numerals as discussed above, including any potential variations in the features.

As for FIGS. 14A-I, the alternative FIGS. 19A-G illustrate non-exhaustive arrangements of optical stacks comprising different sequences and further optical components to achieve alternative optical performance trade-offs between privacy mode and share mode performance.

FIGS. 19F-M are schematic diagrams illustrating in top view various alternative structures of display device optical stacks comprising polarisation switch 600 and in-plane polariser 610. Features of the embodiments of FIGS. 19A-G not discussed in further detail may be assumed to correspond to the features with equivalent reference numerals as discussed above, including any potential variations in the features.

The non-exhaustive alternative embodiments of FIGS. 19F-J may be provided for the display devices of the type of FIG. 1A and of the type of FIG. 16A for example.

FIG. 19F illustrates the biaxial retarder arrangement 730 arranged between the polarisation switch 600 and in-plane polariser; FIG. 19G illustrates that the polarisation switch 600 may be arranged between the biaxial retarder arrangement 730 and in-plane polariser 610; FIG. 19H illustrates that the biaxial retarder arrangement 730 may comprise biaxial retarders 730A, 730B with the polarisation switch 600 arranged therebetween.

By comparison with the embodiments hereinabove, the alternative embodiments of FIGS. 19J-K comprise a biaxial retarder arrangement 730 arranged to receive light from the out-of-plane polariser 950 and the structure birefringent component 720 arranged to receive light from the biaxial retarder arrangement 730. The output polarisation state incident onto the structured birefringent component may be modified to provide improved luminance reduction in directions 447 that may be termed non-viewing directions for snooper 47 in the privacy mode of operation.

By comparison with the embodiments hereinabove, the alternative embodiments of FIGS. 19L-M comprise a further out-of-plane polariser 745 arranged between the polarisation switch 600 and the in-plane polariser 610. FIG. 19M illustrates that a further biaxial retarder 747 may be provided between the further out-of-plane polariser 745 and the in-plane polariser 610. The transmission profile of the display device may have a non-switchable additional transmission profile of FIG. 7B in the embodiment of FIG. 19L and a non-switchable additional transmission profile of FIG. 8L in the embodiment of FIG. 19M. Off-axis luminance in privacy mode may be further reduced in comparison to the illustrative embodiments described hereinabove. Advantageously security factor may be further improved.

Alternative arrangements of backlights 20 will now be described. The backlight 20 arrangements of the display devices 100 described elsewhere herein may be provided by other backlight 20 types disclosed herein, including but not limited to waveguides 1 with light turning film components 50, brightness enhancement film 41 or films 41A, 41B, switchable backlights, mini-LED backlights, out-of-plane polarisers 522 and light control films 530 as described further hereinbelow.

FIG. 20A is a schematic diagram illustrating in perspective side view an alternative backlight 20 comprising addressable first and second arrays of light sources 15A, 15B. Features of the embodiment of FIG. 20A not discussed in further detail may be assumed to correspond to the features with equivalent reference numerals as discussed above, including any potential variations in the features.

The alternative embodiment of FIG. 20A provides first and second light cones 455A, 455B in dependence on the array 15A. 15B that is illuminated respectively. In wide-angle state, light source 15B may provide light cone 455B and optionally light source 15A may provide some light in light cone 445A. In narrow-angle state only light source 15A is illuminated and light primarily directed into light cone 445A.

In the present embodiments, the SDVACRA 900 may be arranged to provide further increase in the size of the cone 455B in wide-angle state. Advantageously the visibility of the display device 100 in wide-angle state may be further increased.

An alternative switchable backlight 20 will now be described.

FIG. 20B is a schematic diagram illustrating in perspective side view an alternative backlight 20 comprising first and second waveguides 1A, 1B and respective aligned first and second arrays of light sources 15A, 15B; FIG. 20C is a schematic diagram illustrating in top view operation of the backlight 20 of FIG. 20B; FIG. 20D is a schematic diagram illustrating in perspective rear view a light turning component 50; and FIG. 20E is a schematic diagram illustrating in top view a light turning component 50. Features of the embodiments of FIGS. 20B-E not discussed in further detail may be assumed to correspond to the features with equivalent reference numerals as discussed above, including any potential variations in the features.

By way of comparison with FIG. 20A, the alternative embodiment of FIGS. 21A-D comprises a further waveguide 1A arranged to receive light from a waveguide 1B with respective aligned light sources 15A, 15B. The backlight 20 comprises: at least one first light source 15A arranged to provide input light; at least one second light source 15B arranged to provide input light in an opposite direction from the at least one first light source 15A; a waveguide arrangement 11 comprising at least one waveguide 1, the waveguide arrangement 11 being arranged to receive the input light from the at least one first light source and the at least one second light source and to cause light from the at least one first light source and the at least one second light source to exit from the waveguide arrangement 11 by breaking total internal reflection; and an optical turning film component 50 comprising: an input surface 56 arranged to receive the light exiting from a waveguide 1 through a light guiding surface 8 of the waveguide 1 by breaking total internal reflection, the input surface 56 extending across the plane; and an output surface 58 facing the input surface 56, wherein the input surface 56 comprises an array of prismatic elements 51. The prismatic elements 51 may be elongate.

The waveguide arrangement 11 comprises: a first waveguide 1A extending across a plane and comprising first and second opposed light guiding surfaces arranged to guide light along the waveguide, the second light guiding surface being arranged to guide light by total internal reflection; and a first input end 2A arranged between the first and second light guiding surfaces 6A. 8A and extending in a lateral direction between the first and second light guiding surfaces 6A, 8A; wherein the at least one first light source 15A is arranged to input light 445 into the first waveguide 1A through the first input end, and the first waveguide 1A is arranged to cause light from the at least one first light source 15A to exit from the first waveguide 1A through one of the first and second light guiding surfaces 6A. 8A by breaking total internal reflection; a second waveguide 1B extending across the plane arranged in series with the first waveguide 1A and comprising first and second opposed light guiding surfaces 6B, 8B arranged to guide light along the waveguide 1B, the second light guiding surface 8B being arranged to guide light by total internal reflection, and a second input end 2B arranged between the first and second light guiding surfaces 6B. 8B and extending in a lateral direction between the first and second light guiding surfaces 6B, 8B; wherein the at least one second light source 15B is arranged to input light 447 into the second waveguide 1B through the second input end 2B, and the second waveguide 1B is arranged to cause light from the at least one second light source 15B to exit from the second waveguide 1B through one of the first and second light guiding surfaces 6B. 8B by breaking total internal reflection, and wherein the first and second waveguides 1A, 1B are oriented so that at least one first light source 15A and at least one second light source 15B input light 445, 447 into the first and second waveguides 1A, 1B in opposite directions.

The optical turning film component 50 comprises: an input surface 56 arranged to receive the light 444A, 444B exiting from the waveguide arrangement 11 through a light guiding surface of the at least one waveguide 1A, 1B of the waveguide arrangement by breaking total internal reflection, the input surface 56 extending across the plane; and an output surface 58 facing the input surface, wherein the input surface 56 comprises an array of prismatic elements 52. The prismatic elements each comprise a pair of elongate facets 52 defining a ridge 54 therebetween. Angles QA. ØB of prism surfaces 53A, 53B are provided to direct the nominal light output from waveguides 1A, 1B to directions 445, 447 by refraction and reflection at surfaces 53A, 53B. Advantageously desirable illumination directions such as illustrated in FIGS. 4A-F may be achieved by selection of angles ϕ_{A}, ϕ_{B}.

The backlight 20 of FIG. 20C may provide two different luminance profiles, for example for use in the passenger infotainment display device 100 of FIGS. 31A-B. In operation, the light 444A from the first light source 15A exits the backlight 20 with a first angular distribution 445 towards the passenger 45 and the light from the second light source 15B exits the backlight 20 with a second angular distribution 457 towards the driver. The first angular distribution 455 may be symmetrical about an axis 199 of symmetry of the backlight 20 and the second angular distribution 457 is asymmetrical about the same axis 199 of symmetry of the backlight 20. In a left-hand drive vehicle, the asymmetrical distribution 457 may be to the left of the axis 199 of symmetry of the backlight 20 and in a right-hand drive vehicle the asymmetrical distribution 457 may be to right of the axis 199 of symmetry of the backlight 20.

Waveguides 1A, 1B comprise surface relief features that are arranged to leak some of the guiding light either towards the rear reflector 3 or towards the light turning component 50. Each waveguide 1A. 1B comprises a surface relief 30 arranged on the first side 6A, 6B that may comprise prism surfaces 32, 33. Further the second sides 8A, 8B may further comprise surface relief 31 that may comprise elongate features or prism features as illustrated in FIG. 18D hereinbelow. In operation the surface reliefs 30, 31 provide leakage of light 445, 447 from the waveguide 1A, 1B for light guiding along the waveguide 1A, 1B.

FIG. 21A is a schematic diagram illustrating in perspective side view an alternative backlight 20 comprising an array of light sources 15a-n that may be mini-LEDs and an array of light deflecting wells 40a-n. Features of the embodiment of FIG. 21A not discussed in further detail may be assumed to correspond to the features with equivalent reference numerals as discussed above, including any potential variations in the features.

Backlight 20 is described in U.S. Patent Publ. No 2022-0404540, which is herein incorporated by reference in its entirety. The backlight 20 is arranged to illuminate a predetermined area of a transmissive SLM 48. Backlight 20 and SLM 48 are controlled by means of controller 500.

The size and profile of the light output cone 455 is determined by the structure and operation of the backlight 20 and other optical layers in the optical stack 5. The backlight 20 is arranged to provide a distribution of luminous intensity within a relatively small cone angle 402 in comparison with conventional backlights using brightness enhancement films such as BEF™ from 3M corporation described hereinbelow.

Backlight 20 comprises a support substrate 17, reflective layer 3, an array of light emitting elements 15 and an optical waveguide 1 comprising light input wells 30 and light deflecting wells 40. The light emitting elements 15 are aligned to the light input wells 30. The light deflecting wells 40 are arranged in an array between the light input wells 30.

The waveguide 1 comprises rear and front light guiding surfaces 6, 8 and may be comprise a light transmitting material such as PMMA, PC, COP or other known transmissive material. The light input wells may comprise air between the rear light guiding surface 6 and the end 34. The waveguide 1 comprises an array of catadioptric elements wherein light is refracted at the light input well and is reflected by total internal reflection and/or reflection at coated reflective surfaces.

The backlight 20 further comprises a reflective layer 3 behind the rear light guiding surface 6 that is arranged to reflect light extracted from the waveguide 1 through the rear light guiding surface 6 back through the waveguide 1 for output forwardly.

The backlight 20 further comprises a light turning optical arrangement that is a light turning optical component 50 arranged to direct light output rays 415G from the waveguide 1 into desirable light output cone 402. Light turning optical component 50 may comprise a film. Advantageously low thickness may be achieved.

Control system 500 is arranged to control the light emitting elements 15 and the pixels 220R, 220G, 220B of the SLM 48. High resolution image data may be provided to the SLM 48 and lower resolution image data may be provided to the light emitting elements 15 by the control system. The display device 100 may advantageously be provided with high dynamic range, high luminance and high efficiency as will be described further hereinbelow.

FIG. 21B is a schematic diagram illustrating in perspective side view an alternative backlight 20 arrangement comprising an array of light sources 15 provided on the edge of a waveguide 1, crossed brightness enhancement films 41A, 41B, light control component 5 comprising a diffuser; and a passive light control element 520 comprising an out-of-plane polariser 522 and an additional polariser 918 of the display device 100. Features of the embodiment of FIG. 21B not discussed in further detail may be assumed to correspond to the features with equivalent reference numerals as discussed above, including any potential variations in the features.

By way of comparison with FIG. 1A, the alternative backlight 20 of FIG. 21B provides an output luminance distribution that has a wider luminance profile than that typically provided by waveguides and light turning components 50. As will be described in FIG. 35C hereinbelow, the profile of the alternative backlight 20 may be narrowed by the out-of-plane polariser 522 arranged outside a polariser that may be an additional polariser 918 or alternatively a display input polariser 210.

Alternatively or additionally a light control element 520 comprising a micro-louvre component 770 may be provided between the backlight 20 and the polariser 918. Advantageously security factor S may be improved in a narrow-angle state while the light dispersion provided by the present embodiments may achieve desirable wide-angle state performance.

In alternative embodiments, the light sources 15 may be arranged as a two-dimensional mini-LED array arranged to direct light into one of the guide surfaces of the waveguide 1 to achieve full area local dimming. Advantageously a high dynamic range display device 100 may be provided.

Backlights 20 may be provided with other types of passive light control element 520 as will now be described.

FIG. 22 is a schematic diagram illustrating in perspective side view the operation of a backlight comprising a light turning component 50, and a micro-louvre component 790. Features of the embodiment of FIG. 22 not discussed in further detail may be assumed to correspond to the features with equivalent reference numerals as discussed above, including any potential variations in the features.

The alternative backlight 20 of FIG. 22 is further provided with a light control component 790 that is provided to be arranged between the backlight 20 and the SLM 48. The light control component 790 comprises an input surface 776, an output surface 778 facing the input surface 776, an array of light transmissive regions 774 extending between the input surface 776 and the output surface 778, and absorptive regions 772 between the transmissive regions and extending between the input surface and the output surface.

Light control component 790 may further comprise a support substrate 710. Advantageously the flatness of the light control film may be increased to achieve increased uniformity. The light control component 790 may be curved to increase image luminance uniformity to the user 45 as described further hereinabove.

It may be desirable to provide a backlight 20 comprising brightness enhancement films 41A, 41B.

FIG. 23A is a schematic diagram illustrating in perspective side view an alternative backlight 20 comprising a light scattering waveguide 1, a rear reflector 3, crossed prismatic films 40A, 40B and a light control element 530 comprising louvres 772 of thickness t1 with pitch pl and louvre 774 width al arranged between light transmissive regions 774 of width sl; and arranged on substrate 792; and FIG. 23B is a schematic diagram illustrating in top view operation of the backlight 20 of FIG. 23A. Features of the embodiments of FIGS. 23A-B not discussed in further detail may be assumed to correspond to the features with equivalent reference numerals as discussed above, including any potential variations in the features.

The backlight 20 of FIGS. 23A-B comprises a rear reflector 3; and an illumination apparatus comprising waveguide 1 and light sources 15. Light rays 412 from the source 15 are input through input side 2 and guide within the surfaces 6, 8 of the waveguide 1. Light is output by means of extraction features 12 and is incident onto rear reflector 3 which may reflect light either by scattering or specular reflection back through the waveguide 1.

In alternative embodiments (not shown), the light sources 15 and waveguide 1 may be alternatively provided by a two-dimensional array of mini-LEDs arrayed across the area of the SLM 48 and optionally various scattering layers including wavelength conversion layers provided.

Output light is directed towards crossed brightness enhancement films 41A, 41B that are arranged to receive light exiting from the first surface 6 of waveguide 1. In the present embodiments, ‘crossed’ refers to an angle of substantially 90° between the optical axes of the two retarders in the plane of the retarders.

Brightness enhancement films 41A, 41B each comprise a prismatic layer with prismatic surfaces 42A, 42B arranged between the optical waveguide 1 and the SLM 48 to receive output light from the optical waveguide 1 or array of mini-LEDs. Light rays 412 from the waveguide 1 or array of mini-LEDs are directed through the SLM 48.

The prismatic surfaces 42A, 42B are elongate and the orientation of the elongate prismatic surfaces of the turning film and further turning film are crossed. Light that is in directions near to the optical axis 199 are reflected back towards the reflector 3, whereas light rays 410 that are closer to grazing the surface 6 are output in the normal direction.

Optionally reflective polariser 208 may be provided between the input display polariser 210 and backlight 20 to provide recirculated light and increase display efficiency. Advantageously efficiency may be increased.

The light recirculating components 3, 41A, 41B, 208 of backlight 20 achieve a mixing of output light from the waveguide. Such recirculation is tolerant to manufacturing defects and backlights 20 may advantageously be provided with larger size, lower cost and higher luminance uniformity than the collimated backlights illustrated elsewhere herein. However, the backlights of FIGS. 23A-B provide increased luminance at higher polar angles that may degrade security factor in narrow-angle state as will be described below.

It would be desirable to provide high uniformity backlights with low manufacturing cost while achieving high security factor in narrow-angle state, and achieving desirable luminance in the public mode of operation.

The light control component 530 is arranged between the backlight 20 and the SLM 48. Light control component 530 is arranged between the reflective polariser 208 of the backlight 20 and the display input polariser 210.

The arrangements of FIGS. 23A-B in combination with switchable liquid crystal retarders are described further in U.S. Pat. No. 11,099,447, which is herein incorporated by reference in its entirety.

Advantageously the embodiments of FIGS. 23A-B used for the backlight 20 of the present embodiments may provide reduce cost of manufacture. Improved wide-angle state visibility may be achieved and high security factor for viewers 47 in narrow-angle state.

The out-of-plane polariser 750 of FIG. 22B may further be provided with the arrangements of FIGS. 23A-B to further reduce the size of the output light cone 455.

FIG. 24A is a schematic diagram illustrating in top view propagation of output light along axes 445, 447 from a SLM 48 through a switchable liquid crystal retarder arrangement 300 in a narrow-angle state. Features of the embodiment of FIG. 24A not discussed in further detail may be assumed to correspond to the features with equivalent reference numerals as discussed above, including any potential variations in the features.

Linear polarisation component 360 (that is the output polarisation state 904 hereinabove) from the output polariser 218 is transmitted by reflective polariser 302 and incident on switchable liquid crystal retarder arrangement 300.

Considering the viewing axis 445, when the layer 314 of liquid crystal material 315 is driven to operate in the narrow-angle state, the switchable liquid crystal retarder arrangement 300 provides no overall transformation of polarisation component 360 to output light rays 400 passing therethrough along the axis 445, but provides an overall transformation of polarisation component 360 to light rays 402 passing therethrough for the inclined axis 447. On-axis 445 light has a polarisation component 362 that is unmodified from component 360 and is transmitted through the additional polariser 318.

Considering the inclined axis 447 off-axis light has a polarisation component 364 that is transformed by the switchable liquid crystal retarder arrangement 300. At a minimum transmission, the polarisation component 361 is transformed to a linear polarisation component 364 and absorbed by additional polariser 318. More generally, the polarisation component 361 is transformed to an elliptical polarisation component, that is partially absorbed by additional polariser 318.

The profile of light transmission such as that illustrated in FIG. 15D modifies the polar distribution of luminance output of the underlying SLM 48. In the case that the SLM 48 comprises a directional backlight 20, then off-axis luminance may be further be reduced as described above.

When the display polariser 310 is the input polariser 210, the principles of operation of the switchable liquid crystal retarder arrangement 300 are the same as when the display polariser 310 is the output polariser 218 for transmitted light.

The operation of the reflective polariser 302 for light from ambient light source 604 will now be described for the display operating in narrow-angle state.

FIG. 24B is a schematic diagram illustrating in top view propagation of ambient illumination light through the switchable liquid crystal retarder arrangement 300 in a narrow-angle state. Features of the embodiment of FIG. 24B not discussed in further detail may be assumed to correspond to the features with equivalent reference numerals as discussed above, including any potential variations in the features.

Ambient light source 604 illuminates the display device 100 with unpolarised light. Additional polariser 318 transmits light ray 410 normal to the display device 100 with a first polarisation component 372 that is a linear polarisation component parallel to the electric vector transmission direction 319 of the additional polariser 318.

For rays along axis 410, in both wide-angle and narrow-angle states of operation, the polarisation component 372 remains unmodified by the switchable liquid crystal retarder arrangement 300 and so transmitted polarisation component 382 is parallel to the transmission axis of the reflective polariser 302 and the output polariser 218, so ambient light is directed through the SLM 48 and lost.

By comparison, for ray 412 along inclined axis 447, light is directed through the switchable liquid crystal retarder arrangement 300 such that polarisation component 374 incident on the reflective polariser 302 may be reflected. Such polarisation component is re-converted into component 376 after passing through switchable liquid crystal retarder arrangement 300 and is transmitted through the additional polariser 318.

Thus when the layer 314 of liquid crystal material is in the narrow-angle state, the reflective polariser 302 provides reflected light rays 412 along the inclined axis 447 for ambient light passing through the additional polariser 318 and then the switchable liquid crystal retarder arrangement 300; wherein the reflected light 412 passes back through the switchable liquid crystal retarder arrangement 300 and is then transmitted by the additional polariser 318.

The illustrative polar distribution of light reflection illustrated in FIG. 15E thus illustrates that high reflectivity can be provided at typical inclined axis 447 locations by means of the narrow-angle state of the switchable liquid crystal retarder arrangement 300. Thus, in the narrow-angle state, the reflectivity for off-axis viewing positions is increased as illustrated in FIG. 15E, and the luminance for off-axis light from the SLM is reduced as illustrated in FIG. 15D. Image security factor S is advantageously increased.

Operation in the wide-angle state will now be further described.

FIG. 25A is a schematic diagram illustrating in top view propagation of output light from a SLM through the switchable liquid crystal retarder arrangement 300 in wide-angle state. Features of the embodiment of FIG. 25A not discussed in further detail may be assumed to correspond to the features with equivalent reference numerals as discussed above, including any potential variations in the features.

When the switchable liquid crystal retarder 301 is in the wide-angle state, the switchable liquid crystal retarder arrangement 300 provide substantially no overall transformation of polarisation component 360 to output light passing therethrough along either of the axes 445, 447. The profile of light transmission such as that illustrated in FIG. 15F provides substantially no modification of the polar distribution of luminance output of the underlying SLM 48.

As described hereinabove, polarisation mixing in diffractive wide-angle states may provide some change in the polarisation state 364, providing loss although desirably polarisation component 362 is substantially the same as polarisation component 360 and polarisation component 364 is substantially the same as polarisation component 360. Thus the angular transmission profile of FIG. 15F is substantially uniformly transmitting across a wide polar region. Advantageously a display may be switched to a wide field of view.

FIG. 25B is a schematic diagram illustrating in top view propagation of ambient illumination light through the switchable liquid crystal retarder arrangement 300 in a wide-angle state. Features of the embodiment of FIG. 25B not discussed in further detail may be assumed to correspond to the features with equivalent reference numerals as discussed above, including any potential variations in the features.

When the switchable liquid crystal retarder 301 is in the wide-angle state, the switchable liquid crystal retarder arrangement 300 provides substantially no overall transformation of polarisation component 372 to ambient light rays 412 passing through the additional polariser 318 along the axes 445, 447.

In operation in the wide-angle state, input light ray 412 has polarisation state 372 after transmission through the additional polariser 318. For both axes 445, 447 no polarisation transformation occurs and thus the reflectivity for light rays 402 from the reflective polariser 302 is low. Light ray 412 is transmitted by reflective polariser 302 and lost in the display polarisers 218, 210 or the backlight 20 to provide the reflectivity profile of FIG. 15G.

Advantageously in a wide-angle state, high luminance and low reflectivity is provided across a wide field of view. Such a display can be conveniently viewed with high contrast by multiple viewers.

As may be used herein, the terms “substantially” and “approximately” provide an industry-accepted tolerance for its corresponding term and/or relativity between items. Such an industry-accepted tolerance ranges from zero percent to ten percent and corresponds to, but is not limited to, component values, angles, et cetera. Such relativity between items ranges between approximately zero percent to ten percent.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically, and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A display device comprising:
at least one light source arranged to output light;
a structured birefringent component;
an out-of-plane polariser; and
a polarisation switch arranged to switch the display device between a first mode of operation and a second mode of operation; and
an in-plane polariser,
wherein the polarisation switch is arranged between the out-of-plane polariser and the in-plane polariser, and the polarisation switch is also arranged between the structured birefringent component and the in-plane polariser, and
wherein the display device is arranged to output an image formed using light which has been output from the at least one light source and which has passed through the structured birefringent component, the out-of-plane polariser, the polarisation switch and the in-plane polariser.

2. The display device of claim 1, wherein:
the at least one light source is arranged to output light towards the structured birefringent component and out-of-plane polariser,
the structured birefringent component and out-of-plane polariser are arranged to receive the light output from the at least one light source and to output light towards the polarisation switch,
the polarisation switch is arranged to receive the light output from the structured birefringent component and out-of-plane polariser and to output light towards the in-plane polariser, and
the in-plane polariser is arranged to receive the light output from the polarisation switch and to output light for forming the image.

3. The display device of claim 1, wherein the structured birefringent component is arranged to output at least some light having a first polarisation state and at least some light having a different second polarisation state.

4. The display device of claim 1, wherein the out-of-plane polariser is arranged to absorb a component of the light which it receives in a direction out of a plane defined by a pixel layer of the display device.

5. The display device of claim 1, further comprising a biaxial retarder arrangement arranged between the at least one light source and the in-plane polariser, wherein the light used to form the image output by the display device also passes through the biaxial retarder arrangement.

6. The display device of claim 5, wherein the biaxial retarder arrangement comprises a B-plate.

7. The display device of claim 6, wherein the B-plate has principal components of refractive index nx, ny, nz and a thickness d, and
wherein for light at a wavelength of 550 nm:
the value of (nx−ny)d is in a range between −130 nm and −170 nm,
the value of (nx−nz)d is in a range between +270 nm and +330 nm, and
the value of a parameter Rth is in a range between +340 nm and +400 nm,
wherein Rth=(nx+ny)/2−nz)d.

8. The display device of claim 5, wherein the biaxial retarder arrangement comprises a C-plate arranged to receive the light output from an A-plate.

9. The display device of claim 8, wherein for light at a wavelength of 550 nm:
the A-plate has a retardance in a range between +85 nm and +115 nm,
and
either:
the C-plate is a negative C-plate with a retardance in a range between −190 nm and −250 nm, or
the C-plate is a positive C-plate with a retardance in a range between +220 nm and +280 nm.

10. The display device of claim 5, wherein the biaxial retarder arrangement is arranged to receive light output from the out-of-plane polariser.

11. The display device of claim 1, wherein the polarisation switch is switchable between a first mode in which it is arranged to change the polarisation state of the light passing therethrough and a second mode in which it is arranged to affect the polarisation state of the light passing therethrough differently from the first mode.

12. The display device of claim 11, wherein, in the first mode, the polarisation switch is arranged to change the polarisation state of the light passing therethrough from a first linear polarisation state to a second linear polarisation state that is orthogonal to the first linear polarisation state.

13. The display device of claim 11, wherein, in the second mode, the polarisation switch is arranged not to change the polarisation state of the light passing therethrough.

14. The display device of claim 1, wherein the in-plane polariser is a linear polariser arranged to output light having a linear polarisation state.

15. The display device of claim 1, wherein the out-of-plane polariser is arranged between the structured birefringent component and the polarisation switch.

16. The display device of claim 1, wherein the structured birefringent component is arranged between the at least one light source and the out-of-plane polariser.

17. The display device of claim 11, wherein the light output by the in-plane polariser in the first mode has a different light output transmission profile to the light output by the in-plane polariser in the second mode.

18. The display device of claim 1, wherein the at least one light source is a backlight.

19. The display device of claim 18, wherein the backlight provides a luminance at polar angles to a normal direction to the display device greater than 45 degrees that is at most 33% of the luminance along the normal direction to the display device, preferably at most 20% of the luminance along the normal to the display device, and most preferably at most 10% of the luminance along the normal to the display device.

20. The display device of claim 1, wherein the at least one light source is an emissive pixel layer.

21. The display device of claim 1, wherein the structured birefringent component comprises a plurality of birefringent lenses.

22. The display device of claim 1, wherein the structured birefringent component comprises one or more of:
a refractive structure having optical power in only one dimension;
a refractive structure having optical power in two dimensions;
a diffractive structure having optical power in only one dimension;
a diffractive structure having optical power in two dimensions.

23. The display device of claim 1, wherein the polarisation switch layer comprises a switchable layer of liquid crystal material.

24. The display device of claim 23, wherein the polarisation switch comprises two surface alignment layers disposed adjacent to the layer of liquid crystal material on opposite sides thereof and each arranged to provide alignment at the adjacent liquid crystal material.

25. The display device of claim 23, wherein the polarisation switch layer further comprises transmissive electrodes arranged to apply a voltage for controlling the switchable layer of liquid crystal material.

26. The display device of claim 25, wherein the transmissive electrodes are on opposite sides of the switchable layer of liquid crystal material.

27. The display device of claim 25, wherein the transmissive electrodes are patterned to provide at least two pattern regions.

28. The display device of claim 25, further comprising a control system arranged to control the voltage applied across the transmissive electrodes of the polarisation switch layer.

29. The display device of claim 20, wherein the emissive pixel layer comprises a plurality of pixels arranged in a pixel array and the structured birefringent component comprises a plurality of birefringent lenses, each pixel of the emissive pixel layer being aligned with a respective birefringent lens, wherein each of the plurality of birefringent lenses is arranged to reflect at least some of the light received from pixels which are not aligned with that birefringent lens.

30. The display device of claim 29, wherein the display device further comprises a parallax barrier layer comprising a plurality of apertures arranged in an aperture array, each aperture being aligned with a respective pixel of the emissive pixel layer, wherein the parallax barrier layer is arranged to prevent at least some of the light from each of the plurality of pixels from reaching birefringent lenses which are not aligned with that pixel.

31. The display device of claim 20, wherein the emissive pixel layer comprises a plurality of pixels arranged in a pixel array and the structured birefringent component comprises a plurality of birefringent lenses, each pixel of the pixel layer being aligned with a respective birefringent lens, the display device further comprising a colour filter layer comprising a plurality of colour filters arranged in a colour filter array, wherein each of the plurality of pixels is aligned with a respective colour filter of the plurality of colour filters, wherein the colour filter layer is arranged between the structured birefringent component and the pixel layer.

32. The display device of claim 31, wherein the colour filter layer is arranged to prevent at least some of the light from each of the plurality of pixels from reaching birefringent lenses which are not aligned with that pixel.

33. The display device of claim 1, further comprising a half-wave retarder arranged between the at least one light source and the out-of-plane polariser.

34. The display device of claim 1, further comprising:
a spatial light modulator; and
at least one polar control retarder,
wherein the in-plane polariser is an input polariser of the spatial light modulator, and
wherein the spatial light modulator is arranged between the polarisation switch and the at least one polar control retarder, and
wherein the display device comprises an additional polariser arranged on an output side of the polar control retarder.

35. The display device of claim 34, wherein:
the at least one polar control retarder comprises a switchable liquid crystal retarder comprising a layer of liquid crystal material, wherein the at least one polar control retarder is arranged, in a switchable state of the switchable liquid crystal retarder, simultaneously to introduce no net relative phase shift to orthogonal polarisation components of light passed by the spatial light modulator along a first axis and to introduce a net relative phase shift to orthogonal polarisation components of light passed by the spatial light modulator along a second axis inclined to first axis.

36. The display device of claim 34, wherein:
the at least one polar control retarder further comprises at least one passive compensation retarder which is arranged simultaneously to introduce no net relative phase shift to orthogonal polarisation components of light passed by the spatial light modulator along the first axis and to introduce a net relative phase shift to orthogonal polarisation components of light passed by the spatial light modulator along the second axis.

37. The display device of claim 34, further comprising a reflective polariser arranged between the spatial light modulator and the at least one polar control retarder.

38. The display device of claim 1, further comprising:
a spatial light modulator; and
at least one polar control retarder,
wherein the in-plane polariser is arranged between the at least one polar control retarder and the polarisation switch, and
wherein the at least one polar control retarder is arranged between the in-plane polariser and the spatial light modulator, and
wherein the spatial light modulator comprises an additional polariser as its input polariser.

39. The display device of claim 38, wherein the at least one polar control retarder comprises a switchable liquid crystal retarder comprising a layer of liquid crystal material, wherein the at least one polar control retarder is arranged, in a switchable state of the switchable liquid crystal retarder, simultaneously to introduce no net relative phase shift to orthogonal polarisation components of light passed by the in-plane polariser along a first axis and to introduce a net relative phase shift to orthogonal polarisation components of light passed by the in-plane polariser along a second axis inclined to first axis.

40. The display device of claim 38, wherein:
the at least one polar control retarder further comprises at least one passive compensation retarder which is arranged simultaneously to introduce no net relative phase shift to orthogonal polarisation components of light passed by the in-plane polariser along the first axis and to introduce a net relative phase shift to orthogonal polarisation components of light passed by the in-plane polariser along the second axis.

41. The display device of claim 35, wherein the switchable liquid crystal retarder comprises two surface alignment layers disposed adjacent to the liquid crystal material on opposite sides thereof and each arranged to provide alignment at the adjacent liquid crystal material.

42. The display device of claim 35, wherein the switchable liquid crystal retarder further comprises transmissive electrodes arranged to apply a voltage for controlling the layer of liquid crystal material.

43. The display device of claim 42, wherein the transmissive electrodes are on opposite sides of the layer of liquid crystal material.

44. The display device of claim 35, wherein the control system is further arranged to control the voltage applied across the transmissive electrodes of the switchable liquid crystal retarder.

45. A view angle control optical element for use with an in-plane polariser and at least one light source of a display device, the view angle control optical element comprising:
a structured birefringent component;
an out-of-plane polariser, and
a polarisation switch for switching the display device between a first mode of operation and a second mode of operation,
wherein:
the out-of-plane polariser is arranged between the structured birefringent component and the polarisation switch; or
the structured birefringent component is arranged between the out-of-plane polariser and the polarisation switch.
